(19) United States
(12) Patent Application Publication
(10) Pub. No.: US 2022/0041871 A1
(43) Pub. Date: Feb. 10, 2022

(54) LOW VOC MULTIFUNCTIONAL ADDITIVES TO IMPROVE WATERBORNE POLYMER FILM PROPERTIES

(71) Applicant: Emerald Kalama Chemical, LLC, Vancouver, WA (US)

(72) Inventors: Stephen Finley Foster, Ridgefield, WA (US); Bradley Les Farrell, Vancouver, WA (US); Emily McBride, Kalama, WA (US); Kyle Jeffrey Posselt, Woodland, WA (US); Julie O. Vaughn-Biege, Copley, OH (US); Sarah L. Strother, Woodland, WA (US)

(73) Assignee: Emerald Kalama Chemical, LLC, Vancouver, WA (US)

(21) Appl. No.: 17/600,723

(22) PCT Filed: Apr. 3, 2020
(86) PCT No.: PCT/US2020/026635

§ 371 Date: Oct. 1, 2021

Related U.S. Application Data
(60) Provisional application No. 62/830,061, filed on Apr. 5, 2019.

(51) Int. Cl. C09D 7/63; C09D 5/08; C08L 25/14; C08L 23/08; C08K 5/05; C08K 5/103; C08K 5/12; C08K 5/13

(52) U.S. Cl. CPC C09D 7/63; C09D 5/08; C08L 25/14; C08K 5/13; C08K 5/05; C08K 5/103; C08K 5/12; C08L 23/0853

(57) ABSTRACT

Low VOC multifunctional additive blends provide, in addition to coalescence, increased hardness, hardness development, scrub resistance, block resistance, dirt pickup resistance, wet adhesion, and corrosion (flash rust) resistance, among other properties, to waterborne coatings or other waterborne polymer film-forming compositions, and are comprised of known low volatile coalescents in combination with certain high volatile components some of which were not known nor heretofore utilized as coalescents. The inventive blends have been found to act synergistically to provide coalescence and unexpected improvement in properties of waterborne polymer formulations, while still providing a low VOC content to the formulations. The invention is also directed to methods for improving the properties of waterborne polymer systems and for incorporating organic acids into waterborne coatings to enhance flash rust resistance, among other properties, through use of the low VOC multifunctional additive blends of the invention.

### FIELD OF THE INVENTION

The invention is directed to low volatile organic compound (VOC) multifunctional additives for waterborne polymer film-forming compositions, which provide in addition to coalescent function, improved properties of the films formed from them, including hardness, scrub resistance, block resistance, and flash rust resistance, among other properties. The invention is also directed to methods to increase and improve the hardness and scrub resistance, among other properties, of waterborne polymer film-forming compositions, including but not limited to coatings, through use of the inventive multifunctional additive blends. The blends comprise traditional low volatility coalescents in combination with high volatile components, some of which are not known nor previously utilized as coalescents. Certain combinations of the high volatile components with traditional low volatility components have been found to act synergistically to improve properties of the waterborne polymer film, while greatly minimizing VOC content. The invention is also directed to methods of improving the properties of waterborne coatings using the low VOC multifunctional additive blends of the invention.

### BACKGROUND OF THE INVENTION

Various coating applications may require good surface hardness as a key feature of the film formed by the coating. Coating hardness is an important property for wear resistant coatings and hardfacing of tooling parts, as well as for thermal and water barrier coatings. Hardness development in waterborne coatings is critical to block resistance and dirt pickup, prevents wear, resists indentation and scratching, and improves barrier properties, among other reasons known to one skilled in the art. Scrub resistance is also highly desirable in coatings, particularly for coated surfaces that require frequent washing. Some of the inventive blends result in greatly improved scrub resistance in some coating systems as described herein.

A number of methods to increase hardness are known. As one example, hardness of a coating may be increased by the use of various fillers, such as mineral additives, clays and other thickeners. Some polymer compositions include “high solids” content, also thought to contribute to hardness. Binders may be selected that have a certain hardness or particle size. Properties of a coating may also be altered by using blends of binders or altering the presence of certain monomers within the binder. Changing the thickness of a coating may also result in improved hardness. Other ways of improving hardness, along with other properties, include use of core shell, staged composition or inclusion of crosslinking groups in the composition. Still other methods are known in the art. While these methods of improving hardness and other properties have been successful, in part, efforts are ongoing to develop methods and additives to improve properties further and provide additional functionality to coatings.

In addition to hardness and improved scrub resistance, some coatings and other waterborne polymer compositions require corrosion resistance. By way of example, corrosion prevention, particularly flash rust resistance, in latex direct-to-metal coatings, among others, is necessary due to the nature of the coating being a waterborne system. When applied to metal surfaces, waterborne coating formulations possess ionic electrolytes, water, and oxygen all of which is required for corrosion to occur. This can result in the formation of flash rust on the metal surface. Organic acids and salts, such as benzoic acid and sodium benzoate, are known to provide corrosion protection through anodic protection by adsorbing to the metal ions and preventing dissolution into the aqueous environment. Generally, these organic acids and salts are added separately throughout the formulation process; however, because of its low water solubility, the incorporation of benzoic acid into a waterborne polymer system can prove challenging.

While improving properties of coatings is an ongoing endeavor, consumers and environmental regulatory agencies continue to push for lower volatile organic compound (“VOC”) content in coatings. VOC's are carbon-containing compounds that readily vaporize or evaporate into the air, where they may react with other elements or compounds. VOC's are of particular concern in the paint and coatings industry in the manufacture as well as use of products comprising VOC's. Use of VOC's in the manufacture of paint and coatings may under certain circumstances result in poor plant air quality and worker exposure to harmful chemicals. Similarly, painters and other users of VOC-containing paints and coatings who are regularly exposed to harmful VOC vapors may suffer from health problems. Persons who are exposed to VOC's may suffer from a number of health problems, including but not limited to several types of headaches, cancers, impaired brain function, renal and liver dysfunction, breathing difficulties and other health problems.

Paints and coatings having high VOC content are also considered environmental hazards. They are the second largest source of VOC emissions into the atmosphere after automobiles, responsible for roughly 11 billion pounds every year. Regulations have been implemented to protect manufacturing workers and end-users. Consumers are also demanding safer alternatives. Formulators can reduce or replace the most volatile components used in the coatings, which reduces VOC concerns to some extent, but may result in compromised performance. Desirably, a low VOC content paint or coating should have, at a minimum, equivalent performance to paints or coatings having higher VOC content. Toward that end, there is a continuing need for raw material suppliers to develop new, lower VOC products for use in paints and coatings, which keep VOC content lower, but do not compromise performance.

A historically volatile, but usually very necessary component, used in coating compositions is the film-forming aid, i.e., coalescent. Coalescents allow coatings formulators to use conventional, well-recognized latex emulsions that are lower in cost and enable them to achieve superior performance vs. coatings based on low T_{g} polymers that don't require coalescents. Coalescents facilitate film formation, by softening dispersed polymers and allowing them to fuse or form a continuous film. The coalescent will then partially or completely volatilize out of the film, allowing the film to regain much its original physical properties. Coalescents are selected that improve the properties of the paint/coating film, such as hardness, gloss, scrub resistance, and block resistance. Coalescents are also selected based upon a variety of properties, including without limitation, volatility, miscibility, stability, compatibility, ease of use, and cost. Traditional coalescents are highly volatile and can contribute significantly to the VOC content of a paint or coating.

Film-forming aids are known in the art. The industry standard, 2,2,4-trimethyl-1,3-pentanediol monoisobutyrate (TXMB) (commercially available from Eastman Chemical as Eastman Texanol™) was and is widely used despite the fact that it is 100% volatile according to the EPA 24 ASTM D2369 test method. Other film-forming aids include glycol ethers, such as diethylene glycol monomethyl ether (DEGME), butyl cellusolve (ethylene glycol monobutyl ether), butyl Carbitol™ (diethylene glycol monobutyl ether) and dipropylene glycol n-butyl ether (DPnB), which are also high volatile components used as coalescents or coalescing solvents. Highly volatile coalescents contribute significantly to the VOC's of the film, beginning with the coalescing phase and lasting for a sustained period afterwards. This, in turn, can affect the air quality around the film which is manifested as an unpleasant odor.

Because of these issues, there has been a trend toward developing and using less volatile, more permanent film-forming aids for coatings and other film-forming compositions. By way of example, Optifilm™ Enhancer 400 (or OE-400), commercially available from Eastman Chemical is a newer lower-VOC coalescent that has become an industry benchmark for lower VOC content coalescents and has been identified in a Safety Data Sheet as triethylene glycol bis(ethylhexanoate-2) also referred to as triethylene glycol dioctanoate (TEGDO), commercially available from a number of suppliers. Another useful low VOC coalescent is COASOL™ (Dow), which is a mixture of refined di-isobutyl esters of adipic acid, glutaric acid and succinic acid, in specific proportions, stated to be characterized by low odor and low vapor pressure. Still other useful low VOC coalescents include citrates and other adipates.

In addition, plasticizers are known as excellent coalescents for latex paints and other coatings, while having significantly less volatility than traditional coalescents. In some coatings' applications, plasticizers are also utilized for their plasticizing functions to soften a harder base polymer in the coating, providing flexibility and reducing brittleness. Plasticizers are also known to improve other paint performance characteristics, such as mud cracking, wet edge and open time.

Phthalate plasticizers, such as di-n-butyl phthalate (DBP), diisobutyl phthalate (DIBP) or butyl benzyl phthalate (BBP), have traditionally been used in the coatings industry when a true plasticizer was required, as is the case when polymers with high T_{g}'s (glass transition temperatures) are employed in one application or another. DBP and DIBP have a lower VOC content than traditional coalescents, but are still somewhat volatile, while BBP has a very low VOC content. Apart from VOC content, however, phthalate ester use has some disadvantages, as DBP and BBP uses, in particular, are restricted due to regulatory concerns.

Dibenzoates are non-phthalates and do not have the restrictions or health concerns associated with phthalates. Classic dibenzoates used as coalescents include 1,2-propylene glycol dibenzoate (PGDB), dipropylene glycol dibenzoate (DPGDB) and as blends of diethylene glycol dibenzoate (DEGDB) and DPGDB and/or PGDB. Commercial examples of benzoates include without limitation K-FLEX® DP (DPGDB), K-FLEX®500 (DEGDB/DPGDB blend), K-FLEX® 850S (a newer grade of DEGDB/DPGDB blend), and K-FLEX® 975P (a newer triblend comprising DEGDB/DPGDB/1,2-PGDB), among many others.

Dibenzoate glycol esters have been used extensively as plasticizers and coalescent “film-forming” aids for many years. The advantages of the use of certain dibenzoates in coatings are known and include: low vapor pressure (in the range of 10⁻⁶-10⁻⁸ mmHg) resulting in low VOC content, appropriate solubility parameters for applications with polar polymers, such as polyvinylchloride (PVC) and acrylates, biodegradability, and safety in food contact applications in adhesives and coatings. Usefulness of dibenzoates as film-forming aids has been established for architectural coatings in both interior and exterior applications. Their performance advantages in architectural coatings include increased volume solids, gloss, and scrub resistance.

Monobenzoate esters known to be useful as coalescents include: isodecyl benzoate (IDB), isononyl benzoate (INB), and 2-ethylhexyl benzoate (EHB). For example, isodecyl benzoate has been described as a useful coalescent agent for paint compositions in U.S. Pat. No. 5,236,987 to Arendt. The use of 2-ethylhexyl benzoate in a blend with DEGDB and diethylene glycol monobenzoate is described in U.S. Pat. No. 6,989,830 to Arendt et al. The use of isononyl esters of benzoic acid as film-forming agents in compositions such as emulsion paints, mortars, plasters, adhesives, and varnishes is described in U.S. Pat. No. 7,638,568 to Grass et al. Phenylpropyl benzoate has also been found to be an excellent film-forming agent for use in a variety of coatings.

Other plasticizers useful in coatings to enable proper film formation and improve film properties in select polymer systems include the non-phthalate 1,2-cyclohexane dicarboxylate esters, such as diisononyl-1, 2 cyclohexane dicarboxylate (commercially available as Hexamoll® DINCH® from BASF).

While plasticizers are generally useful coalescents for waterborne systems based on low VOC contribution, this same low VOC contribution means that they have greater permanence than other traditional higher VOC coalescents, i.e., they are less volatile and thus slower to leave the film. In some instances, the permanence of plasticizers can be a detriment. A major concern of formulators is that permanence may adversely affect certain properties such as dirt pickup, blocking and film hardness. In using plasticizers as coalescents, a balance must be struck between greater permanence—and thus lower VOC's—and good final film properties. Desirably, a low VOC content paint or coating should have, at a minimum, equivalent performance to paints or coatings having higher VOC content. Toward that end, raw material suppliers continue to develop new, lower VOC products for use in paints and coatings and other film-forming compositions, which minimize compromises to performance and improve properties of the polymer film.

There remains an unmet need for coalescents that have lower VOC content, while meeting or improving key coating properties, such as hardness, scrub resistance, block resistance, hardness development and dirt pickup resistance, over that achieved with traditional high volatility coalescents. In addition, in waterborne polymer systems in particular there is a need to improve corrosion (flash rust) resistance in certain use applications.

Low VOC multifunctional additive blends have been discovered that provide lower VOC content to coatings and other film-forming compositions and good coalescence, while actually enhancing other important performance properties as compared to using traditional, high or low VOC coalescents alone. These inventive low VOC multifunctional additives achieve, in addition to coalescence, improved hardness and scrub resistance, among other properties, of waterborne polymer systems through blending both high volatile and low volatile compounds. In particular, it has been found that blending certain low volatility coalescents, including without limitation dibenzoate, phthalate, terephthalate, citrate and adipate plasticizers and other low or zero VOC content film-forming aids, with certain high volatility components achieves unexpectedly improved hardness, block resistance, dirt pickup resistance and scrub resistance in a variety of coatings. The inventive multifunctional additives utilize known high VOC coalescents as well as other high volatility compounds that are not known and have not heretofore been utilized as coalescents. In some aspects, the inventive low VOC multifunctional additives may also include anticorrosion compounds to enhance the functions provided by the additive.

It has also been found that organic acids, such as benzoic acid, may be incorporated into a waterborne polymer system by combining it with the novel multifunctional additives of the invention to enhance anticorrosive (flash rust resistance) properties, in addition to achieving other property improvements. Benzoic acid, known to be insoluble in water, is difficult to incorporate into waterborne polymer systems. However, it has been found that benzoic acid is soluble, to a point, in the low VOC multifunctional additives of the invention, thus providing a novel way to incorporate organic acids, such as benzoic acid, into waterborne polymer systems. Organic salts, such as sodium benzoate, are soluble in water up to about 30% and may be added to a waterborne coating comprising the low VOC multifunctional additive blends of the invention to enhance flash rust resistance of the coating.

It is an object of the invention to provide a coalescent for use in waterborne polymer film-forming compositions, including without limitation coatings, by blending a low volatility component with a high volatility component to provide a lower VOC content coating while enhancing polymer film performance properties.

It is a further object of the invention to provide a waterborne coating having improved hardness and scrub resistance, among other properties, than previously achieved using traditional high volatility or low volatility coalescents alone by blending a high volatility component with a low volatility component.

Another object of the invention is to provide a method to improve the hardness and scrub resistance, among other properties, of waterborne polymer systems over that achieved with traditional high and low volatility coalescents by using a low VOC multifunctional additive comprising a blend of low and high volatility components.

Yet another object of the invention is to enhance performance properties of waterborne polymer film-forming compositions, by adding the multifunctional additive blends of the invention to improve without limitation hardness, hardness development, scrub resistance, corrosion (flash rust) resistance, dirt pick up resistance, and block resistance.

Still another object of the invention is to provide a vehicle or carrier for pigment and colorant (color, dyes) solutions/dispersions to be added to waterborne polymer film-forming compositions, wherein the vehicle comprises the low VOC multifunctional additives of the invention.

Still other objects of the invention will be known to one skilled in the art based upon the disclosure herein.

### SUMMARY OF THE INVENTION

The invention is directed to low VOC multifunctional additive compositions for use in waterborne coatings and other waterborne polymer film-forming compositions, which, in addition to coalescence, provide improved hardness and scrub resistance, hardness development, dirt pickup resistance, block resistance, corrosion (flash rust) resistance, among other properties, as compared to that achieved with traditional high or low volatility coalescents alone. The invention is also directed to methods for improving the hardness and scrub resistance and other properties of waterborne coatings and other waterborne polymer film-forming compositions over that achieved with traditional coalescents by adding the inventive low VOC multifunctional additive composition(s).

In a first embodiment the invention is a low VOC multifunctional additive blend for use in waterborne coating and other waterborne polymer film-forming applications, comprising a low volatility coalescent (film-forming aid) blended with a high volatility component comprising a glycol ether, TXMB, benzylamine, phenoxyethanol, phenyl ethanol, benzyl alcohol, benzyl benzoate, 3-phenyl propanol, 2-methyl-3-phenyl propanol, vanillin or β-methylcinnamyl alcohol (cypriol).

In a second embodiment the invention is a low VOC multifunctional additive for use in waterborne coating wherein the additive comprises a blend of a known low volatility coalescent comprising a benzoate ester, a phthalate, a terephthalate, a 1,2 cyclohexanoate dicarboxylate ester, a citrate, an adipate, Optifilm™ Enhancer 400, TEGDO or mixture of refined di-isobutyl esters of adipic acid, glutaric acid and succinic acid (Coasol™) and a high volatility component.

In a third embodiment the invention is a waterborne coating comprising the inventive low VOC multifunctional additive blends.

In a fourth embodiment, the invention is a waterborne coating comprising a styrene-acrylic binder and the inventive low VOC multifunctional additive blends.

In a fifth embodiment, the invention is a waterborne coating comprising a vinyl acrylic binder and the inventive multifunctional additive blends.

In a sixth embodiment, the invention is a waterborne coating comprising a 100% acrylic binder and the inventive low VOC multifunctional additive blends.

In a seventh embodiment, the invention is a waterborne coating comprising a vinyl acetate-ethylene binder and the inventive low VOC multifunctional additive blends.

In an eighth embodiment, the invention is a waterborne coating comprising a VeoVa™ binder, a vinyl ester of versatic acid, (available from Hexion) and the inventive low VOC multifunctional additive blends.

In a ninth embodiment, the invention is a method of increasing the hardness, hardness development, block resistance, dirt pick up resistance, scrub resistance, wet adhesion, corrosion (flash rust) resistance of waterborne coatings and other waterborne polymer film-forming compositions, comprising the step of adding the inventive low VOC multifunctional additive blends during formulation of the waterborne coatings or waterborne polymer film-forming compositions.

In a tenth embodiment, the invention is a method of incorporating benzoic acid through using a percent molar excess of benzoic acid in the synthesis of dibenzoate coalescents that are utilized in the low VOC multifunctional additive blend, to enhance corrosion resistance and wet adhesion of direct-to-metal coatings, among other properties discussed above.

In an eleventh embodiment, the invention is a low VOC multifunctional additive comprising an excess-acid dibenzoate as the low volatility component in combination with a high volatility component.

In a twelfth embodiment, the invention is a method of combining the excess acid-dibenzoate and benzyl alcohol to create a low VOC anticorrosion coalescent with multifunctional enhancements of wet adhesion, hardness improvement, corrosion resistance, block resistance, dirt pickup resistance and scrub resistance in direct-to-metal coatings.

In a thirteenth embodiment, the invention is a method of dissolving benzoic acid, dibenzoates, and benzyl alcohol together as one mixture to create a low VOC anticorrosion coalescent with multifunctional enhancements of wet adhesion, hardness improvement, corrosion resistance, block resistance, dirt pickup resistance and scrub resistance in direct-to-metal coatings.

In a fourteenth embodiment, the invention is directed to a mixture of sodium benzoate, dibenzoates, and benzyl alcohol incorporated into a waterborne coating to provide multifunctional enhancements of wet adhesion, hardness improvement, corrosion (flash rust) resistance, block resistance, dirt pickup resistance and scrub resistance in direct-to-metal coatings.

In a fifteenth embodiment, the invention is directed to a carrier or dispersant for a colorant to be added to waterborne film-forming compositions of the invention, comprising the low VOC multifunctional additives of the invention.

Other embodiments will be evident to one skilled in the art based on the disclosure herein.

### BRIEF DESCRIPTION OF THE DRAWINGS

FIG. 1 demonstrates enhanced scrub resistance performance (scrub cycles) achieved for a hard styrene-acrylic resin (Encor 471), comparing use of TXMB alone, K-FLEX® 975P alone, and an inventive low VOC multifunctional additive blend comprising a 70:30 blend of TXMB:K-FLEX® 975P.

FIG. 2 demonstrates enhanced scrub resistance performance achieved for a styrene-acrylic resin (EPS 2533), comparing use of TXMB alone, K-FLEX® 975P alone, and an inventive low VOC multifunctional additive blend comprising a 70:30 blend of TXMB to K-FLEX® 975P.

FIG. 3 demonstrates enhanced scrub resistance performance achieved for a styrene acrylic resin (Acronal 296D), comparing use of TXMB alone, K-FLEX® 975 P along and an inventive low VOC multifunctional additive blend comprising a 10:90 TXMB:K-FLEX® 975P blend.

FIG. 4 demonstrates enhanced scrub resistance performance achieved for a 100% acrylic resin (Encor 626), comparing use of TXMB alone, K-FLEX® 850S alone, and an inventive low VOC multifunctional additive blend comprising 10:90 TXMB:K-FLEX® 850S.

FIG. 5 demonstrates enhanced scrub resistance performance achieved for a 100% acrylic resin (VSR1050), comparing use of TXMB alone, K-FLEX® 850S alone, and an inventive low VOC multifunctional additive blend comprising 10:90 TXMB:K-FLEX® 850S.

FIG. 6 demonstrates enhanced scrub resistance performance achieved for a vinyl acrylic resin (Encor 379G), comparing use of TXMB alone, K-FLEX® 850S alone and an inventive low VOC multifunctional additive blend comprising 80:20 TXMB:K-FLEX® 850S.

FIG. 7(a) shows flow and leveling results (ratings) achieved for samples of Encor 471 flat, Encor 471 semigloss, Encor 626 flat, and Encor 626 semigloss samples, comparing samples comprising TXMB, OE-400, K-FLEX® 850S, and three inventive low VOC multifunctional additive blends comprising benzyl alcohol and K-FLEX® 850S at varying ratios.

FIG. 7(b) shows flow and leveling results (ratings) achieved for samples of Encor 471 flat, Encor 471 semigloss, Encor 626 flat and Encor 626 semigloss samples, comparing an uncoalesced sample and samples comprising TXMB, OE-400, K-FLEX® 850S, a blend of TXMB:OE:400 (1:1) and four inventive low VOC multifunctional additive blends comprising benzyl alcohol and K-FLEX® 850S at varying ratios and a blend of benzyl alcohol:OE-400 (1:1).

FIG. 8 shows burnish resistance results (percentage increase in 85° gloss) achieved for Encor 471 and Encor 626 flat samples, comparing uncoalesced samples and samples comprising TXMB, OE-400, K-FLEX® 850S, and three inventive low VOC multifunctional additive blends, X-3411, X-3412 and X-3413.

FIGS. 9(a) and 9(b) show Koenig hardness testing results achieved with Encor 471 and Encor 626 flat samples, comparing an uncoalesced sample and samples comprising TXMB, OE-400, K-FLEX® 850S and three inventive low VOC multifunctional additive blends comprising benzyl alcohol and K-FLEX® 850S at varying ratios.

FIGS. 9 (c) and 9 (d) show Koenig hardness results achieved with semigloss samples of Encor 471 and Encor 626, comparing an uncoalesced sample and samples comprising TXMB, OE-400, K-FLEX® 850S, a blend of TXMB:OE-400 (1:1), and four inventive low multifunctional additive blends comprising benzyl alcohol and K-FLEX® 850S at varying ratios and benzyl alcohol:OE-400 (1:1) ratio.

FIG. 9 (e) shows Koenig hardness results achieved with Encor 471 semigloss samples, comprising three inventive low VOC multifunctional additive blends of cypriol:K-FLEX® 850S, 3-phenyl propanol:K-FLEX® 850S, and 2-methyl-3-phenyl propanol:K-FLEX® 850S, all at 1:1 ratios.

FIGS. 10 (ambient) and 11 (50° C.) show block resistance results ratings for Encor 471 flat and semigloss samples and Encor 626 flat and semigloss samples, comparing and uncoalesced sample and samples comprising TXMB, K-FLEX® 850S, TXMB:OE-400 (1:1), and four inventive low VOC multifunctional additive blends comprising benzyl alcohol and K-FLEX® 850S at varying ratios and a blend of benzyl alcohol:OE-400 (1:1).

FIG. 12(a) is a photographic image showing low temperature coalescence results for Encor 471 flat (10 mils), comparing samples comprising TXMB, OE-400, K-FLEX® 850S, and three inventive low VOC multifunctional additive blends comprising benzyl alcohol and K-FLEX® 850S at varying ratios.

FIG. 12(b) shows low temperature coalescence results (ratings) achieved for flat and semigloss samples of Encor 471 and Encor 626, comparing an uncoalesced sample and samples comprising TXMB, OE-400, K-FLEX® 850S, a blend of TXMB:OE-400 (1:1), and four inventive low VOC multifunctional additive blends comprising benzyl alcohol and K-FLEX® 850S at varying ratios and benzyl alcohol:OE-400 (1:1).

FIGS. 13 (a), 13 (b), 13 (c), 13 (d) and 13 (e) are contour plots showing log reduction over time (days) for concentrations of 3-phenyl propanol ranging from 0.25 wt. % to 2.5 wt. %. in soy broth, for A. brasiliensis (mold), P. aeruginosa (gram negative), E. coli (gram negative), S. aureus (gram positive), and C. albicans (yeast) microorganisms.

FIG. 14 shows Stormer viscosity results (KU) achieved for Encor 471 and Encor 626 flat and semigloss samples, comparing an uncoalesced sample and samples comprising TXMB, OE-400, K-FLEX® 850S, a blend of TXMB:OE-400 (1:1), and four inventive low VOC multifunctional additive blends comprising benzyl alcohol and K-FLEX® 850S at varying ratios and benzyl alcohol:OE-400 (1:1).

FIG. 15 shows contrast ratio results achieved for Encor 471 and Encor 626 flat and semigloss samples, comparing an uncoalesced sample and samples comprising TXMB, OE-400, K-FLEX® 850S, a blend of TXMB:OE-400 (1:1), and four inventive low VOC multifunctional additive blends comprising benzyl alcohol and K-FLEX® 850S at varying ratios and benzyl alcohol:OE-400 (1:1).

FIGS. 16, 17 and 18 show gloss results achieved at 20°, 60° and 85° angles, respectively, for Encor 471 and Encor 626 flat and semigloss samples, comparing an uncoalesced sample and samples comprising TXMB, OE-400, K-FLEX® 850S, a blend of TXMB:OE-400 (1:1), and four inventive low VOC multifunctional additive blends comprising benzyl alcohol and K-FLEX® 850S at varying ratios and benzyl alcohol:OE-400 (1:1).

FIG. 19 shows dirt pickup resistance results (percent difference of reflectance) achieved for Encor 471 and Encor 626 flat and semigloss samples, comparing an uncoalesced sample and samples comprising TXMB, OE-400, K-FLEX® 850S, a blend of TXMB:OE-400 (1:1), and four inventive low VOC multifunctional additive blends comprising benzyl alcohol and K-FLEX® 850S at varying ratios and benzyl alcohol:OE-400 (1:1).

FIG. 20 shows print resistance results (ratings) achieved for Encor 471 and Encor 626 flat and semigloss samples, comparing an uncoalesced sample and samples comprising TXMB, OE-400, K-FLEX® 850S, a blend of TXMB:OE-400 (1:1), and four inventive low VOC multifunctional additive blends comprising benzyl alcohol and K-FLEX® 850S at varying ratios and benzyl alcohol:OE-400 (1:1).

FIGS. 21(a) and 21(b) show initial and final scrub resistance results (number of cycles), respectively, for Encor 471 and Encor 626 flat and semigloss samples, comparing an uncoalesced sample and samples comprising TXMB, OE-400, K-FLEX® 850S, a blend of TXMB:OE-400 (1:1), and four inventive low VOC multifunctional additive blends comprising benzyl alcohol and K-FLEX® 850S at varying ratios and a blend of benzyl alcohol:OE-400 (1:1).

FIG. 22 shows dry adhesion results (ratings) achieved for Encor 471 and Encor 626 flat and semigloss samples, comparing an uncoalesced sample and samples comprising TXMB, OE-400, K-FLEX® 850S, a blend of TXMB:OE-400 (1:1), and four inventive low VOC multifunctional additive blends comprising benzyl alcohol and K-FLEX® 850S at varying ratios and benzyl alcohol:OE-400 (1:1).

FIG. 23 shows drying time results (time (minutes)) achieved for Encor 471 and Encor 626 flat and semigloss samples, comparing an uncoalesced sample and samples comprising TXMB, OE-400, K-FLEX® 850S, a blend of TXMB:OE-400 (1:1), and four inventive low VOC multifunctional additive blends comprising benzyl alcohol and K-FLEX® 850S at varying ratios and benzyl alcohol:OE-400 (1:1).

FIGS. 24 and 25 show mudcracking results from 14-60 mils at ambient and 40° F. (greatest mils w/o cracking) achieved for Encor 471 and Encor 626 flat and semigloss samples, comparing an uncoalesced sample and samples comprising TXMB, OE-400, K-FLEX® 850S, a blend of TXMB:OE-400 (1:1), and four inventive low VOC multifunctional additive blends comprising benzyl alcohol and K-FLEX® 850S at varying ratios and benzyl alcohol:OE-400 (1:1).

FIG. 26 shows open time results (time (minutes)) achieved for Encor 471 and Encor 626 flat and semigloss samples, comparing an uncoalesced sample and samples comprising TXMB, OE-400, K-FLEX® 850S, a blend of TXMB:OE-400 (1:1), and four inventive low VOC multifunctional additive blends comprising benzyl alcohol and K-FLEX® 850S at varying ratios and benzyl alcohol:OE-400 (1:1).

FIG. 27 shows wet edge results (time (minutes)) achieved for Encor 471 and Encor 626 flat and semigloss samples, comparing an uncoalesced sample and samples comprising TXMB, OE-400, K-FLEX® 850S, a blend of TXMB:OE-400 (1:1), and four inventive low VOC multifunctional additive blends comprising benzyl alcohol and K-FLEX® 850S at varying ratios and benzyl alcohol:OE-400 (1:1).

FIG. 28 shows sag resistance results (ratings) achieved for Encor 471 and Encor 626 flat and semigloss samples, comparing an uncoalesced sample and samples comprising TXMB, OE-400, K-FLEX® 850S, a blend of TXMB:OE-400 (1:1), and four inventive low VOC multifunctional additive blends comprising benzyl alcohol and K-FLEX® 850S at varying ratios and benzyl alcohol:OE-400 (1:1).

FIGS. 29 (a)-(h) show washability results (ΔE*) achieved for Encor 471 and Encor 626 flat and semigloss samples, comparing an uncoalesced sample and samples comprising TXMB, OE-400, K-FLEX® 850S, a blend of TXMB:OE-400 (1:1), and four inventive low VOC multifunctional additive blends comprising benzyl alcohol and K-FLEX®850S at varying ratios and benzyl alcohol:OE-400 (1:1), against various aqueous and oil-based stains.

FIG. 30 shows washability results (ΔE*) achieved for Encor 471 and Encor 626 flat and semigloss samples, comparing an uncoalesced sample and samples comprising TXMB, OE-400, K-FLEX® 850S, a blend of TXMB:OE-400 (1:1), and four inventive low VOC multifunctional additive blends comprising benzyl alcohol and K-FLEX® 850S at varying ratios and benzyl alcohol:OE-400 (1:1), against permanent marker.

FIG. 31 shows VOC contribution calculations (g/L) for various paint binders (Encor 471, EPS2533, Acronal 296D, Encor 626, VSR-1050, and Encor 379G), comparing VOC's calculated per binder for TXMB, K-FLEX® 850S, K-FLEX® 975P, and two inventive low VOC multifunctional additive blends comprising TXMB and K-FLEX® 850S or 975P (depending on binder) (see Example 21).

FIG. 32 shows scrub resistance results (number of scrub cycles), initial and final, achieved for a styrene acrylic binder (Encor 471), comparing TXMB, OE-400, K-FLEX® 975 P and two inventive low VOC multifunctional additive blends comprising TXMB:K-FLEX® 975 P at ratios of 70:30 and 30:70.

FIG. 33 shows scrub resistance results (number of scrub cycles) initial and final, achieved for another styrene acrylic binder (EPS 2533), comparing TXMB, OE-400, K-FLEX® 975 P and two inventive low VOC multifunctional additive blends comprising TXMB:K-FLEX® 975 P at ratios of 55:45 and 30:70.

FIG. 34 shows scrub resistance results (number of scrub cycles) initial and final, achieved for yet another styrene acrylic binder (Acronal 296D), comparing TXMB, OE-400, K-FLEX® 975 P and two inventive low VOC multifunctional additive blends comprising TXMB:K-FLEX® 975 P at ratios of 90:10 and 10:90.

FIG. 35 shows scrub resistance results (number of scrub cycles) initial and final, achieved for a 100% acrylic binder (Encor 626), comparing TXMB, OE-400, K-FLEX® 850S and two inventive low VOC multifunctional additive blends comprising TXMB:K-FLEX® 850S at ratios of 90:10 and 10:90.

FIG. 36 shows scrub resistance results (number of scrub cycles) initial and final, achieved for another 100% acrylic binder (VSR-1050), comparing TXMB, OE-400, K-FLEX® 850S and two inventive low VOC multifunctional additive blends comprising TXMB:K-FLEX® 850S at ratios of 90:10 and 40:60.

FIG. 37 shows scrub resistance results (number of scrub cycles) initial and final, achieved for a vinyl acrylic binder (Encor 379G), comparing TXMB, OE-400, K-FLEX® 850S and two inventive low VOC multifunctional additive blends comprising TXMB:K-FLEX® 850S at ratios of 80:20 and 50:50.

FIG. 38 shows a side by side comparison of 1-day and 7-day block resistance results achieved for Encor 471, comparing TXMB, OE-400, K-FLEX® 975 P and two inventive low VOC multifunctional additive blends comprising TXMB:K-FLEX® 975 P at ratios of 70:30 and 30:70.

FIG. 39 shows a side by side comparison of 1-day and 7-day block resistance results (rating) achieved for EPS 2533, comparing TXMB, OE-400, K-FLEX® 975 P and two inventive low VOC multifunctional additive blends comprising TXMB:K-FLEX® 975 P at ratios of 30:70 and 55:45.

FIG. 40 shows a side by side comparison of 1-day and 7-day block resistance results achieved for Acronal 296D, comparing TXMB, OE-400, K-FLEX® 975 P and two inventive low VOC multifunctional additive blends comprising TXMB:K-FLEX® 975 P at ratios of 10:90 and 90:10.

FIG. 41 shows a side by side comparison of 1-day and 7-day block resistance results achieved for Encor 626, comparing TXMB, OE-400, K-FLEX® 850S and two inventive low VOC multifunctional additive blends comprising TXMB:K-FLEX® 850S at ratios of 10:90 and 90:10.

FIG. 42 shows a side by side comparison of 1-day and 7-day block resistance results achieved for VSR-1050, comparing TXMB, OE-400, K-FLEX® 850S and two inventive low VOC multifunctional additive blends comprising TXMB:K-FLEX® 850S at ratios of 40:60 and 90:10.

FIG. 43 shows a side by side comparison of 1-day and 7-day block resistance results for Encor 379G, comparing TXMB, OE-400, K-FLEX® 850S and two inventive low VOC multifunctional additive blends comprising TXMB:K-FLEX® 850S at ratios of 50:50 and 80:20.

FIG. 44 shows gloss results (units) achieved for Encor 471, comparing TXMB, OE-400, K-FLEX® 975 P and two inventive low VOC multifunctional additive blends comprising TXMB:K-FLEX® 975 P at ratios of 70:30 and 30:70.

FIG. 45 shows gloss results achieved for EPS 2533, comparing TXMB, OE-400, K-FLEX® 975 P and two inventive low VOC multifunctional additive blends comprising TXMB:K-FLEX® 975 P at ratios of 55:45 and 30:70.

FIG. 46 shows gloss results achieved for Acronal 296D, comparing TXMB, OE-400, K-FLEX® 975 P and two inventive low VOC multifunctional additive blends comprising TXMB:K-FLEX® 975 P at ratios of 90:10 and 10:90.

FIG. 47 shows gloss results achieved for Encor 626, comparing TXMB, OE-400, K-FLEX® 850S and two inventive low VOC multifunctional additive blends comprising TXMB:K-FLEX® 850S at ratios of 10:90 and 90:10.

FIG. 48 shows gloss results achieved for VSR-1050, comparing TXMB, OE-400, K-FLEX® 850S and two inventive low VOC multifunctional additive blends comprising TXMB:K-FLEX® 850S at ratios of 90:10 and 40:60.

FIG. 49 shows gloss results achieved for Encor 379G, comparing TXMB, OE-400, K-FLEX® 850S and two inventive low VOC multifunctional additive blends comprising TXMB:K-FLEX® 850S at ratios of 50:50 and 80:20.

FIG. 50 shows dirt pickup resistance (A % Y) results achieved for Encor 471, comparing TXMB, OE-400, K-FLEX® 975 P and two inventive low VOC multifunctional additive blends comprising TXMB:K-FLEX® 975 P at ratios of 70:30 and 30:70.

FIG. 51 shows dirt pickup resistance results achieved for EPS 2533, comparing TXMB, OE-400, K-FLEX® 975 P and two inventive low VOC multifunctional additive blends comprising TXMB:K-FLEX® 975 P at ratios of 55:45 and 30:70.

FIG. 52 shows dirt pickup resistance results achieved for Acronal 296D, comparing TXMB, OE-400, K-FLEX® 975 P and one inventive low VOC multifunctional additive blend comprising TXMB:K-FLEX® 975 P at a ratio of 90:10.

FIG. 53 shows dirt pickup resistance results achieved for VSR-1050, comparing TXMB, OE-400, K-FLEX® 850S and two inventive low VOC multifunctional additive blends comprising TXMB:K-FLEX® 850S at ratios of 90:10 and 40:60.

FIG. 54 shows dirt pickup resistance results achieved for Encor 626, comparing TXMB, OE-400, K-FLEX® 850S and two inventive low VOC multifunctional additive blends comprising TXMB:K-FLEX® 850S at ratios of 10:90 and 90:10.

FIG. 55 shows dirt pickup resistance results achieved for Encor 379G, comparing TXMB, OE-400, K-FLEX® 850S and two inventive low VOC multifunctional additive blends comprising TXMB:K-FLEX® 850S at ratios of 50:50 and 80:20.

FIG. 56 shows low temperature coalescence results (rating) achieved for Encor 471, comparing TXMB, OE-400, K-FLEX® 975 P and two inventive low VOC multifunctional additive blends comprising TXMB:K-FLEX® 975 P at ratios of 70:30 and 30:70.

FIG. 57 shows low temperature coalescence results achieved for EPS 2533, comparing TXMB, OE-400, K-FLEX® 975 P and two inventive low VOC multifunctional additive blends comprising TXMB:K-FLEX® 975 P at ratios of 55:45 and 30:70.

FIG. 58 shows low temperature coalescence results achieved for Acronal 296D, comparing TXMB, OE-400, K-FLEX® 975 P and two inventive low VOC multifunctional additive blends comprising TXMB:K-FLEX® 975 P at ratios of 90:10 and 10:90.

FIG. 59 shows low temperature coalescence results achieved for Encor 626, comparing TXMB, OE-400, K-FLEX® 850S and two inventive low VOC multifunctional additive blends comprising TXMB:K-FLEX® 850S at ratios of 10:90 and 90:10.

FIG. 60 shows low temperature coalescence results achieved for VSR-1050, comparing TXMB, OE-400, K-FLEX® 850S and two inventive low VOC multifunctional additive blends comprising TXMB:K-FLEX® 850S at ratios of 90:10 and 40:60.

FIG. 61 shows low temperature coalescence results achieved for Encor 379G, comparing TXMB, OE-400, K-FLEX® 850S and two inventive low VOC multifunctional additive blends comprising TXMB:K-FLEX® 850S at ratios of 50:50 and 80:20.

FIG. 62 is a photographic image depicting wet adhesion results achieved for a waterborne direct-to-metal coating (Table 5) applied to a steel panel, comparing use of a blend of propylene glycol dibenzoate and dipropylene glycol n-butyl ether (left image) and an inventive low VOC multifunctional additive blend comprising propylene glycol dibenzoate and benzyl alcohol (right image), wherein the inventive multifunctional additive blend greatly improves wet adhesion.

FIG. 63 shows Koenig hardness results achieved over time for a direct-to-metal waterborne coating (Table 5), comprising blends of propylene glycol dibenzoate and dipropylene glycol n-butyl ether, butyl benzyl phthalate and dipropylene glycol n-butyl ether, and an inventive low VOC multifunctional additive blend comprising propylene glycol dibenzoate and benzyl alcohol.

FIG. 64 shows Koenig hardness results over time achieved for a direct-to-metal coating comprising 1:1 blends of PGDB:DPnB, BBP:DPnB, and two inventive low VOC multifunctional additive blends of PGDB:benzyl alcohol (1:1) and K-FLEX® 850S:benzyl alcohol (1:1).

FIG. 65 shows block resistance results (at 23° C.) achieved for a direct-to-metal coating, comprising 1:1 blends of PGDB:DPnB and BBP:DPnB, and two inventive low VOC multifunctional additive blends of PGDB:benzyl alcohol (1:1) and K-FLEX® 850S:benzyl alcohol (1:1).

FIG. 66 shows block resistance results (at 50° C.) achieved for a direct-to-metal coating, comprising 1:1 blends of PGDB:DPnB and BBP:DPnB, and two inventive low VOC multifunctional additive blends of PGDB:benzyl alcohol (1:1) and K-FLEX® 850S:benzyl alcohol (1:1).

FIG. 67 shows dry and wet adhesion results achieved for a direct-to-metal coating, comprising 1:1 blends of PGDB:DPnB, BBP:DPnB, and two inventive low VOC multifunctional additive blends of PGDB:benzyl alcohol (1:1) and K-FLEX® 850S: benzyl alcohol (1:1).

FIG. 68 shows freeze-thaw results achieved for a styrene acrylic binder, comparing TXMB, TEGDO, K-FLEX® 850S, and two low VOC multifunctional additive blends of the invention comprising benzyl alcohol and dibenzoates at varying ratios. (No results for TXMB as the sample gelled).

FIG. 69 shows freeze-thaw results achieved for an all acrylic binder, comparing TXMB, TEGDO, K-FLEX® 850S, and two low VOC multifunctional additive blends of the invention comprising benzyl alcohol and dibenzoates at varying ratios.

FIG. 70 is a photographic image of Encor 626 blended with 2.5 wt. % of the inventive low VOC multifunctional additive blend, X-3411, to binder, demonstrating a stable polymer emulsion incorporating the low VOC multifunctional additive blend.

FIG. 71 is a photographic image of Encor 626 blended with 1.1 wt. % benzyl alcohol to binder, showing aggregates/flocculants at the bottom of the jar and demonstrating that benzyl alcohol alone destabilizes the polymer (binder).

FIG. 72 is a photographic image of a fully formulated Encore 471 semigloss with post-added benzyl alcohol at 3.95 wt. % to binder, showing aggregates and flocculants formed and demonstrating that benzyl alcohol alone destabilizes the polymer (binder).

FIG. 73 is a photographic image of a fully formulated semigloss Encor 471, using 7.9 wt. % to binder of X-3411 (which amounts to 3.95 wt. % benzyl alcohol), demonstrating that a stable coating results by the blend of benzyl alcohol and a dibenzoate according to the present invention.

### DETAILED DESCRIPTION OF THE INVENTION

The invention is directed to low VOC multifunctional additive blends for use in waterborne coatings and other waterborne polymer film-forming compositions, which, in addition to coalescence, provide improved hardness and scrub resistance, hardness development, block resistance, dirt pickup resistance, wet adhesion and anticorrosion (flash rust resistance), among other properties, over that achieved with traditional high or low volatility coalescents when used alone. The invention is also directed to methods for improving performance properties of waterborne polymer film-forming composition over that achieved with traditional high or low volatility coalescents alone, by adding the inventive coalescent compositions. The invention is also directed to methods for preparing certain of the low VOC multifunctional additive compositions and/or waterborne polymer systems, through the incorporation of certain organic acids to enhance flash rust resistance of the waterborne film-forming composition(s).

The following terms are defined:

“Binder” shall mean and include polymers and resins that form the base of a paint or coating formulation or other waterborne polymer film-forming composition. The terms “binder”, “polymer” and “resin” are used interchangeably herein, unless expressly defined.

“High volatility”, “high volatile” and “high VOC”, when used in connection with respect to certain components of the multifunctional additive blends of the invention, are used interchangeably herein. As is understood, “VOC” means “volatile organic compound(s).”

“Low volatility”, “low volatile” and “low VOC”, when used in connection with certain components of the multifunctional additive blends of the invention, are used interchangeably herein.

“Formulation” shall mean and include a paint or coating composition or other waterborne polymer film-forming composition (defined below) comprising a binder (polymer), the inventive low VOC multifunctional additive blends, and other components traditionally used in the compositions.

“Waterborne polymer film-forming composition” in shall mean and include compositions that are known “film formers”, including without limitation paints and other coatings, regardless of substrate to be coated, films, film coatings, adhesives, glues, sealants, caulks and some inks. The phrases “waterborne polymer system” and “waterborne polymer film-former” or “waterborne polymer film-forming composition” are used interchangeably herein. For the avoidance of doubt, “waterborne coatings” are also considered to be “waterborne polymer film-forming compositions.” Depending on use or application, the phrase “waterborne coating” or “paint” or “paint formulation” may be used in lieu of “waterborne polymer film-forming composition”.

“Multifunctional additives” or “multifunctional additive blends” or “low VOC multifunctional additives” or “low VOC multifunctional additive blends” are used interchangeably to describe the inventive compositions. “Multifunctional” shall mean and include the various functions provided by the low VOC multifunctional additives of the invention, including, in addition to coalescence, improved hardness, rate of hardness development, scrub resistance, block resistance, dirt pickup resistance, wet adhesion and corrosion (flash rust) resistance, among others.

In particular, the invention is directed to low VOC multifunctional additive blends comprising a mixture of known low volatile (VOC) coalescing component and a high volatile (VOC) component(s) some of which are not traditionally known, recognized or heretofore utilized as coalescents. The inventive multifunctional additives may, optionally, include certain organic acid, such as benzoic acid, to enhance flash rust resistance in waterborne polymer systems. Salts of organic acids may also be added to a waterborne coating comprising the low VOC multifunctional additives of the invention to enhance flash rust resistance.

Low VOC coalescent components for use in the inventive multifunctional additives include plasticizers. Suitable dibenzoate plasticizers include without limitation diethylene glycol dibenzoate (DEGDB), dipropylene glycol dibenzoate (DPGDB), 1,2-propylene glycol dibenzoate (PGDB), triethylene glycol dibenzoate, tripropylene glycol dibenzoate, dibenzoate blends, such as DEGDB and DPGDB or a triblend of DEGDB, DPGDB, and PGDB, and mixtures thereof. Suitable monobenzoate plasticizers include without limitation 2-ethylhexyl benzoate, 3-phenyl propyl benzoate, 2-methyl-3-phenyl propyl benzoate, isodecyl benzoate, isononyl benzoate and mixtures thereof. Other benzoate esters and blends thereof are also suitable for the invention. Suitable phthalate plasticizers include without limitation di-n-butyl phthalate (DBP), diisobutyl phthalate (DIBP) or butyl benzyl phthalate (BBP). Suitable terephthalate plasticizers include without limitation di-2-ethylhexyl terephthalate (DOTP), dibutyl terephthalate (DBT), or diisopentyl terephthalate (DPT). Suitable citrate plasticizers include without limitation acetyl tributyl citrate, tri-n-butyl citrate and others. Suitable 1,2-cyclohexane dicarboxylate ester plasticizers that may be used with select polymer systems include diisononyl-1, 2 cyclohexane dicarboxylate (Hexamoll® DINCH® from BASF) Other lower VOC content plasticizers will be known to one skilled in the art based upon the disclosure herein.

Non-plasticizer, low VOC coalescents suitable for use in the inventive low VOC multifunctional additives include without limitation triethylene glycol dioctanoate (TEGDO), Optifilm™ Enhancer 400 (OE-400) (triethylene glycol bis(ethylhexanoate-2), available from Eastman Chemical), and mixtures of refined diisobutyl esters of adipic acid, glutaric acid and succinic acid (Coasol™ and Coasol™ 290 Plus, commercially available from DOW). Other non-plasticizer, low VOC coalescents or film-forming agents will be known to one skilled in the art based upon the disclosure herein.

The higher VOC components utilized in the inventive low VOC multifunctional additives include known high volatile coalescents as well as other high volatile components not known and not heretofore utilized as coalescing agents. Suitable higher VOC components for use in the inventive blends include without limitation glycol ethers used as coalescents, such as butyl cellusolve (ethylene glycol monobutyl ether), butyl Carbitol™ (diethylene glycol monobutyl ether), diethylene glycol monomethyl ether (DEGME) and dipropylene glycol n-butyl ether (DPnB), 2,2,4-trimethyl-1,3-pentanediol monoisobutyrate (TXMB), benzylamine, phenoxyethanol, phenyl ethanol, benzyl alcohol, benzyl benzoate, 3-phenyl propanol, 2-methyl-3-phenyl propanol, vanillin, β-methylcinnamyl alcohol (cypriol). Of these, TXMB is historically a high VOC coalescent that has been combined with OE-400 (a low VOC coalescent) in efforts to mitigate costs and achieve lower VOC's. A comparative evaluation of this prior reported combination in comparison to the inventive coalescents is provided in the examples. TXMB was not known, nor was it expected, to have synergies when blended with dibenzoates. Results showed that surprisingly the TXMB:dibenzoate blend performed far better than the reported TXMB:OE-400 blend.

With respect to higher VOC components not known, recognized or heretofore utilized as coalescent agents, such as benzylamine, phenoxyethanol, phenyl ethanol, benzyl alcohol, benzyl benzoate, 3-phenyl propanol, 2-methyl-3-phenyl propanol, vanillin or β-methylcinnamyl alcohol (cypriol), unexpected results occurred when blended with lower VOC coalescents identified above. When used alone, some of these components were expected to be incompatible with and actually did destabilize typical coatings polymers when evaluated. Yet, in combination with a lower VOC coalescent component as disclosed herein, surprisingly, the polymers were not destabilized. Blends of these higher VOC components with low VOC coalescents unexpectedly provides improved performance properties while still providing low VOC content to the coatings and other waterborne polymer systems. As one example set forth herein, a benzyl alcohol:850S blend improved the incorporation of benzyl alcohol into a polymer emulsion allowing for a more stable product. The result is totally unexpected since benzyl alcohol, even at low levels of addition, is known to be incompatible with acrylic and styrene-acrylic binders.

Other higher VOC components will be known to one skilled in the art based upon the disclosure herein.

Other components that may be included in the low VOC multifunctional additives of the invention include components that inhibit corrosion, specifically flash rust inhibitors. Flash rust resistance is particularly important in waterborne direct-to-metal coatings, among other applications. Organic acids, such as benzoic acid, phthalic acid, succinic acid enhance flash rust resistance properties of certain coatings. However, organic acids, such as benzoic acid, are known to have very low water solubility, which presents a challenge when trying to incorporate them into a waterborne polymer film-forming composition.

The inventive low VOC multifunctional additive blends provide novel methods for incorporating organic acids, such as benzoic acids, into waterborne polymer film-forming compositions. In one method, benzoic acid is first incorporated into a low volatile dibenzoate component during synthesis of the dibenzoate, by using a percent molar excess of benzoic acid ranging from 1% to 30% in the reaction. The resulting excess-acid-containing, low volatile dibenzoate ester may then be combined with high volatility components to form the low VOC multifunctional additive blend(s) of the invention.

Alternatively, benzoic acid, along with the low volatility component and the high volatility component, are all mixed together to form a low VOC multifunctional additive blend of the invention. Or, benzoic acid can be added to the already-formed low VOC multifunctional additive blends of the invention, which are then added to a waterborne coating to improve wet adhesion, initial rate of hardness development, and flash rust resistance of the coating.

In yet another method, benzoic acid is first dissolved in an already synthesized dibenzoate at a concentration sufficient to improve flash rust resistance when added to a waterborne direct-to-metal coating formulation, then adding a high volatile component to form the low VOC multifunctional additive blend.

A preferred embodiment for enhancing flash rust resistance comprises benzoic acid, a dibenzoate and benzyl alcohol, although other organic acids may be incorporated into high volatile and low volatile components of the inventive multifunctional additives through the methods described herein.

Although salts of organic acids, such as sodium benzoate, are generally insoluble for purposes of the above methods, they are water soluble and may be later added to a waterborne coating comprising the low VOC multifunctional additives of the invention to enhance flash rust resistance, improve wet adhesion, and initial rate of hardness development. As one example, sodium benzoate, may be added to a waterborne coating comprising benzyl alcohol as the high volatile component and propylene glycol dibenzoate as the low volatile component.

Accordingly, the inventive low VOC multifunctional additive blends comprise at least one high volatile component and at least one low volatile component. Preferably, at least one component of the blend has a molecular structure that includes an aromatic ring, although the invention is not limited as such. Depending on application/use, organic acids may also be incorporated in or added to the inventive low VOC multifunctional additive blends, as described above. Or, organic acids salts may be added to a waterborne polymer film-forming composition comprising the low VOC multifunctional additive blends of the invention.

The low VOC multifunctional additive blends of the invention may be used in a wide variety of waterborne coatings or other waterborne polymer film-forming compositions. The invention is not limited to any particular polymer. Generally, any of the known polymers that can be formulated in a paint or coating can be used in combination with the novel low VOC multifunctional additive blends to prepare a low VOC content paint or coating without sacrificing performance properties in accordance with the present invention. In addition, the low VOC multifunctional additive blends can be used with polymer compositions that rely in whole or in part on film formation, including without limitation adhesives, glues, sealants, caulks, and some ink compositions.

Waterborne polymer film-forming compositions may comprise a variety of polymers. Suitable polymers include but are not limited to various latex and vinyl polymers including vinyl acetate, vinylidene chloride, diethyl fumarate, diethyl maleate, or polyvinyl butyral; various polyurethanes and copolymers thereof; polyamides, various polysulfides; nitrocellulose and other cellulosic polymers; polyvinyl acetate and copolymers thereof, ethylene vinyl acetate, and vinyl acetate-ethylene; and various polyacrylates and copolymers thereof.

The acrylates in particular constitute a large group of polymers of varying hardness for use with the multifunctional additive blends of the present invention and include without limitation various polyalkyl methacrylates, such as methyl methacrylate, ethyl methacrylate, butyl methacrylate, cyclohexyl methacrylate, or allyl methacrylate; various aromatic methacrylates, such as benzyl methacrylate; various alkyl acrylates, such as methyl acrylate, ethyl acrylate, butyl acrylate, or 2-ethylhexyl acrylate.

Acrylics are also useful polymers and include without limitation 100% acrylics, acrylic copolymers, acrylic acids, such as methacrylic acid; vinyl acrylics; styrenated acrylics, and acrylic-epoxy hybrids.

Other polymers include without limitation alkyds, epoxies, phenol-formaldehyde types; melamines; vinyl esters of versatic acid, and the like. While some polymers, such as alkyds, typically do not require coalescents, they may benefit in early hardness development or initial rate of hardness development from use of the low VOC multifunctional additive blends of the invention. They may also benefit by the improvement of other properties as discussed herein. Other polymers useful in waterborne coatings or other waterborne polymer film-forming compositions will be known to one skilled in the art based on the disclosure herein.

The ratio of the high volatile (VOC) component to the low volatile (VOC) component(s) in the inventive multifunctional additive blends varies from about 10:1 to about 1:10. Ratios may vary depending on the particular components of the multifunctional additive blend, the coating formulation and/or anticipated applications or uses.

Generally, the amounts of inventive multifunctional additive blends utilized in coating formulations are determined by the amount required to achieve an MFFT (minimum film forming temperature) of 32° F.-40° F. (˜0°-4.4° C.), which are standard temperatures used to determine if paint or coatings can be applied in cold weather. Amounts of the inventive low VOC multifunctional additive blends may be expressed in percentage to binder (wt. % to binder (polymer)), based on 100 grams of the binder (polymer or resin) in the coating formulation or as a percentage (wt. %) of the formulation based on the total weight of all components in the formulation. In a coating, as pigment volume concentration increases, the percentage of the inventive multifunctional additive blends in the formulation decreases, although the percentage to binder remains constant.

Exemplary amounts of the inventive multifunctional additive blends based on percentage to binder (polymer) or percentage in formulation are set forth in the examples. Suitable percentage to binder amounts range from about 0.1% to about 15%, based on 100 grams of binder, although the amounts will vary based upon the particular binder and other components utilized. Suitable percentages in formulation (based on total weight of all components) range from about 0.8 wt. % to about 5 wt. %, based on the total weight of the components of the formulation.

Applications for the use of the low VOC multifunctional additive blends of the invention include without limitation: architectural coatings, industrial coatings, OEM coatings, interior and exterior paints, metal coatings, including direct-to-metal coatings, marine coatings, film coatings, vinyl film compositions, plastic coatings, wood coatings and treatments, paper coatings, fabric coatings, textile coatings, wallpaper coatings, decorative coatings, construction coatings, cement coatings, concrete coatings, floor coatings, varnishes and inks. Other useful applications include use in adhesive compositions, glues, or other waterborne polymer film-forming compositions that require a coalescent or film formation, such as sealants and caulks. Still other useful applications will be known to one skilled in the art.

The low VOC multifunctional additives of the invention also have utility as a vehicle or carrier for pigments or colorants (colors, dyes) to be added to already prepared waterborne polymer systems. The amounts of the low VOC multifunctional additive blends used for this application will vary depending on the particular waterborne polymer system, the nature and type of pigment or colorant, and the amount of color required in the waterborne polymer system.

Certain components of the low VOC multifunctional additive blends offer a further advantage in that they have demonstrated efficacy to enhance formulation robustness with respect to in-can preservation, thus potentially significantly reducing the need for traditional in-can antimicrobial components, depending on formulation and process.

The invention is further described by the following non-limiting examples.

### EXAMPLES

Test Materials:

High Volatility Components:
2,2,4-Trimethyl-1,3-pentanediol monoisobutyrate (TXMB or TMPDMIB) (commercially available as Texanol™ from Eastman)
Benzyl alcohol
3-Phenyl propanol (3PP)
2-Methyl-3-phenyl propanol (2M3PP)
Vanillin
B-Methylcinnamyl alcohol (Cypriol)

Lower VOC Plasticizers/Coalescents/Film Formers:
K-FLEX® PG (Propylene Glycol Dibenzoate (PGDB))
K-FLEX® 500 (DEGDB/DPGDB blend)
K-FLEX® 850S or 850S (a newer grade of DEGDB/DPGDB blend)
K-FLEX® 975P or 975P (a newer dibenzoate triblend comprising DEGDB/DPGDB/1,2-PGDB)
Triethylene glycol dioctanoate (TEGDO), multiple sources
Optifilm™ Enhancer 400 or OE-400 (reported in a Safety Data Sheet to be triethylene glycol bis(ethylhexanoate-2), commercially available from Eastman Chemical)

Exemplary inventive Low VOC Multifunctional Additive Blends
X-3411, 1:1 benzyl alcohol:K-FLEX® 850S
X-3412, 1:2 benzyl alcohol:K-FLEX® 850S
X-3413, 1:3 benzyl alcohol:K-FLEX® 850S
TXMB:K-FLEX® Dibenzoates (various ratios between 10:1 to 1:10 of TXMB:K-FLEX® 850S or 975P)
benzyl alcohol:OE-400, 1:1, unless otherwise specified
Cypriol:K-FLEX® 850S, 1:1
3-PP:K-FLEX® 850S, 1:1
2M3PP:K-FLEX® 850S, 1:1
Note: The above ratios are for materials tested in the examples, although ranges for the ratio of high VOC component to the low VOC component in the inventive multifunctional additive blends may vary between 10:1 to 1:10 and are within the scope of the invention.

Comparative Reported Coalescent Blends:

TXMB:OE-400 (1:1 ratio for all examples)

Coatings: Traditional binders for coatings materials were selected for evaluating the ability of the inventive multifunctional additive blends to provide coalescence and improved properties. Experimental coatings with different binders and different glass transition temperatures and minimum film forming temperatures were utilized. The invention is not limited to use in the coatings evaluated. The following binders (polymers, resins) were evaluated.
Styrene-Acrylic Resin (commercially available as Encor® 471, from Arkema, T_{g}˜44° C.)
Styrene-Acrylic Resin (commercially available as EPS® 2533, from EPS Materials, T_{g}˜N/A)
Acrylic Resin 100% (commercially available as Encor® 626, from Arkema, T_{g}˜29° C.)
Acrylic Resin 100% (commercially available as Rhoplex™ VSR 1050, from Dow Chemical, T_{g}˜17° C.)
Styrene-Acrylic Resin (commercially available as Acronal® 296D, from BASF, T_{g}˜220C
Vinyl Acrylic Resin (commercially available as Encor® 379G, from Arkema, T_{g}˜190C
Acrylic Resin 100% (commercially available as RayCryl 1207 from Specialty Polymers, Inc. (special grade provided without in-can antimicrobial) T_{g}˜19° C.)

Test Methodology:

pH: ASTM E70—The pH of the coatings was measured using a Beckman 310 pH meter with general purpose electrode. The coatings were pH adjusted to within 8.5 to 9.5 pH using ammonium hydroxide (28%).

Stormer Viscosity: ASTM D562—Initial Stormer viscosity was measured using a Brookfield KU-2 viscometer with paddle geometry. Rheology modifier was added to adjust initial viscosity to within the range of 90-110 KU.

MFFT: ASTM D2354—Minimum film formation temperature was evaluated using a Gardco MFFT Bar 90 instrument. Polymer latex emulsions blended with nonionic surfactant and coalescent were drawn down using a MFFT draw down applicator and film formation was evaluated after one hour. The temperature gradient setting on the instrument was −5° C. to 13° C. The film formation temperature was evaluated visually, and the temperature measured using a separate temperature probe.

Low Temperature Coalescence (LTC): ASTM D7306. Paint and equipment were conditioned at 40° F. for 4 hours. Paint was drawn down on a Leneta Form HK to 3 and 10 mils wet. The films were dried horizontal at 40° F. for 18 hours and rated (lab rating 10=excellent, 0=very poor).

Scrubbability: ASTM D2486—Coatings were applied using a 7 mil Dow applicator bar to a Leneta P121-10N chart and dried at 23° C. at 50% RH for 7 days. The scrubbability was measured using a Gardco D10 Washability and Weartester. A 10 mil shim was employed with abrasive media (SC-2). Initial failure was recorded, and complete failure defined as a continuous thin line across the shim.

Block Resistance: ASTM D4946—Coatings were applied using a 3 mil bird film applicator to a Leneta form WB chart and dried in an environmentally controlled room at 23° C. and 50% relative humidity for seven days. Samples were constructed from 1.5 inch squares and oriented coating surface to coating surface with a 1 kg weight placed upon a number 8 stopper at ambient temperature or 120° F. for thirty minutes. The samples were then allowed to equilibrate at room temperature for 30 minutes and were then evaluated through “blind” testing to remove bias.

Gloss: ASTM D523—Coatings were applied using a 3 mil bird film applicator to a Leneta form WB chart and dried in an environmentally controlled room at 23° C. and 50% relative humidity for seven days. Gloss measurements were conducted in triplicate using a Gardco micro-Tri-gloss meter model 4446.

Heat Stability: ASTM D1849—Tested at 120° F. for two weeks. Initial and final viscosities taken.

Flow and Leveling: ASTM D4062—Leneta test blade was used to apply paint. Dried paint was then rated.

Hardness/Hardness Development: ASTM D4366A—Coatings were applied using a 3 mil bird film applicator to aluminum A36 Q panels and dried in an environmentally controlled room at 23° C. and 50% relative humidity. Hardness was measured using a Gardco Koenig and/or Persoz Hardness Rocker with the respective pendulums for each test. Hardness values were reported as the average of three measurements.

Freeze/Thaw Stability: ASTM D2243—Frozen at 0° C. and thawed at ambient. 3 cycles used

Washability: The paint samples were drawn down on a Leneta P-121-10N scrub chart using a7 mil Dow blade. The panels were then allowed to dry in a horizontal position for 7 days. Stains were applied to each panel in a 1 inch wide area, with a 0.25 inch space left between stains. Stains tested included: Lip stick (Rimmel, Rosseto #510, red), crayon (Crayola, red), ketchup (Hunts Tomato Ketchup, no preservatives), mustard (French's Classic Yellow prepared mustard packets, pencil (Papermate Micrado Classic HB #2), coffee (Safeway Signature Select: sun Kissed Blonde), food Coloring (McCormick Food Color & Egg Dye, green), wine (Gnarly Head Wines, old vine zinfandel, 2016 Lodi zinfandel), permanent marker (Sharpie Magnum, black), ball point pen (Papermate Flexgrip Ultra 0.8F, black), and washable marker (Mr. Sketch, blue). A Kim wipe was used to apply coffee, wine and food coloring by placing the dry Kim wipe on the panel and saturating it with stain. The stains were left for 1 hour, after which any excess was removed. A C-31 sponge with 10 g Formula 409 multipurpose-lemon hard surface cleaner was used to wash each panel with 50 cycles. Permanent market, washable marker, and ball point pen stains were washed separately to avoid bleeding. The panel was then rinsed, blotted dry and allowed to dry thoroughly in a horizontal position overnight. The Δ (delta) E of stained area vs white, unwashed area was measured using a colorimeter. A visual assessment was also performed.

Dirt Pick Up: The paint sample was applied by 3 mil drawdown on an aluminum Q36 panel. The panel was allowed to dry in a horizontal position for 7 days. The top half of the panel was covered up and the synthetic dirt was spread evenly over the uncovered portion. The panel was placed in a 50° C. oven for 30 minutes. The panels were removed from the oven and the loose dirt was removed by tapping on the panel. The top portion of the panel was uncovered. The % Y reflectance of the tested part and the untested part were read.

Burnish Resistance: ASTM D6736.

Freeze Thaw: ASTM D2243—Formulated coatings were allowed to equilibrate in an environmentally controlled room at 23° C. and 50% relative humidity for seven days prior to freeze-thaw cycles. Samples were exposed to three freeze cycles. Each freeze-thaw cycle consisted of placing the sample into a −18° C. freezer for 17 hrs., followed by a room temperature equilibration of seven hours followed by a viscosity measurement and then immediately repeating the freeze-thaw cycle. Viscosity was measured using a Stormer viscometer with paddle type rotor.

Flash rust: Formulated coatings were allowed to equilibrate in an environmentally controlled room at 23° C. and 50% relative humidity for seven days prior to draw downs. A sealed polycarbonate box with a tray full of water was placed into an oven set to 50° C. and allowed to equilibrate overnight. 0.025 g of synthetic soil was rubbed on a cold roll steel panel for 30 seconds. Compressed air was used to remove excess soil from the surface. Coatings were drawn down on each panel using a 3 mil bird film applicator, then immediately a mist of water was sprayed over the panel. The panel was then immediately placed into the equilibrated polycarbonate chamber in the oven. The test panel was removed after 90 minutes and evaluated for rust formation on a 0-4 scale. A rating of 0 corresponds to no rust formation and 4 would correspond to severe flash rust. Each test was performed in duplicate and exposed alongside a negative control panel.

Wet Adhesion: ASTM D3359 Method B: Coatings were drawn down at 6 mil wet on a cleaned cold roll steel panel and dried 21 days at ASTM standard conditions. Panels were fully immersed in deionized water for 60 minutes. Panels were gently patted dry for one minute. Three specimens were crosshatched on the same panel using a 5 mm blade with 5 teeth (PA-2253). A three inch piece of Intertape 51596 was cut and the untouched center laid over the crosshatch. The tape was wiped firmly only once with an index finger. The tape was pulled back quickly after 60 seconds and rated using the ASTM method.

Other methodologies utilized are in the table below:

| Test | Reference/method |
|---|---|
| Contrast Ratio | ASTM D2805 |
| Dry Adhesion | ASTM D3359B-Paint was applied to dried aged alkyd with |
| | a brush and dried for 7 days before testing by cross hatch |
| | tape adhesion. |
| Drying Time | ASTM D1640-3 mil wet film applied to Leneta 3B, set to |
| | touch determined at ambient. |
| Mudcracking | Paint was applied with a Leneta Antisag meter (14-60 mils) |
| | on an HK chart at ambient and 40° F. After 24 hours dry the |
| | greatest mils without cracking noted, |
| Print Resistance | ASTM D2064 |
| Sag Resistance | ASTM D4400 |
| Touch Up | Touch up was tested with the paint prepared for the color |
| | acceptance. Self-primed Upsom was used and applied with |
| | a Linzer 2″ Bristle and polyester brush at RT and 40° F. and |
| | allowed to dry overnight. The test paint was applied and |
| | rated for sheen uniformity and color difference. |
| Wet Edge/ | Paint applied with notched drawdown bar on Leneta WB |
| Open Time | chart. At 1 minute intervals 1/4 of 1″ brush was dipped into |
| | the paint and brushed 10 strokes across the line. The wet |
| | edge was rated with the lab system. |

Materials Used in the Examples

Generally, a coating is a combination of a pigment, a binder, a solvent, and other additives, such as coalescents or film-forming aids. The binder (or resin or polymer) is usually how a coating is named, such as acrylic, polyurethane, styrene-acrylic, and the like. The binders are responsible for adhesion, durability, flexibility, gloss and other physical properties of the coating composition. Typical coating compositions used in the examples are shown in Tables 1, 2, 3 and 4 below, although the invention is not limited as such. Flat coatings had 45% PVC, semigloss had 14% PVC and all of the coatings were at 40% volume solids as a base, not taking into account the coalescent addition.

TABLE 1
Coating Formulation-Encor 626 Flat

| INGREDIENT | WEIGHT (KG) |
|---|---|
| Grind | |
| Water | 241.73 |
| Natrosol HBR 250 | 1.93 |
| Tamol 851 | 8.97 |
| Carbowet GA-200 | 2.24 |
| BYK 28 | 2.49 |
| R-902+ | 176.46 |
| Optiwhite | 201.09 |
| Let Down | |
| Encor 626 | 330.46 |
| Water | 31.32 |
| Coatings Multifunctional | Varies |
| Additive/Modifier | (see below) |
| BYK 28 | 0.47 |
| Natrosol HBR 250 | 2.82 |
| Ammonia (28%) pH adjust to 9 | Q.S. |
| Coatings Additives | |
| TXMB | 10.57 |
| OE-400 | 11.75 |
| 850S | 13.16 |
| BA 1:1 850S | 8.25 |
| BA 1:2 850S | 9.91 |
| BA 1:3 850S | 10.64 |

TABLE 2
Coating Formulation-Encor 471 Flat

| INGREDIENT | WEIGHT (KG) |
|---|---|
| Grind | |
| Water | 242.11 |
| Natrosol HBR 250 | 1.94 |
| Tamol 851 | 8.99 |
| Carbowet GA-200 | 2.25 |
| BYK 28 | 2.50 |
| R-902+ | 176.74 |
| Optiwhite | 201.40 |
| Let Down | |
| Encor 471 | 345.1 |
| Water | 15.69 |
| Coatings Multifunctional | Varies |
| Additive/Modifier | (see below) |
| BYK 28 | 0.47 |
| Natrosol HBR 250 | 2.82 |
| Ammonia (28%) pH adjust to 9 | Q.S. |
| Coatings Additive | |
| TXMB | 29.77 |
| OE-400 | 24.16 |
| 850S | 33.52 |
| BA 1:1 850S | 27.29 |
| BA 1:2 850S | 28.92 |
| BA 1:3 850S | 29.61 |

TABLE 3
Coating Formulation-Encor 626 SG

| INGREDIENT | WEIGHT (KG) |
|---|---|
| Grind | |
| Water | 77.94 |
| Natrosol HBR 250 | 0.62 |
| Tamol 851 | 5.47 |
| Carbowet GA-200 | 1.37 |
| BYK 28 | 0.97 |
| R-902+ | 125.08 |
| Optiwhite | 38.98 |
| Let Down | |
| Encor 626 | 625.21 |
| Water | 120.23 |
| Coatings Multifunctional | Varies |
| Additive/Modifier | (see below) |
| BYK 28 | 0.69 |
| Natrosol HBR 250 | 3.44 |
| Ammonia (28%) pH adjust o 9 | Q.S. |
| Coatings Additive | |
| TXMB | 20.01 |
| OE-400 | 22.23 |
| 850S | 24.90 |
| BA 1:1 850S | 15.60 |
| BA 1:2 850S | 18.76 |
| BA 1:3 850S | 20.13 |
| TXMB:OE-400 (1:1) | 20.26 |
| BA:OE-400 (1:1) | 16.63 |

TABLE 4
Coating Formulation-Encor 471 SG

| INGREDIENT | WEIGHT (KG) |
|---|---|
| Grind | |
| Water | 77.45 |
| Natrosol HBR 250 | 0.6195625 |
| Tamol 851 | 5.43 |
| Carbowet GA-200 | 1.3585305 |
| BYK 28 | 0.97 |
| R-902+ | 124.29 |
| Optiwhite | 38.74 |
| Let Down | |
| Encor 471 | 645.16 |
| Water | 102.41 |
| Coatings Additive | Varies |
| | (see below) |
| BYK 28 | 0.51 |
| Natrosol HBR 250 | 3.07 |
| Ammonia 28% pH adjust to 9 | Q.S. |
| Coatings Additives | |
| TXMB | 55.68 |
| OE-400 | 45.18 |
| 850S | 62.70 |
| BA 1:1 850S | 51.03 |
| BA 1:2 850S | 54.09 |
| BA 1:3 850S | 55.38 |
| TXMB:OE-400 (1:1) | 45.67 |
| BA:OE-400 (1:1) | 43.61 |

TABLE 5
Coating Formulation-EPS 2535

| INGREDIENT | WEIGHT (kg) |
|---|---|
| Grind | |
| Water | 81 |
| Nuosperse W-22 | 18 |
| Biosoft N1-3 | 3 |
| AMP-95 | 1 |
| Byk-024 | 1.5 |
| TiPure R-706 | 100 |
| Atomite, 3 microns | 200 |
| Shieldex AC-5 | 15 |
| SZP-391 | 25 |
| Let Down | |
| EPS 2535 | 425 |
| Byk-024 | 0.5 |
| Nuosept 101 | 1 |
| Water | 120.9 |
| Rheolate 1 | 4 |
| Dipropylene glycol | 28.7 |
| n-butyl ether (DPnB) | |
| Propylene Glycol Dibenzoate | 28.7 |
| Benzoic acid (12% solution | 10 |
| with 10% NH₄OH) | |
| Acrysol RM-825 | 2.25 |
| Total | ~1075 |

It was found that by formulating coatings using a low VOC multifunctional additive blend comprising: high volatile compounds, such as TXMB, benzylamine, phenoxyethanol, phenyl ethanol, benzyl alcohol, benzyl benzoate, 3-phenyl propanol (3-PP), 2-methyl-3-phenyl propanol, vanillin or P-methylcinnamyl alcohol (cypriol) in combination with traditional low VOC coalescents or film-formers, including without limitation dibenzoate esters, monobenzoates, phthalates, terephthalates, 1,2-cyclohexane dicarboxylate esters, citrates, OE-400, TEGDO, and others, unexpected improvement in performance properties were achieved while maintaining VOC content at lower levels in comparison to conventional high VOC coating formulations containing the industry standard high VOC coalescent 2,2,4-trimethyl-1,3-pentanediol monoisobutyrate (TXMB) alone or in combination with OE-400/TEGDO. The inventive low VOC multifunctional additive blends also showed unexpected improvement in performance properties when compared to use of traditional low VOC coalescent compounds alone, with minimal increases in VOC content. Improvements may vary depending on use or application or specific components of the formulation.

As is typical, loading levels for coalescents were fixed by determining the amount required in each binder to achieve a minimum film formation temperature (MFFT) of less than 40° F. (˜4.4° C.). In the examples herein, loading levels for the low VOC multifunctional additives are expressed in percentage (%) additive to binder, based on 100 grams of binder, unless otherwise specified. Low VOC multifunctional additive levels may also be expressed at times in wt. % based on the total weight of the formulation. VOC content calculations for each formulation assumed TXMB was 100%, according to EPA Method 24. The VOC content for K-FLEX® 850S has been published previously (2.2 wt. % by ASTM D2369) and was used to estimate VOC contribution.

### Example 1—Evaluation of Scrub Resistance

Dibenzoate coalescents offer, in addition to coalescence, scrub resistance performance advantages in coatings in comparison to that achieved with TXMB alone. However, results may vary depending on the particular dibenzoate utilized and the properties of the binder or the formulation.

FIGS. 1 through 6 show enhanced scrub resistance performance for the inventive low VOC multifunctional additives using blends of TXMB (high volatility component) with a low volatility component (dibenzoate esters) in various ratios vs. paints made with each of the components alone. The high volatility component, TXMB, was combined with lower VOC dibenzoates in experimental samples to form a lower VOC multifunctional additive. FIG. 1 shows scrub resistance results achieved for a harder styrene-acrylic resin (Encor 471) using TXMB alone, K-FLEX® 975P, alone, and a 70:30 blend of TXMB to 975P. The blended low VOC multifunctional additive had lower VOC's than the traditional high volatility component TXMB (although higher than the commercial dibenzoates), and synergistically improved scrub resistance when compared with the TXMB control and the commercial dibenzoate alone.

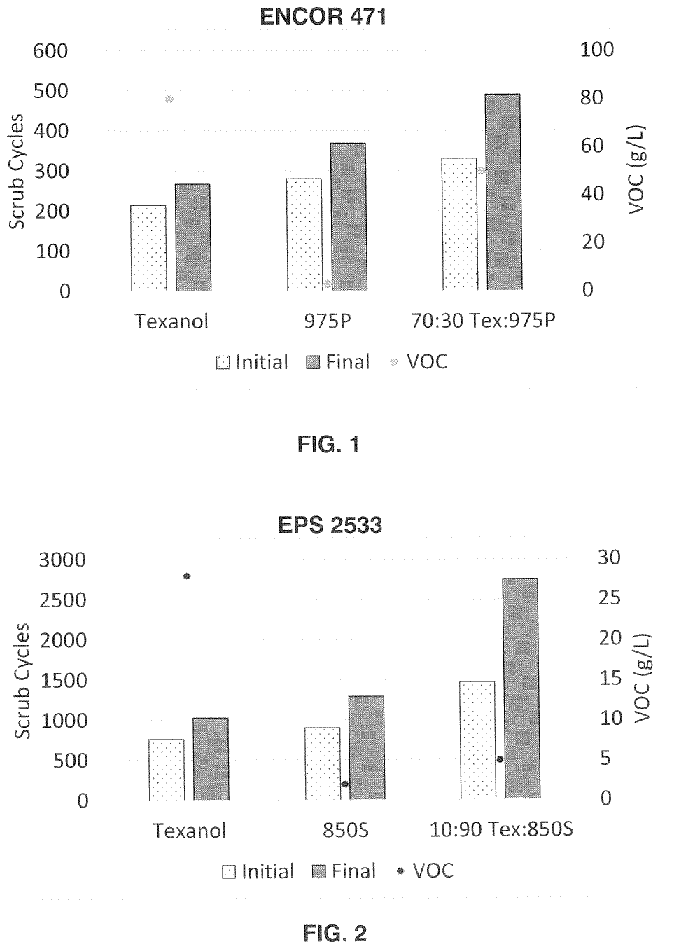

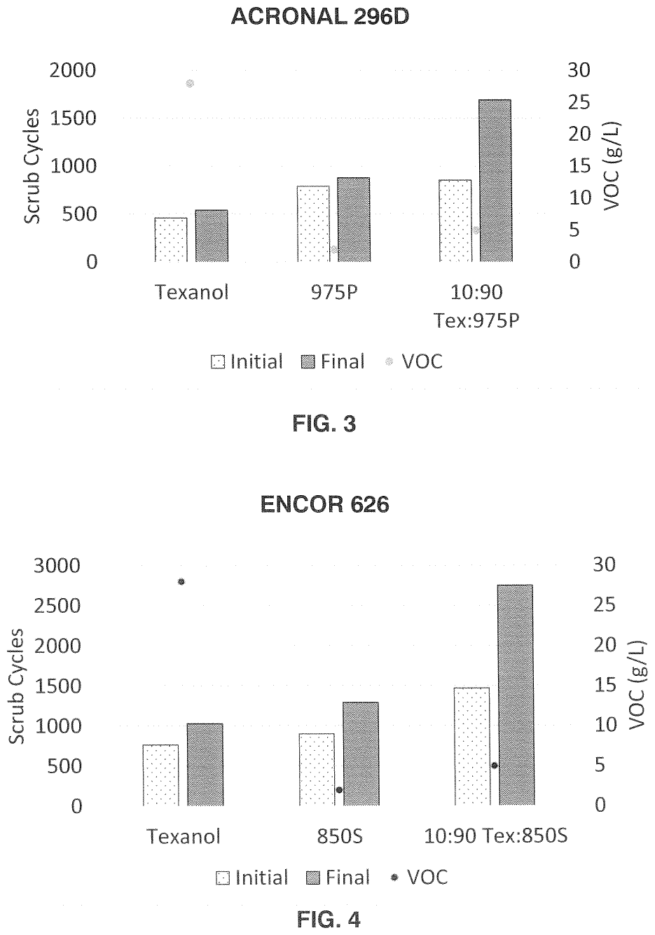

FIG. 2 demonstrated similar scrub resistance results achieved using another styrene-acrylic resin (EPS 2533) comparing TXMB alone, K-FLEX® 975P alone, and a 70:30 blend of TXMB to 975P. FIG. 3 shows similar scrub resistance results achieved for a blended low VOC multifunctional additive of 10:90 TXMB:975P, when used in another styrene acrylic resin (Acronal 296D), although VOC's were much lower in this resin as compared to the other styrene-acrylic resin.

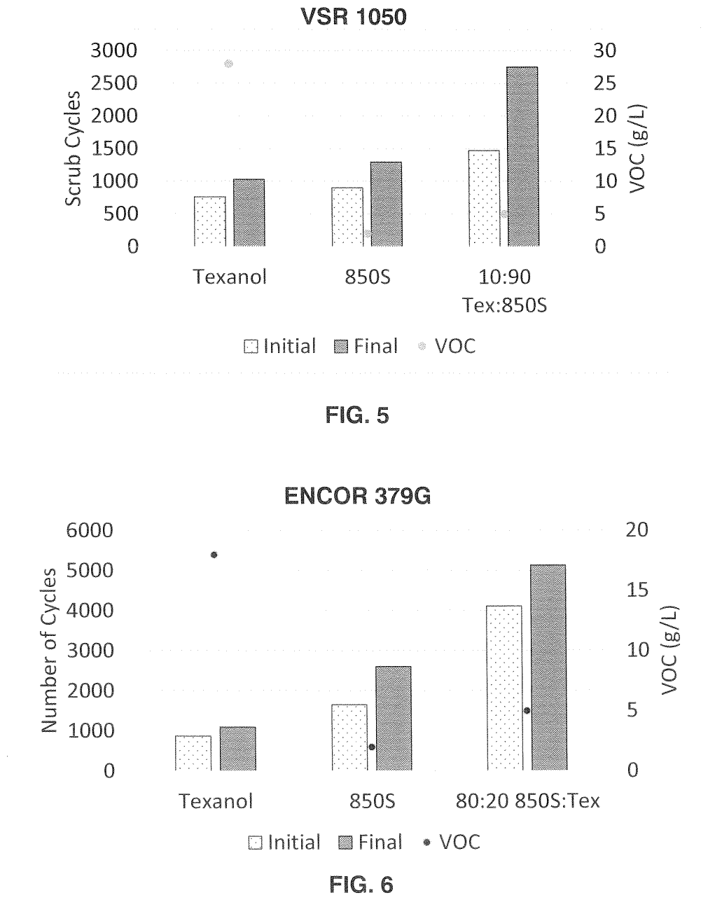

Similar scrub resistance results were obtained when using a blended low VOC multifunctional additive comprising TXMB and K-FLEX® 850S. FIG. 4 shows similar scrub resistance results achieved for the multifunctional additive comprising 10:90 TXMB:K-FLEX® 850S, when used in a 100% acrylic resin (Encor 626) and also had low VOC's. FIG. 5 also shows similar results achieved for the same multifunctional additive (10:90 TXMB:850S) when used in another 100% acrylic resin (VSR 1050). FIG. 6 shows similar results achieved for a vinyl acrylic resin (Encor 379G) using a multifunctional additive comprising 80:20 TXMB:850S. This multifunctional additive blend also had low VOC's. Still other scrub resistance data for various multifunctional additive blends of TXMB: 850S and TXMB:975P is set forth in Example 21.

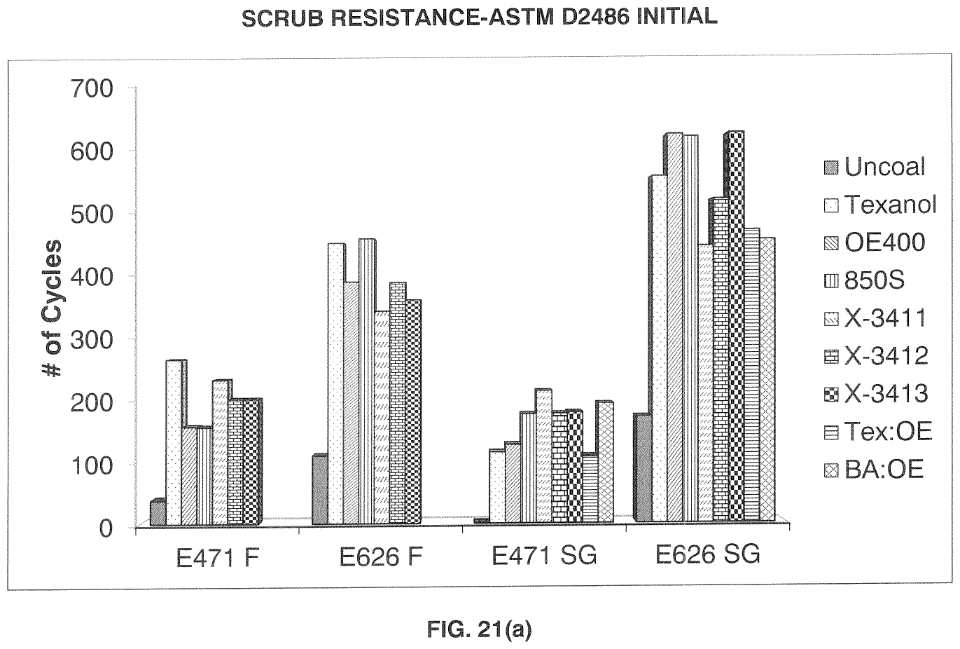

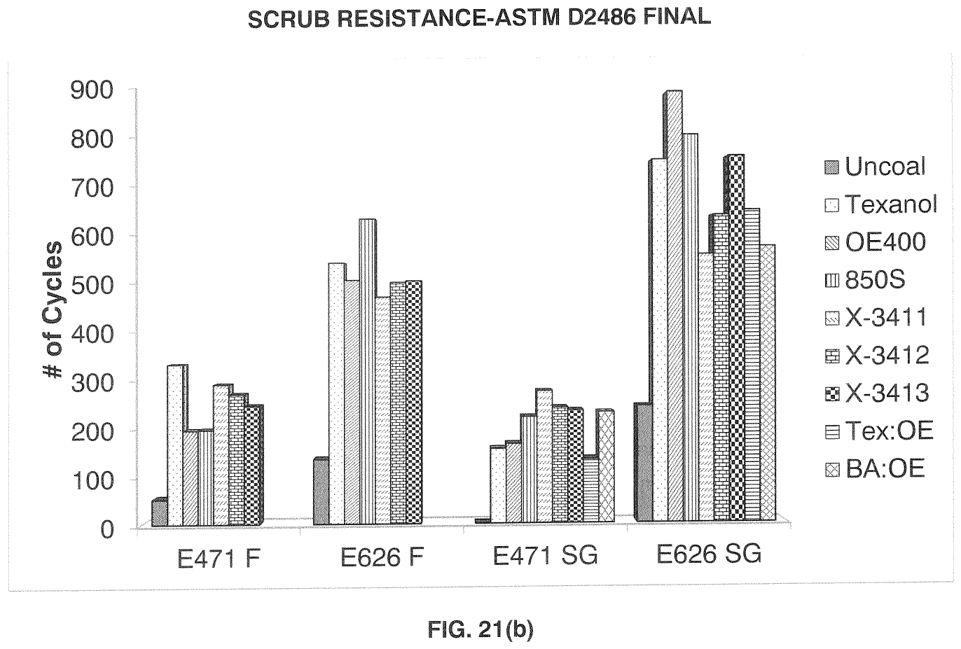

Additional scrub resistance was determined for Encor 471 and Encor 626 flat and semigloss samples using ASTM D2486 and comparing an uncoalesced sample, TXMB, OE-400, K-FLEX® 850S, three inventive low VOC multifunctional additive blends based on a dibenzoate of X-3411, X-3412, and X-3413, TXMB:OE-400 (1:1 ratio) and another inventive low VOC multifunctional additive blend of benzyl alcohol:OE-400 (1:1 ratio). Results are shown in FIGS. 21 (a) (initial) and 21 (b) (final). The inventive multifunctional additive X-3413 showed improved scrub resistance as compared to TXMB and comparable scrub resistance to OE-400 and K-FLEX® 850S in the Encor 626 semigloss sample. In the flat samples and Encor 471 semigloss, X-3411, X-3412, and X-3413 performed comparably to the other coalescents and blends.

The results obtained demonstrated significant improvement in scrub resistance for the blended multifunctional additives of the invention when compared to that achieved with the traditional high volatility TXMB coalescent and the lower VOC dibenzoate coalescent alone. While the lower VOC dibenzoate coalescent had the lowest VOC's, the blended multifunctional additive comprising the dibenzoate and TXMB still had significantly lower VOC's as compared to the traditional high VOC coalescent TXMB alone.

### Example 2—Koenig Hardness

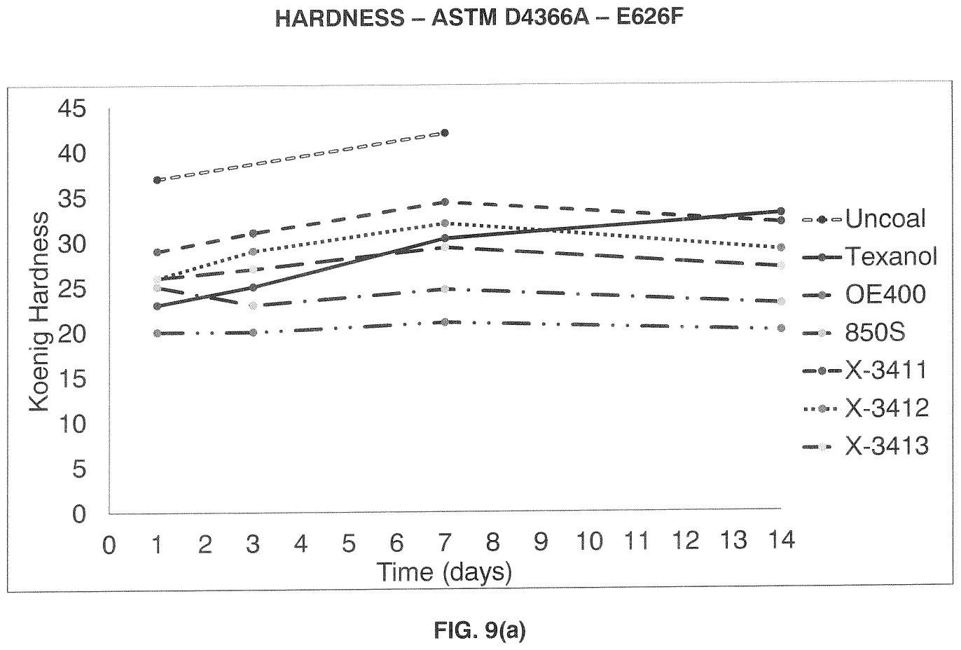

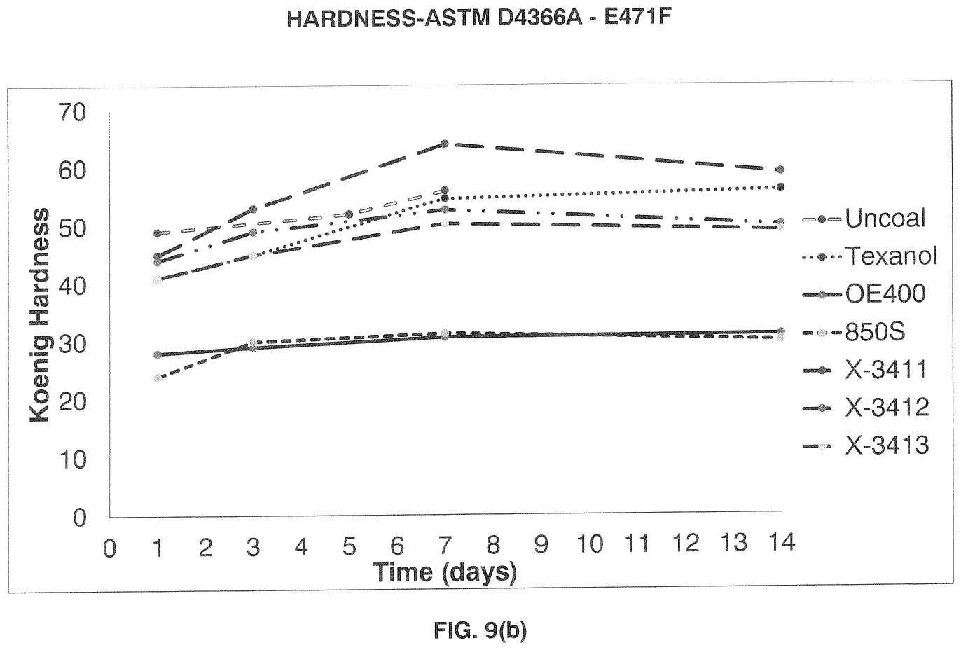

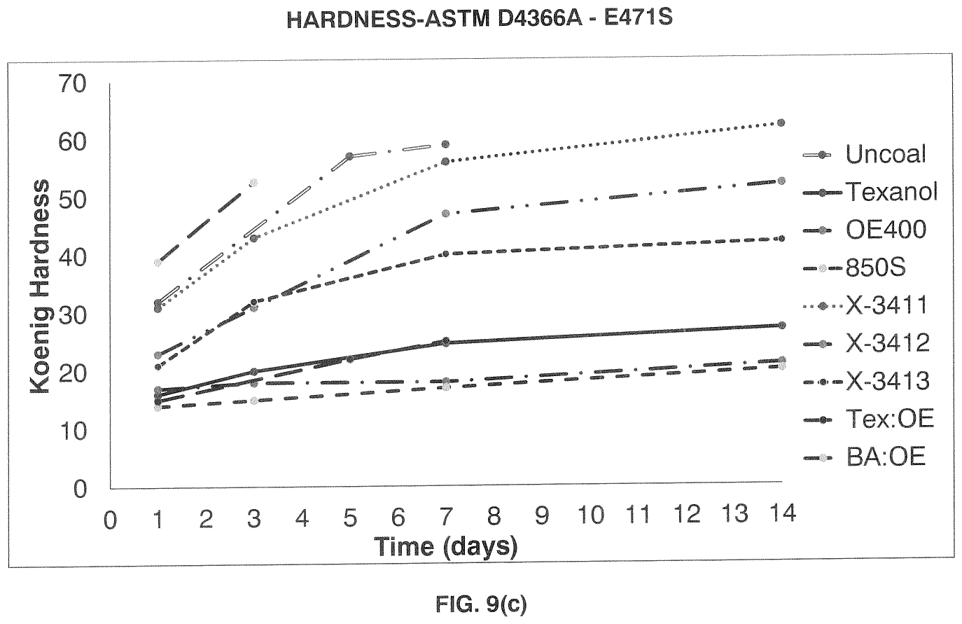

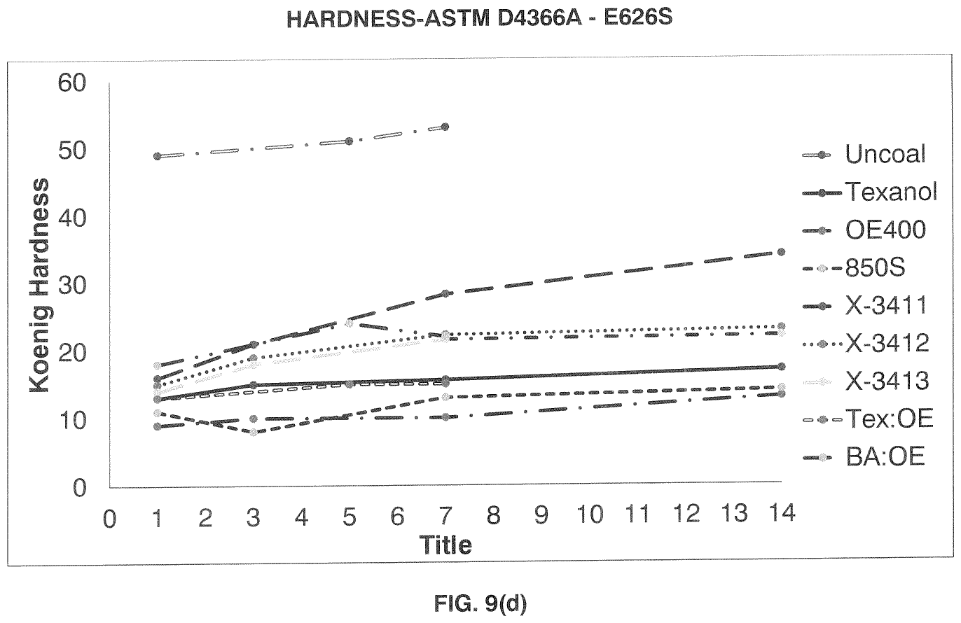

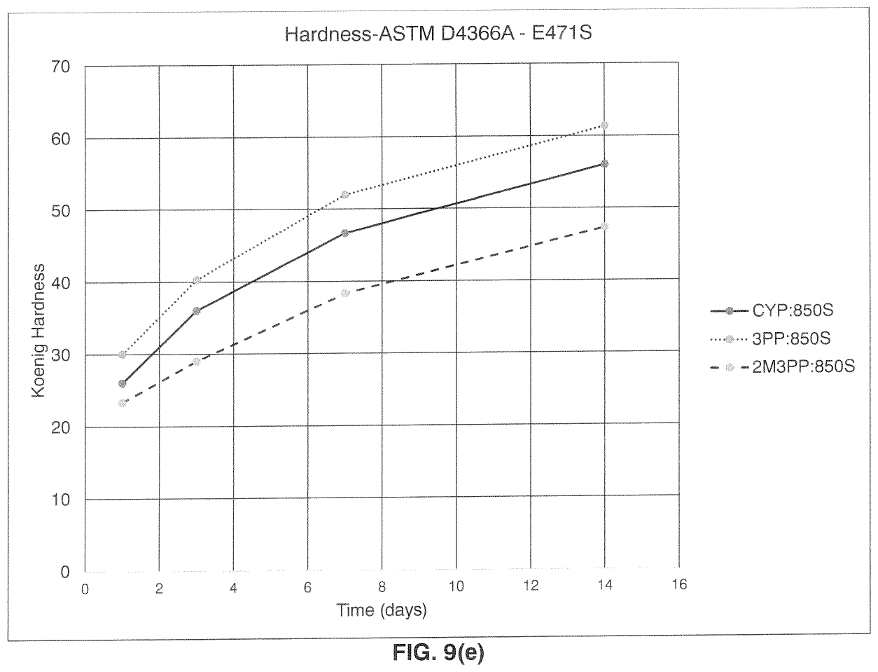

Hardness testing using ASTM D4366A methodology was performed on Encor 471 flat and semigloss samples and Encor 626 flat and semigloss samples comprising TXMB, OE-400, K-FLEX® 850S, and three inventive multifunctional additive blends (X-3411, 1:1 benzyl alcohol:K-FLEX® 850S; X-3412, 1:2 benzyl alcohol:K-FLEX® 850S; X-3413, 1:3 benzyl alcohol:K-FLEX® 850S). Results for flat samples (Encor 626 and Encor 471) are shown in FIGS. 9 (a) and 9 (b), both of which also show a comparison with an uncoalesced sample.

Hardness results for semigloss samples of Encor 471 and Encor 626, comparing TXMB, OE-400, K-FLEX 850S, three inventive multifunctional additive blends of X-3411, X-3412, X-3413, a blend of TXMB:OE-400 (1:1 ratio), and two other inventive multifunctional additive blends of benzyl alcohol:OE-400 (1:1 ratio) of β-methylcinnamyl alcohol (CYP or cypriol) and 850S (1:1 ratio), and an uncoalesced sample are shown in FIGS. 9 (c), 9 (d), and 9 (e). FIG. 9 (e) shows hardness development for K-FLEX®850S combined with volatile components β-methylcinnamyl alcohol or Cypriol (CYP), 3-phenyl propanol (3PP), 2 methyl-3-phenylpropanol (2M3PP), all combinations at a 1:1 ratio. Each of these blends demonstrates improvements in hardness development over that of the higher VOC TXMB control shown in FIG. 9 (c).

Blends of TXMB and OE-400 are known and have been reported to be practiced in the industry to mitigate costs and volatility. Yet, when compared with the inventive multifunctional additive blends, the unexpected hardness achieved by use of the multifunctional additive blends of the invention was not demonstrated for the industry-practiced TXMB:OE-400 blend.

The results demonstrated that the inventive multifunctional additive blends achieved coalescence while performing significantly better. Hardness was much improved over that achieved with the low VOC coalescents OE-400 and K-FLEX® 850S alone or the industry-practiced blend of TXMB:OE-400. Results for the inventive multifunctional additive blends compared to the industry standard high volatility coalescent TXMB were notably improved, although not to the extent that they were when compared to OE-400 and K-FLEX® 850S. Surprisingly, although a blend of a high volatile component (TXMB) and a low volatile component (OE-400) has been utilized in the past, the performance of this particular blend was very poor in comparison to the inventive multifunctional additive blends.

### Example 3—Block Rating

Block resistance testing was performed on Encor 471 flat and semigloss samples and Encor 626 flat and semigloss samples comprising TXMB, K-FLEX® 850S, and three inventive multifunctional additive blends (X-3411, 1:1 benzyl alcohol:K-FLEX® 850S; X3412, 1:2 benzyl alcohol:K-FLEX® 850S; X-3413, 1:3 benzyl alcohol:K-FLEX® 850S), TXMB:OE-400 (1:1 ratio) and an inventive multifunctional additive blend of benzyl alcohol:OE-400 (1:1 ratio), using ASTM D4946 at ambient and 50° C. Historically, high VOC coalescents perform very well in block resistance testing.

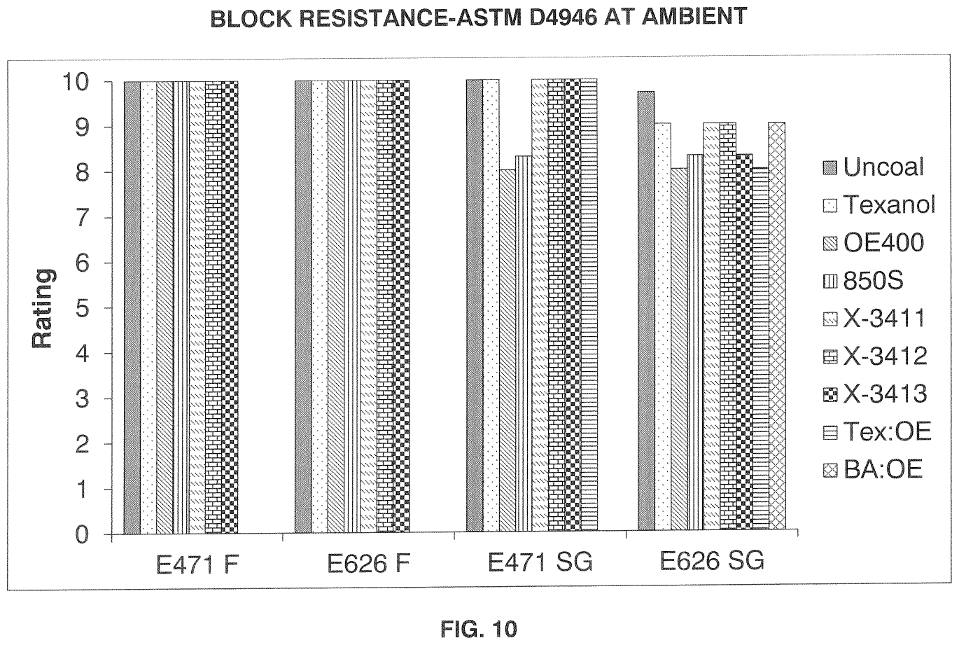

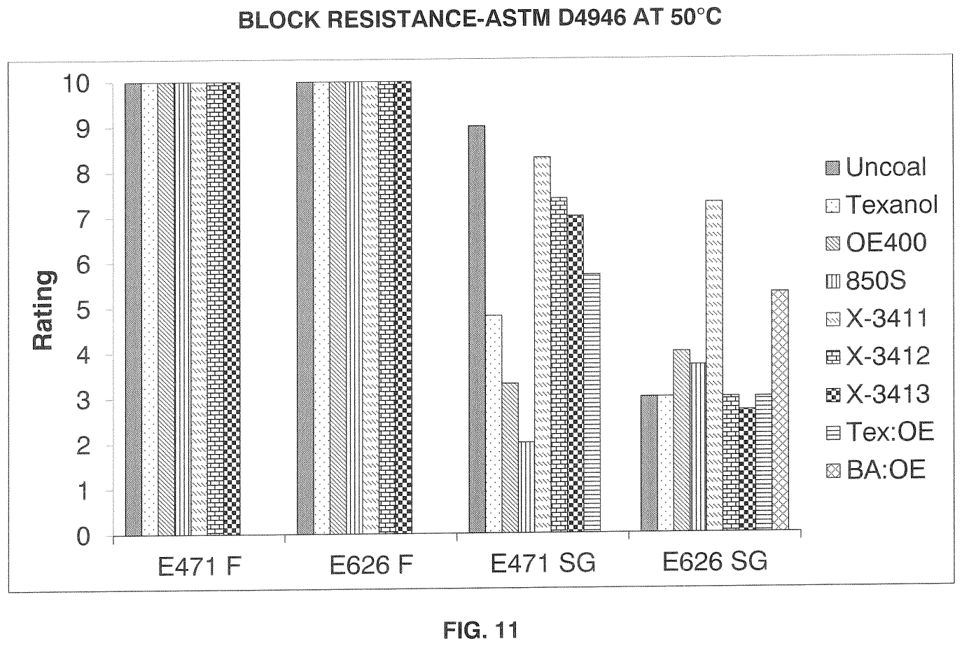

Results are shown in FIGS. 10 and 11. All of the coalescents and multifunctional additive blends performed comparably in the flat samples at ambient or 50° C. In the semigloss samples, at ambient temperature, the inventive multifunctional additive blends performed comparably to TXMB alone and comparable or better than OE-400 and K-FLEX® 850S alone. At 50° C., the inventive multifunctional additive blends performed better than TXMB, OE-400, K-FLEX® 850S, and the industry practiced TXMB:OE-400 blend in the Encor 471 sample. X-3411 and the benzyl alcohol:OE-400 blend performed better than TXMB, OE-400, K-FLEX® 850S, and the industry practiced TXMB:OE-400 blend, with X-3412 and X-3413 performing comparably to the other coalescents and blends.

### Example 4—MFFT Testing and Calculated VOC Addition to Formula

The amounts of TXMB, K-FLEX® 850S, and three ratios of benzyl alcohol to K-FLEX® 850S (inventive multifunctional additives X-3411, X-3412 and X-3413) were evaluated to determine the amount of coalescent needed to achieve 4.4° C. MFFT (minimum film forming temperature) for two binders, i.e., Encor 626 acrylic (T_{g}˜ 29° C.) and Encor 471 styrene-acrylic (T_{g}˜44° C.). Amount of VOC's (g/L) contributed to wet paint (water included) and dry paint (water excluded) were calculated. The results for the Encor 626 acrylic show that the amounts of inventive multifunctional additives required to be added to achieve a 4.4° C. MFFT were lower than that required for the dibenzoate K-FLEX®850S alone and comparable to or slightly lower than that required for TXMB alone, depending on the ratio of benzyl alcohol to K-FLEX® 850S. The calculated VOC contribution was higher for all inventive benzyl alcohol/K-FLEX® 850S combinations vs. K-FLEX® 850S alone, but significantly lower than that calculated for the high volatility TXMB alone. For Encor 471, the results show that the amounts of inventive multifunctional additives required to be added to achieve a 4.400 MFFT were lower than that required for the dibenzoate K-FLEX® 850S alone and comparable to or slightly lower than that required for TXMB alone, depending on the ratio of benzyl alcohol to K-FLEX® 850S. The amounts required and VOC calculations are set forth in the tables below:

ENCOR 626 ACRYLIC (T_{g}^{~}29° C.)
Required Amount for 4.4° C. MFFT

| | | | | Calculated VOC | |
|---|---|---|---|---|---|
| | | | | Add to Formula | |
| | | PVC 25 | PVC 45 | PVC 25 | PVC 45 |
| | | % in | % in | Include/ | Include/ |
| | % to | Formulation | Formulation | Exclude | Exclude |
| Sample | Binder | (Semigloss) | (Flat) | Water g/L | Water g/L |
| TXMB | 3.2% | 1.5% | 1.1% | 20/31 | 14/21 |
| K-FLEX ® 850S | 4.0% | 1.9% | 1.3% | 0.2/0.4 | 0.16/0.24 |
| X-3411 | 2.5% | 1.2% | 0.8% | 8/12 | 6/8 |
| Multifunctional | | | | | |
| Additive Blend | | | | | |
| X-3412 | 3.0% | 1.4% | 1.0% | 6/10 | 5/6 |
| Multifunctional | | | | | |
| Additive Blend | | | | | |
| X-3413 | 3.2% | 1.5% | 1.1% | 5/8 | 4/5 |
| Multifunctional | | | | | |
| Additive Blend | | | | | |

ENCOR 471 STYRENE-ACRYLIC (T_{g}^{~}44° C.)
Required Amount for 4.4° C. MFFT

| | | | | Calculated VOC | |
|---|---|---|---|---|---|
| | | | | Add to Formula | |
| | | PVC 25 | PVC 45 | PVC 25 | PVC 45 |
| | | % in | % in | Include/ | Include/ |
| | % to | Formulation | Formulation | Exclude | Exclude |
| Sample | Binder | (Semigloss) | (Flat) | Water g/L | Water g/L |
| TXMB | 8.6% | 4.2% | 2.7% | 52/83 | 38/54 |
| K-FLEX ® 850S | 9.7% | 4.7% | 3.0% | 1/2 | 1/1 |
| X-3411 | 7.9% | 3.9% | 2.5% | 25/39 | 18/26 |
| Multifunctional | | | | | |
| Additive Blend | | | | | |
| X-3412 | 8.4% | 4.1% | 2.6% | 18/28 | 13/19 |
| Multifunctional | | | | | |
| Additive Blend | | | | | |
| X-3413 | 8.6% | 4.2% | 2.7% | 14/21 | 10/15 |
| Multifunctional | | | | | |
| Additive Blend | | | | | |
| Cypriol-850S | 8.0% | 3.9% | 2.5% | 25/39 | 18/25 |
| Multifunctional | | | | | |
| Additive Blend | | | | | |
| 3-PP-850S | 8.2% | 4.0% | 2.6% | 25/40 | 18/26 |
| Multifunctional | | | | | |
| Additive Blend | | | | | |
| 2M-3PP-850S | 8.2% | 4.0% | 2.6% | 25/40 | 18/26 |
| Multifunctional | | | | | |
| Additive Blend | | | | | |

PVC is Pigment Volume Concentration % to binder is based on 100 grams of binder. % in Formulation is the amount of coalescent in the composition, which varies based on the PVC.

### Example 5—Flow & Leveling

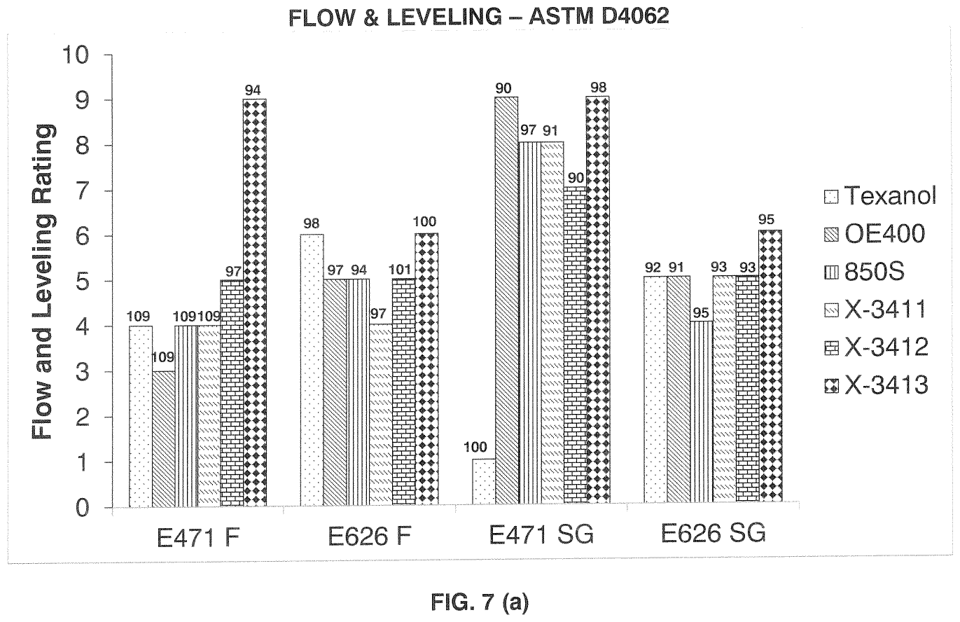

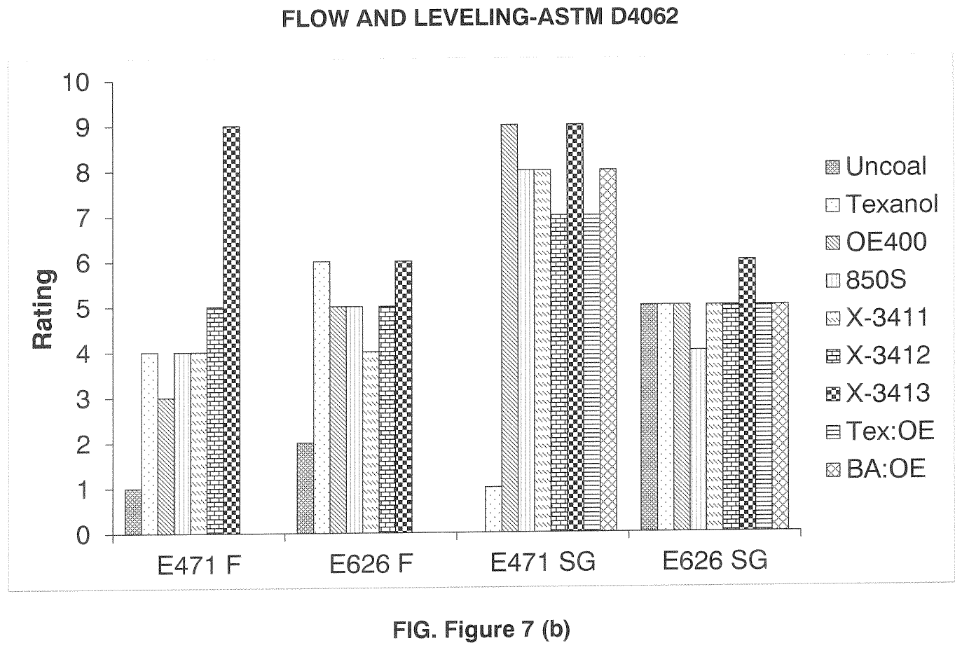

Using ASTM D4062 methodology, flow and leveling was evaluated for samples of Encor 471(flat), Encor 471 (semi-gloss), Encor 626 (flat) and Encor 626 semigloss. comparing TXMB, OE-400, K-FLEX® 850S, X-3411 (1:1 benzyl alcohol:K-FLEX® 850S), X-3412 (1:2 benzyl alcohol:K-FLEX® 850S), and X-3413 (1:3 benzyl alcohol:K-FLEX®850S). Flow and leveling is very sensitive to viscosity, with higher viscosity impeding flow. Despite similarities in viscosity (Stormer), the inventive multifunctional additive blend X-3413 achieved greater flow and leveling ratings for both Encor 471 samples (flat and semigloss) than any other coalescent or blend tested. In the Encor 471 semi-gloss sample, X-3411 and X-3412 performed comparably to OE-400 and K-FLEX® 850S and better than TXMB. All of the inventive multifunctional additive blends (X-3411, X-3412 and X-3413) performed at least comparably to the other coalescents tested in the Encor 626 semigloss sample. Results achieved in are shown in FIG. 7 (a), and a comparison with an uncoalesced sample and TXMB:OE-400 (1:1 ratio) and benzyl alcohol:OE-400 (1:1 ratio) blends is shown in FIG. 7 (b).

### Example 6—Burnish Resistance

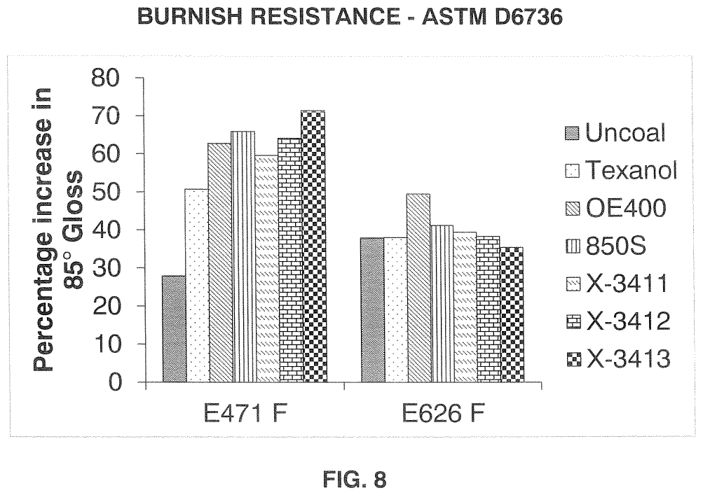

Burnish resistance for uncoalesced samples, and samples comprising TXMB, OE-400, K-FLEX® 850S, X-3411, X-3412 and X-3413 was evaluated in Encor 471 Flat and Encor 626 flat samples. Burnish resistance is tested only on flat formulations. The lower the percentage increase in gloss (%) after twenty rounds of burnishing with cheesecloth, the better rating. The X-3413 inventive multifunctional additive blend had the lowest rating for all coalescents or blends evaluated for the Encor 626 sample, with the X3411 and X3412 multifunctional additive blends performing slightly better or comparable to the other traditional coalescents. Results achieved are compared to an uncoalesced sample as shown in FIG. 8.

### Example 7—Low Temperature Coalescence

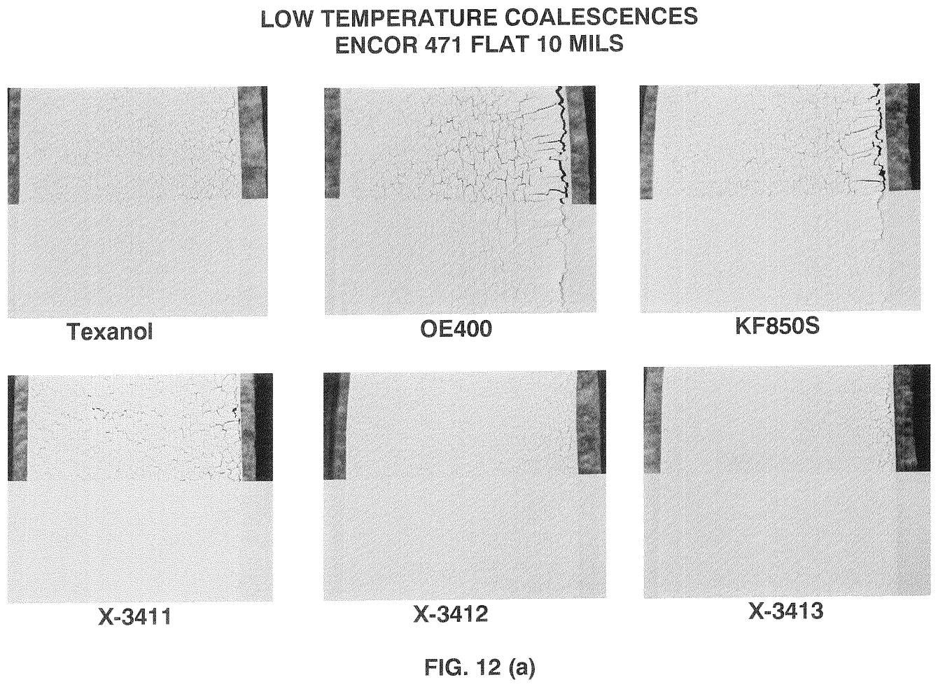

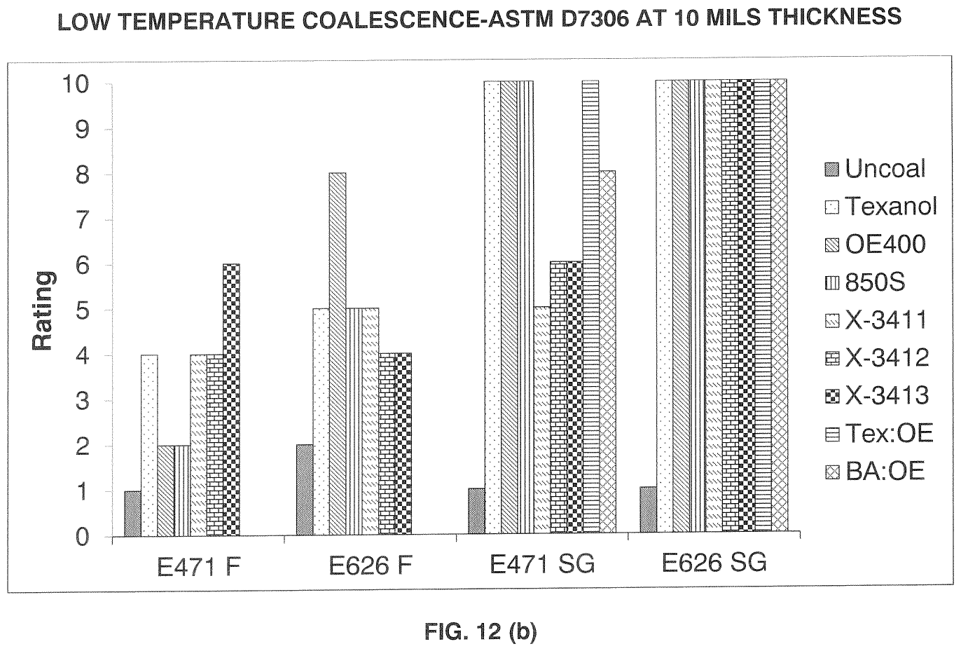

Low temperature coalescence was evaluated in an Encor 471 Flat formulation (10 mils). Coalescents and blends evaluated were TXMB, OE-400, K-FLEX® 850S, X-3411 (1:1 benzyl alcohol:K-FLEX® 850S), X-3412 (1:2 benzyl alcohol:K-FLEX® 850S), and X3413 (1:3 benzyl alcohol:K-FLEX® 850S). Results achieved are shown in photographs (FIG. 12(a)). The results demonstrate that, despite all of the binders having each individual coalescent or blend optimized to achieve MFFT of 4.4° C., the inventive multifunctional additive blends performed better than the other coalescents at low temperature coalescence.

Additional low temperature coalescence using ASTM D7306 methodology at 10 mils thickness was performed on flat and semi-gloss samples of Encor 471 and Encor 626, comparing an uncoalesced sample, TXMB, OE-400, K-FLEX 850S, X-3411, X-3412, X-3413, a blend of TXMB:OE-400 (1:1 ratio) and a blend of benzyl alcohol:OE-400 (1:1). Results are shown in FIG. 12(b).

### Example 8—Antimicrobial Effects

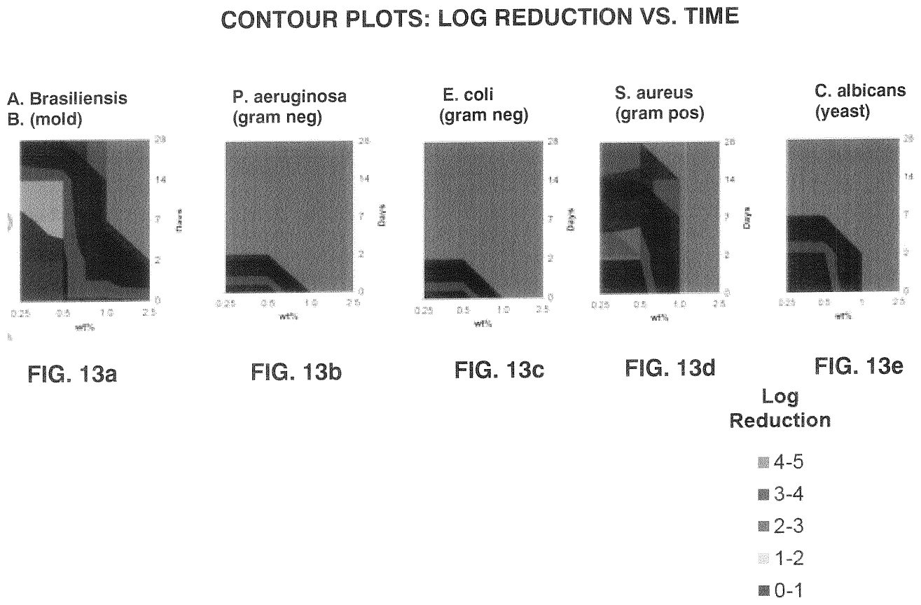

The antimicrobial effects of the higher volatility component, 3-phenyl propanol in low concentrations was evaluated using the USP 51 (United States Pharmacopeia) test methodology. Soy broth, at pH 8.0, was inoculated with strains of A. brasiliensis (mold), P. aeruginosa (gram negative), E. coli (gram negative), S. aureus (gram positive), and C. albicans (yeast). FIGS. 13 (a), 13 (b), 13 (c), 13 (d) and 13 (e) are contour plots showing log reduction over time for concentrations of 3-phenyl propanol ranging from 0.25 wt. % to 2.5 wt. %. Particularly good efficacy was shown against gram negative bacteria and yeast, although at higher concentrations over time log reductions were achieved for all organisms tested.

The ASTM D2574 Test Method was used to determine antimicrobial performance of the inventive multifunctional additive blends against P. aeruginosa and K. aerogenes. Coatings were inoculated to an in-can concentration of 10⁷ cfu/g for each organism. Inoculations were continued every 7 days until the coating failed to achieve a complete kill on day 7. Each 7-day period is referred to as a “round.” As seen from the results below, the benzyl alcohol/dibenzoate (K-FLEX® 850S) multifunctional additive blend (X-3411) greatly exceeded the antimicrobial efficacy achieved for the negative control, which failed after three rounds to K. aerogenes.

COALESCENT ADDITIVE (OPTION A = benzyl alcohol)
45% Pigment Volume Concentration Paint (PVC) (Basic Flat)
RayCryl 1207 (Binder prior to biocide addition)
Point of Failure in ASTM D2574

| | Organism | Day 1 | Day 2 | Day 3 | Day 5 | Day 7 |
|---|---|---|---|---|---|---|
| Round 6 | | | | | | |
| Option A1 | P. aeruginosa | 1 | 0 | 0 | 0 | 0 |
| X-3411 | KE. aerogenes | 4 | 4 | 4 | 3 | 3 |
| 0.34% loading | | | | | | |
| Round 7 | | | | | | |
| Option A2 | P. aeruginosa | 0 | 0 | 0 | 0 | 0 |
| X-3411 | K. aerogenes | 4 | 4 | 4 | 4 | 3 |
| 0.68% loading | | | | | | |
| Round 8 | | | | | | |
| Option A3 | P. aeruginosa | 4 | 4 | 3 | 0 | 0 |
| X-3411 | K. aerogenes | 4 | 4 | 3 | 1 | 1 |
| 1% loading | | | | | | |

CONTROLS:
Negative control failed rd. 3 to K. aerogenes.
TXMB control failed rd. 4 to K. aerogenes.
300 ppm BIT (benzisothiazolinone) control passed all 8 rounds.
% loading set forth above is based on overall weight of the formula.

COALESCENT ADDITIVE
45% Pigment Volume Concentration Paint (PVC) (Basic Flat)
RayCryl 1247 (Binder prior to biocide addition)
ASTM D2574

| | Organism | Day 1 | Day 2 | Day 3 | Day 5 | Day 7 |
|---|---|---|---|---|---|---|
| Round 8 | | | | | | |
| X-3411 | P. aeruginosa | 4 | 4 | 2 | 0 | 0 |
| 1% loading | KE. aerogenes | 4 | 4 | 3 | 2 | 0 |
| with 45 ppm BIT | | | | | | |

CONTROLS:
Negative control with 45 ppm of BIT (benzisothiazolinone) failed rd. 3 to K. aerogenes.
TXMB control with 45 ppm of BIT failed rd. 5 to K. aerogenes.
% loading set forth above is based on overall weight of the formula.

Coalescent loading of 1 wt. % in the overall formula successfully passed eight inoculations of challenge testing resulting in no bacterial recovery at each of the day 7 time points

The antimicrobial effects of the inventive multifunctional additive blends provide a potential advantage to a formulator in applications that require a coating to be resistant to microbes and may reduce the concentration needed for a traditional antimicrobial addition to a formulation.

The results above show that the inventive multifunctional additive blends are truly multi-functional in the sense that they provide not only improved film formation (coalescence) at lower or comparable loading levels when compared to traditional high VOC and low VOC coalescents alone, lower VOC content when compared to traditional high VOC coalescents used alone, improved hardness and scrub resistance when compared to traditional high and low VOC coalescents alone, and comparable or better block resistance and flow and leveling when compared to traditional coalescents, but also have potential for antimicrobial efficacy when tested according to standard protocols.

### Example 9—Viscosity

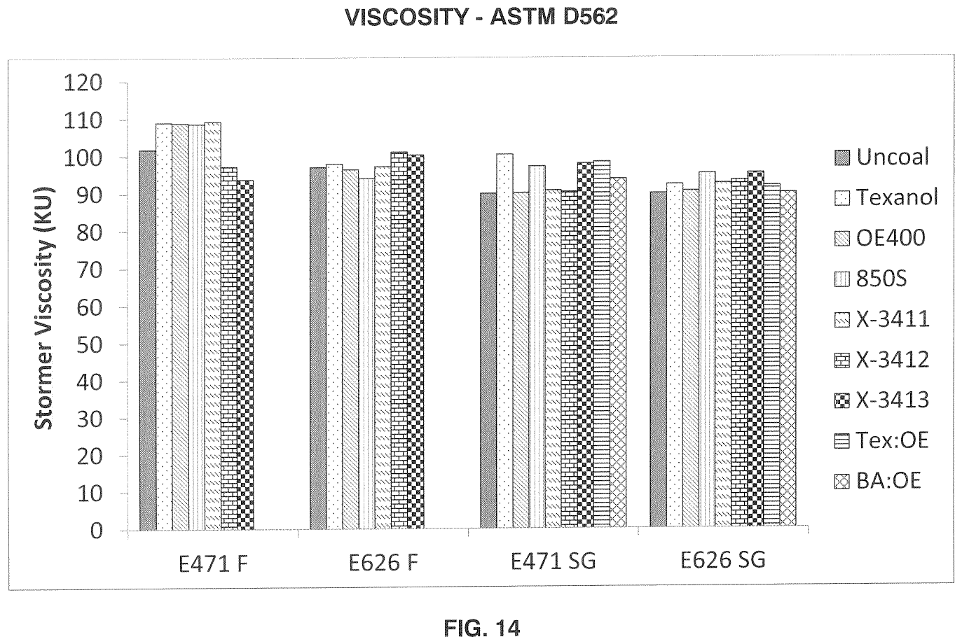

Viscosity (Stormer) was determined for Encor 471 and Encor 626 flat and semigloss samples using ASTM D562 and comparing an uncoalesced sample, TXMB, OE-400, K-FLEX® 850S, X-3411, X-3412, X-3413, TXMB:OE-400 (1:1 ratio) blend and benzyl alcohol:OE-400 (1:1 ratio) blend. Results are shown in FIG. 14 and are comparable for all coalescents and blends tested.

### Example 10—Contrast Ratio

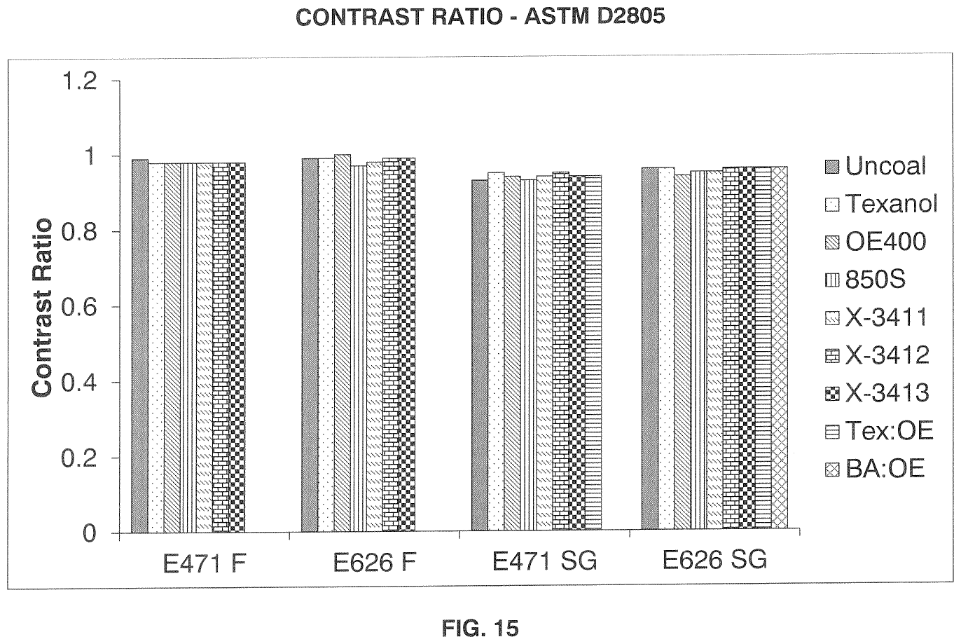

Contrast Ratio was determined for Encor 471 and Encor 626 flat and semigloss samples using ASTM D2805 and comparing an uncoalesced sample, TXMB, OE-400, K-FLEX® 850S, X-3411, X-3412, X-3413, TXMB:OE-400 (1:1 ratio) blend and benzyl alcohol:OE-400 (1:1 ratio) blend. Results are shown in FIG. 15 and are comparable for all coalescents and blends tested.

### Example 11—Gloss

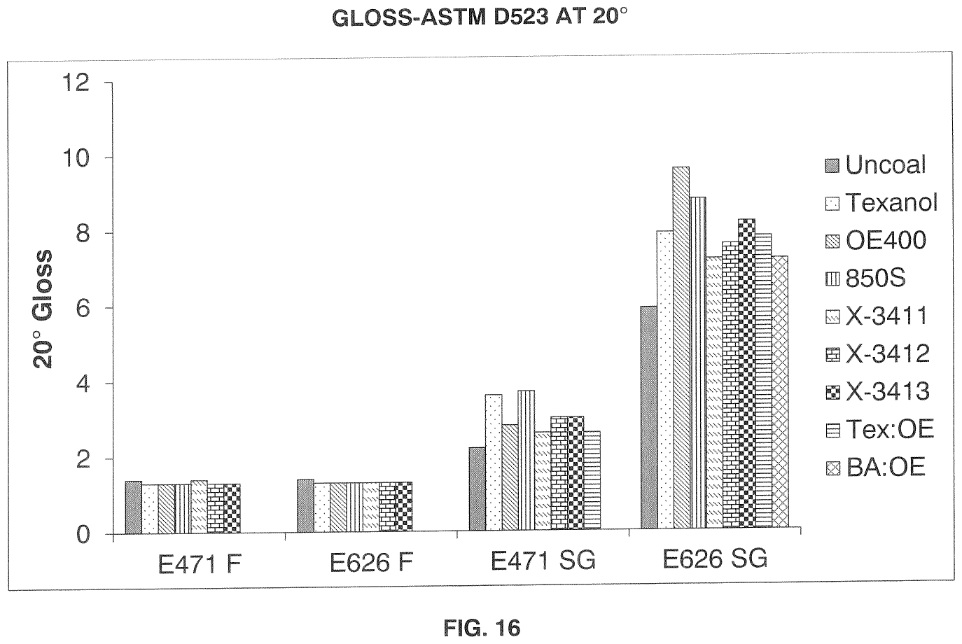

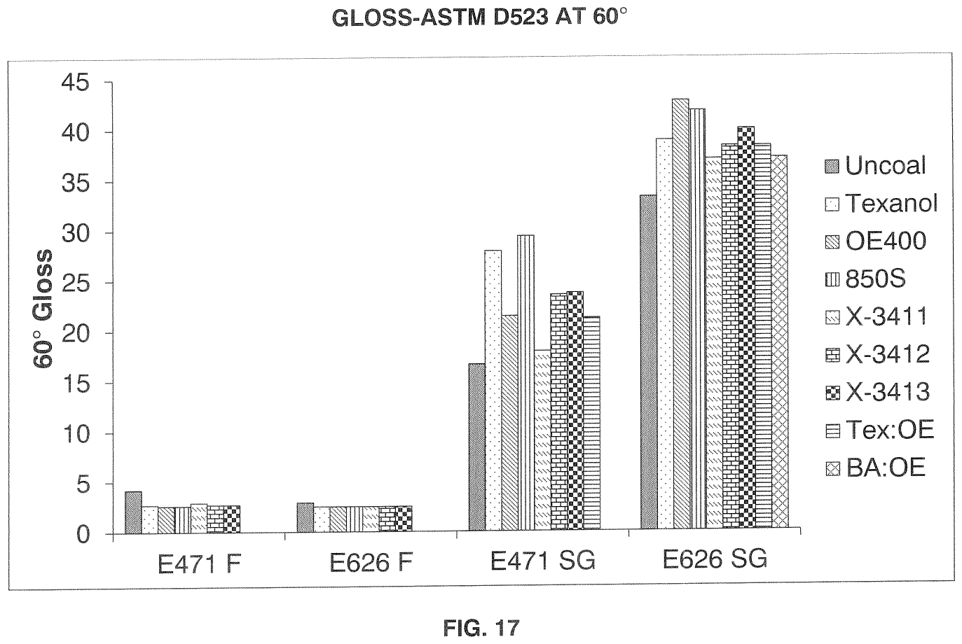

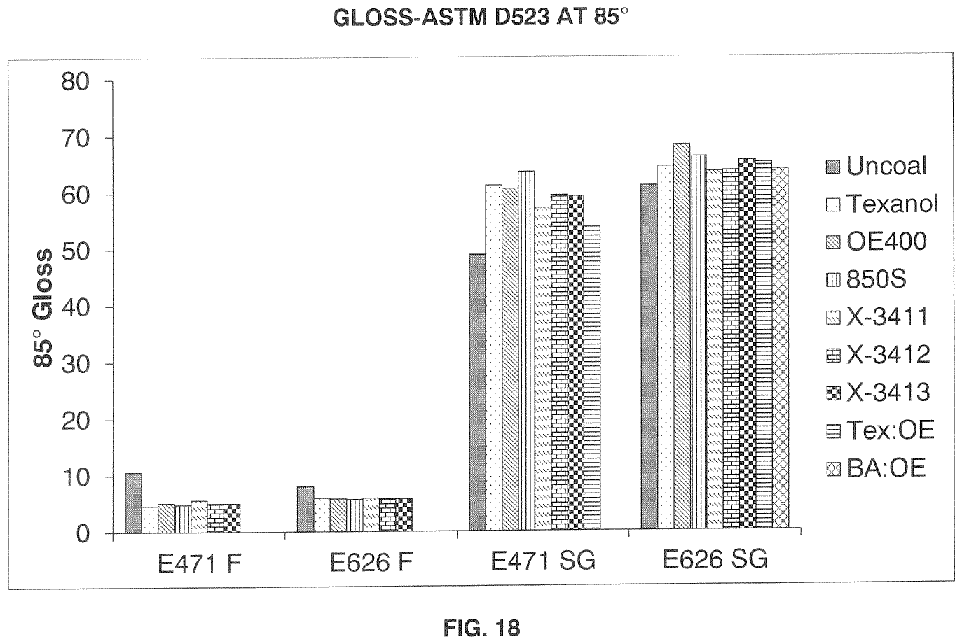

Gloss was determined for Encor 471 and Encor 626 flat and semigloss samples using ASTM D523 at 20°, 60° and 85° angles and comparing an uncoalesced sample, TXMB, OE-400, K-FLEX® 850S, X-3411, X-3412, X-3413, TXMB:OE-400 (1:1 ratio) blend and benzyl alcohol:OE-400 (1:1 ratio) blend. Results are shown in FIGS. 16, 17 and 18. The inventive multifunctional additive blends demonstrated comparable performance to the high VOC TXMB in each of the coatings except the Encor 471 semigloss formulation.

### Example 12—Dirt Pickup Resistance

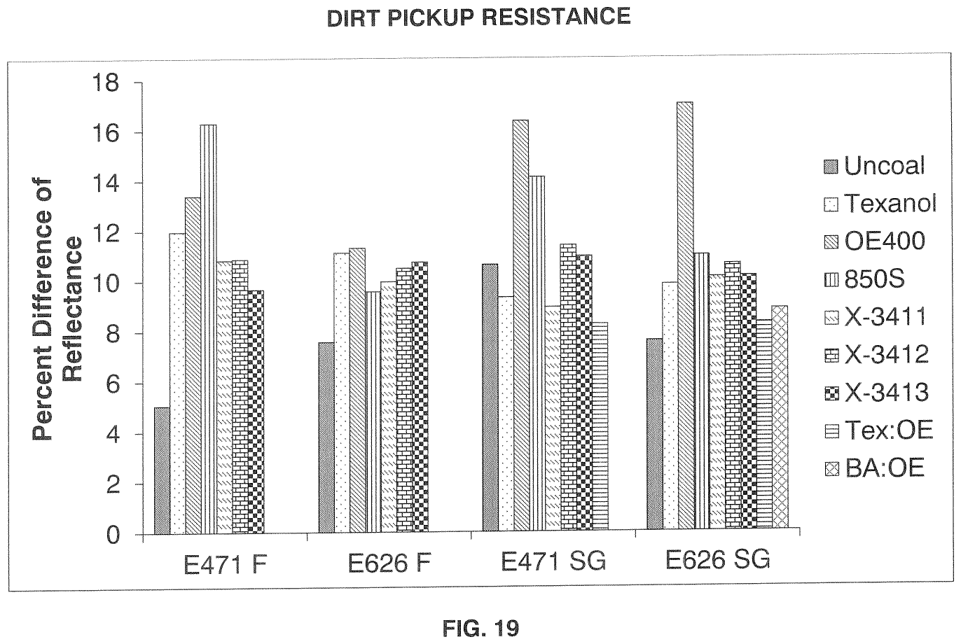

Dirt pickup resistance was determined for Encor 471 and Encor 626 flat and semigloss samples using the above-described methodology and comparing an uncoalesced sample, TXMB, OE-400, K-FLEX® 850S, X-3411, X-3412, X-3413, TXMB:OE-400 blend and benzyl alcohol:OE-400 (1:1 ratio) blend. Results are shown in FIG. 19. The inventive multifunctional additive blends demonstrated a significant performance improvement over the traditional low VOC coalescent, OE-400, in the semigloss formulations.

### Example 13—Print Resistance

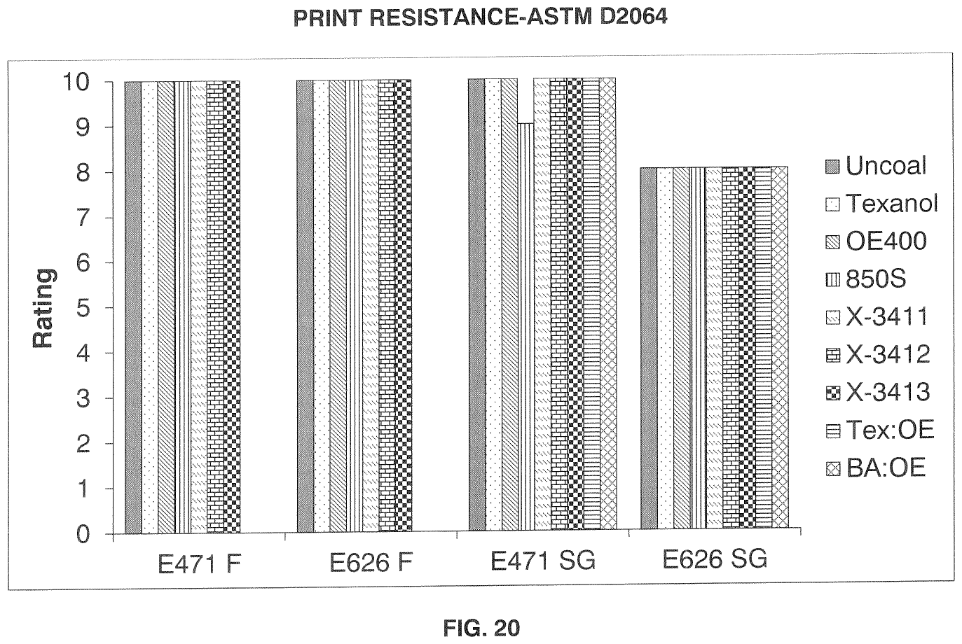

Print Resistance was determined for Encor 471 and Encor 626 flat and semigloss samples using ASTM D2064 and comparing an uncoalesced sample, TXMB, OE-400, K-FLEX® 850S, X-3411, X-3412, X-3413, TXMB:OE-400 (1:1 ratio) blend and benzyl alcohol:OE-400 (1:1 ratio) blend. Results are shown in FIG. 20 and are comparable for all coalescents and blends tested.

### Example 14—Dry Adhesion

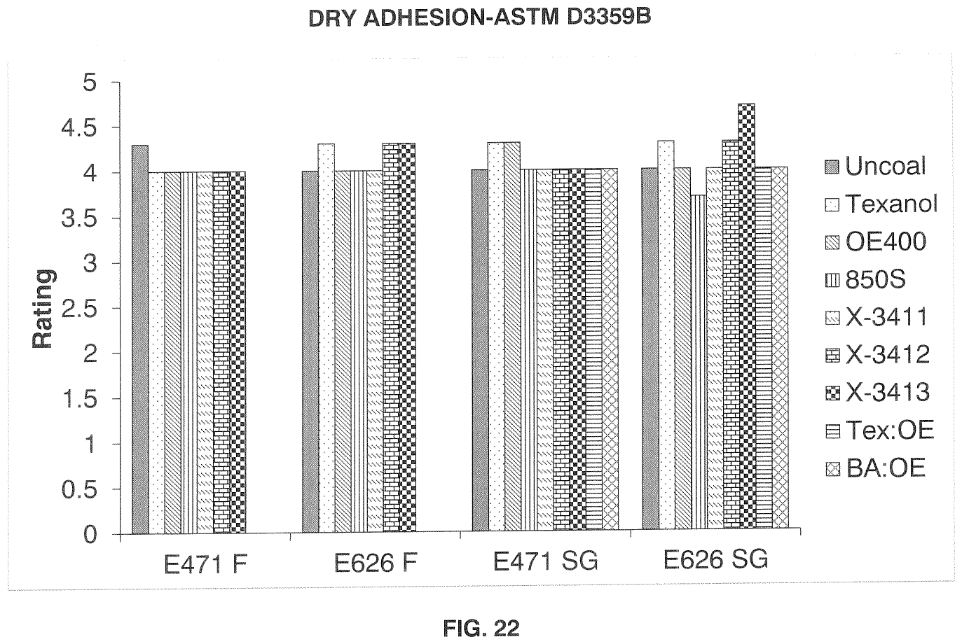

Dry adhesion was determined for Encor 471 and Encor 626 flat and semigloss samples using ASTM D3359B and comparing an uncoalesced sample, TXMB, OE-400, K-FLEX® 850S, X-3411, X-3412, X-3413, TXMB:OE-400 blend and benzyl alcohol:OE-400 (1:1 ratio) blend. Results are shown in FIG. 22 and are comparable for all coalescents and blends tested.

### Example 15—Drying Time

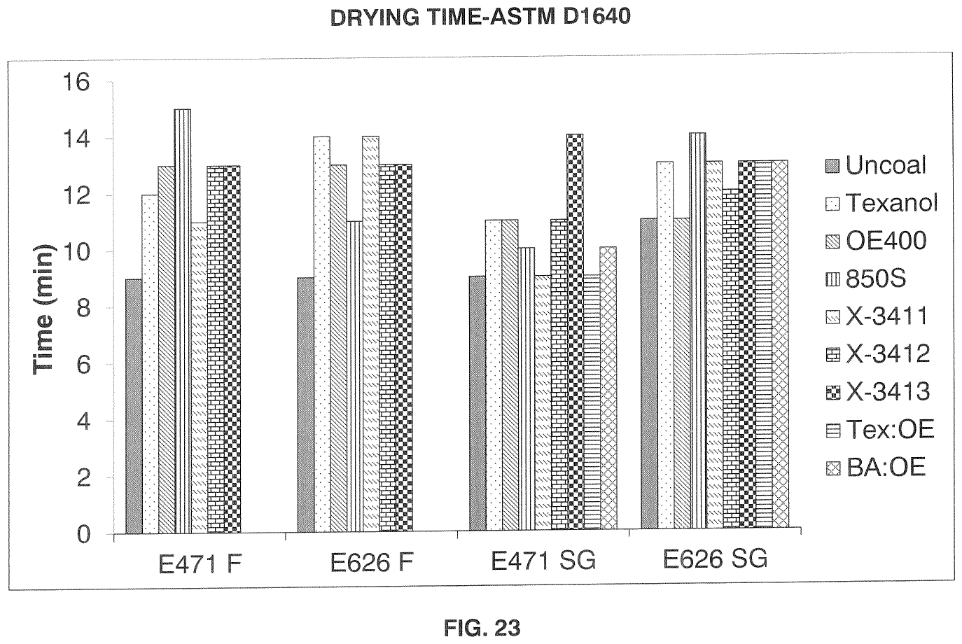

Drying time was determined for Encor 471 and Encor 626 flat and semigloss samples using ASTM D1640 and comparing an uncoalesced sample, TXMB, OE-400, K-FLEX® 850S, X-3411, X-3412, X-3413, TXMB:OE-400 (1:1 ratio) blend and benzyl alcohol:OE-400 (1:1 ratio) blend. Results are shown in FIG. 23 and are comparable for all coalescents and blends tested.

### Example 16—Mudcracking

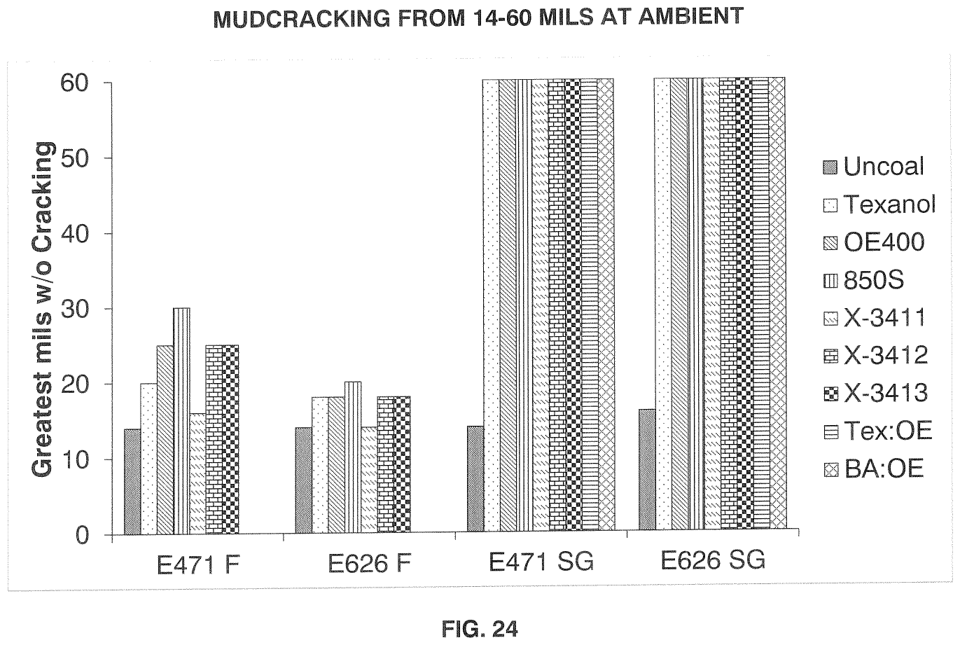

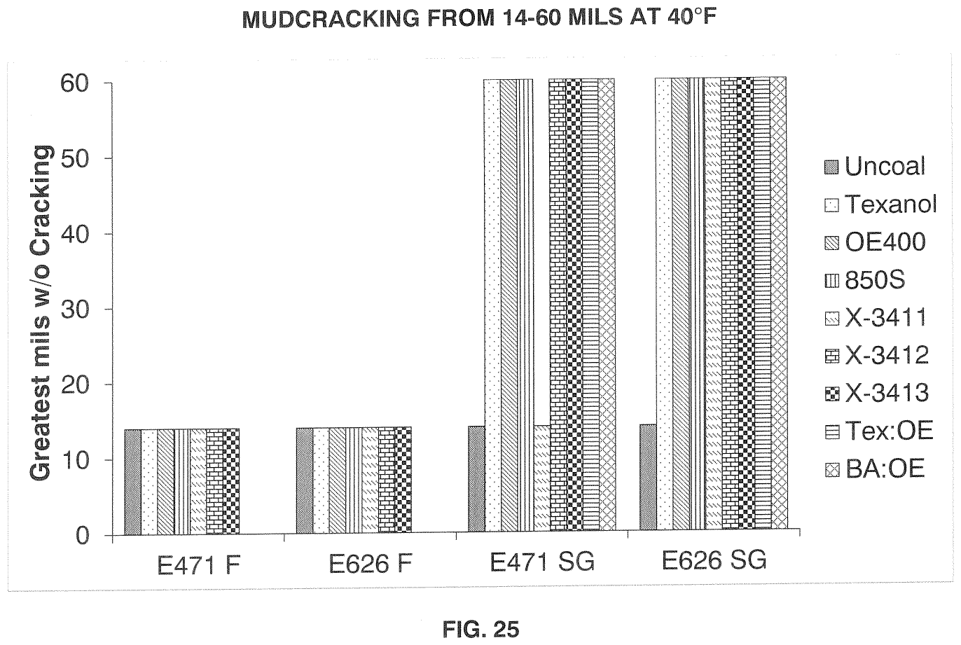

Mudcracking from 14-60 mils at ambient and at 40° F. was determined for Encor 471 and Encor 626 flat and semigloss samples and comparing an uncoalesced sample, TXMB, OE-400, K-FLEX® 850S, X-3411, X-3412, X-3413, TXMB:OE-400 (1:1 ratio) blend and benzyl alcohol:OE-400 (1:1 ratio) blend. Results are shown in FIGS. 24 and 25 and are comparable for all coalescents and blends tested.

### Example 17—Open Time

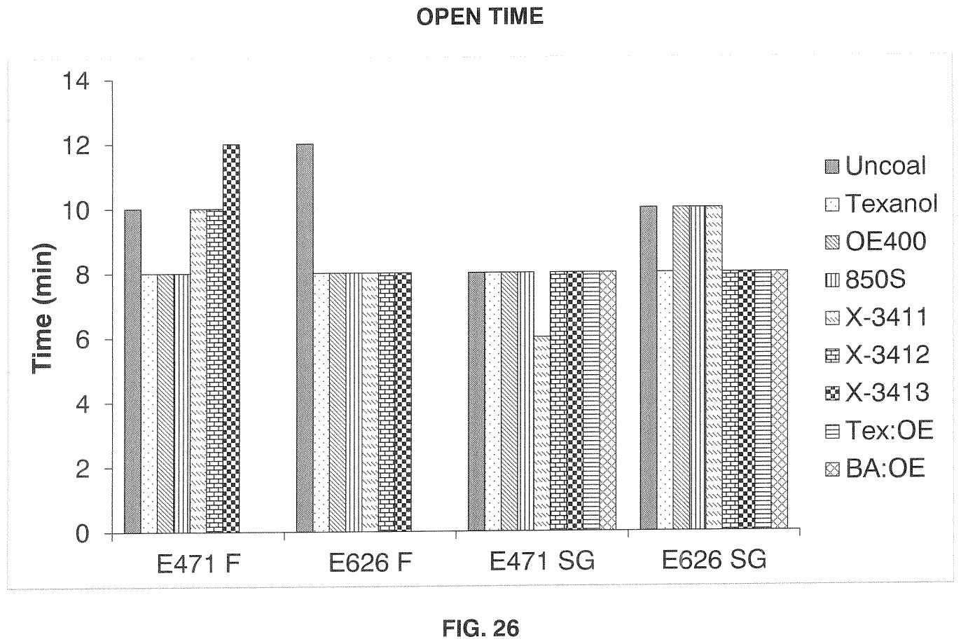

Open time was determined for Encor 471 and Encor 626 flat and semigloss samples and comparing an uncoalesced sample, TXMB, OE-400, K-FLEX® 850S, X3411, X-3412, X-3413, TXMB:OE-400 (1:1 ratio) blend and benzyl alcohol:OE-400 (1:1 ratio) blend. Results are shown in FIG. 26 and are comparable for all coalescents and blends tested.

### Example 18—Wet Edge

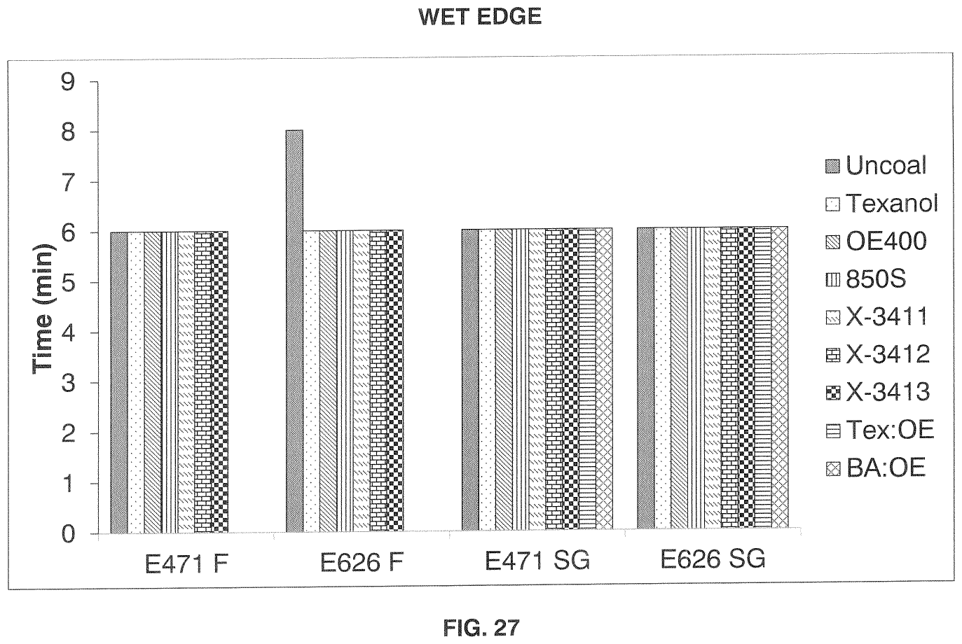

Wet edge was determined for Encor 471 and Encor 626 flat and semigloss samples and comparing an uncoalesced sample, TXMB, OE-400, K-FLEX® 850S, X3411, X-3412, X-3413, TXMB:OE-400 (1:1 ratio) blend and benzyl alcohol:OE-400 (1:1 ratio) blend. Results are shown in FIG. 27 and are comparable for all coalescents and blends tested.

### Example 19—Sag Resistance

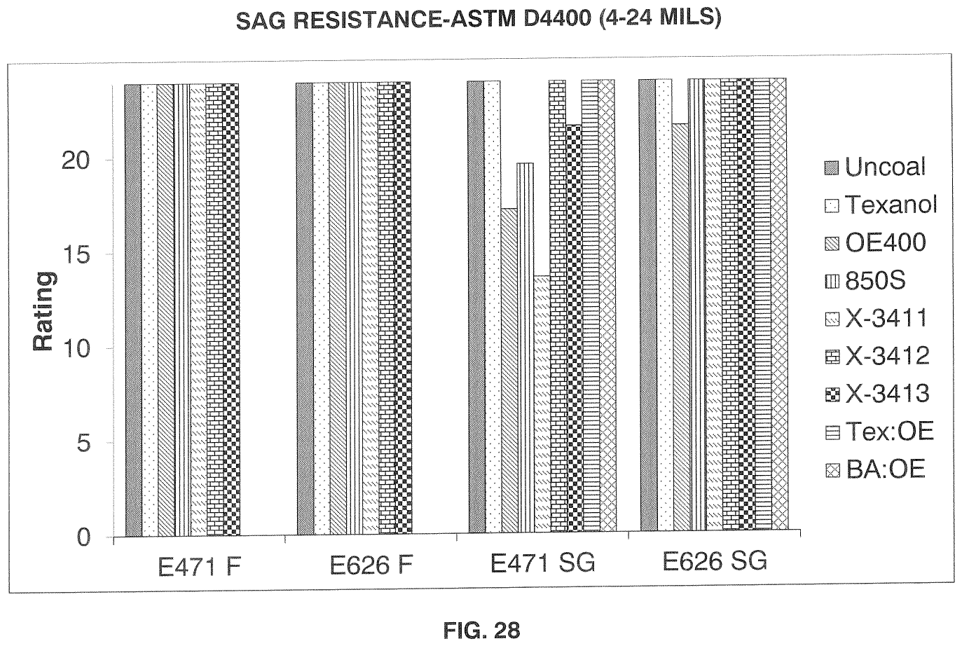

Sag resistance was determined using ASTM D4400 (4-24 mils) for Encor 471 and Encor 626 flat and semigloss samples and comparing an uncoalesced sample, TXMB, OE-400, K-FLEX® 850S, X-3411, X-3412, X-3413, TXMB:OE-400 (1:1 ratio) blend and benzyl alcohol:OE-400 (1:1 ratio) blend. Results are shown in FIG. 28 and are comparable for all coalescents and blends tested.

### Example 20—Washability

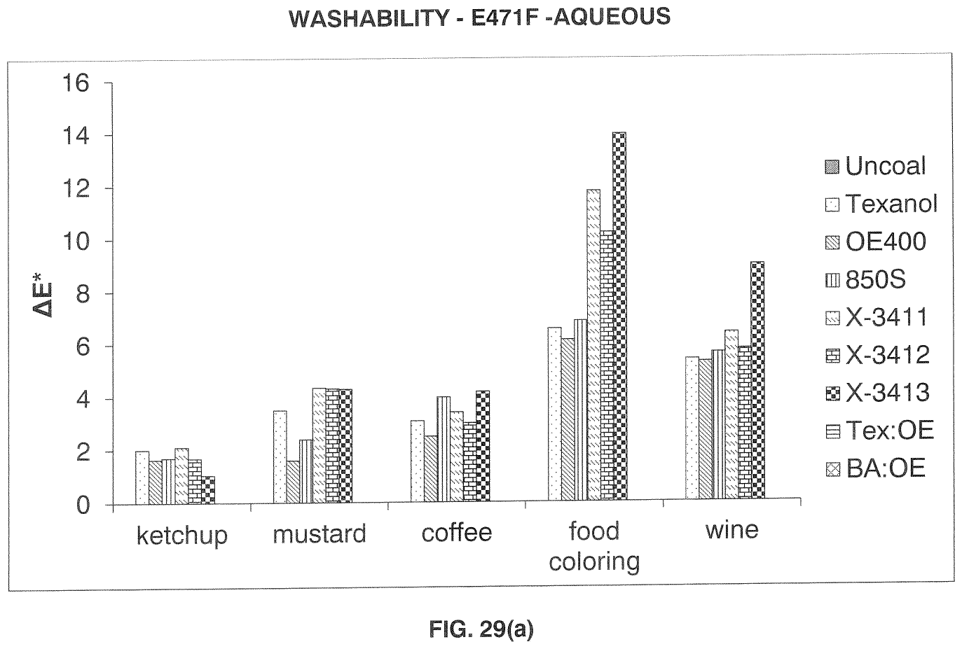

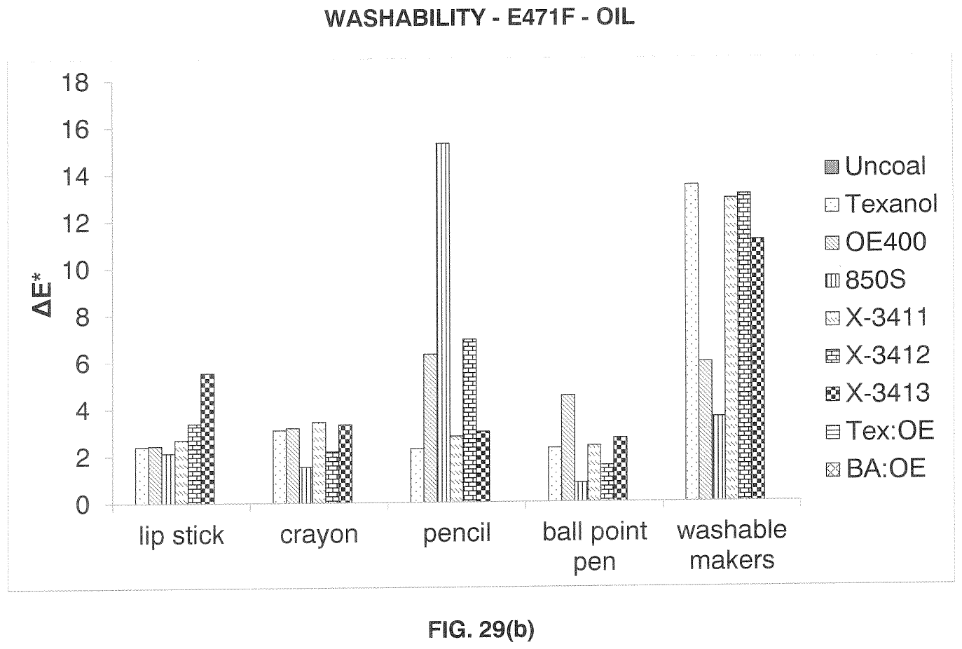

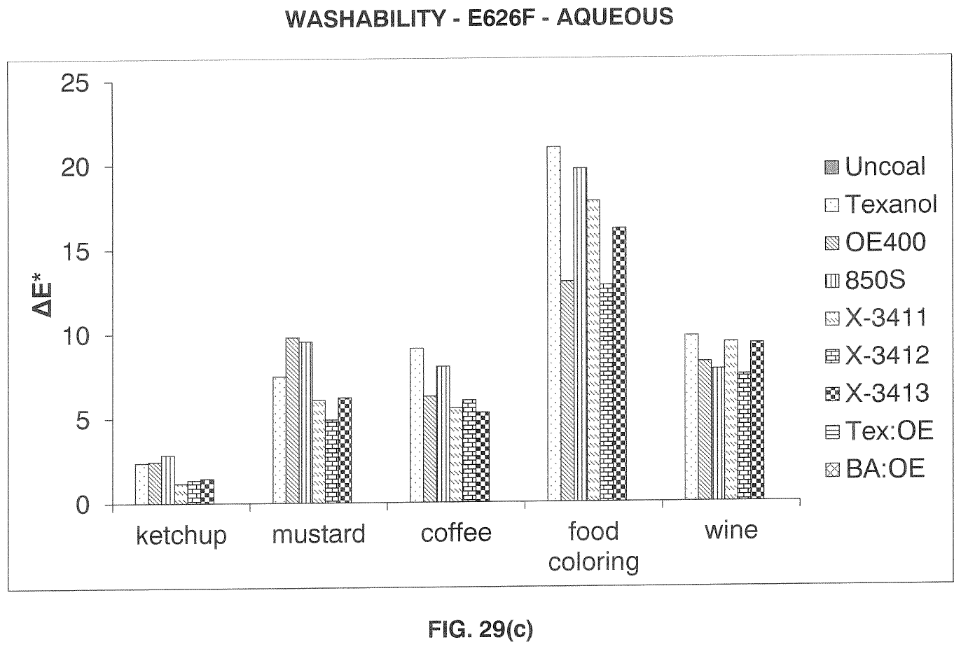

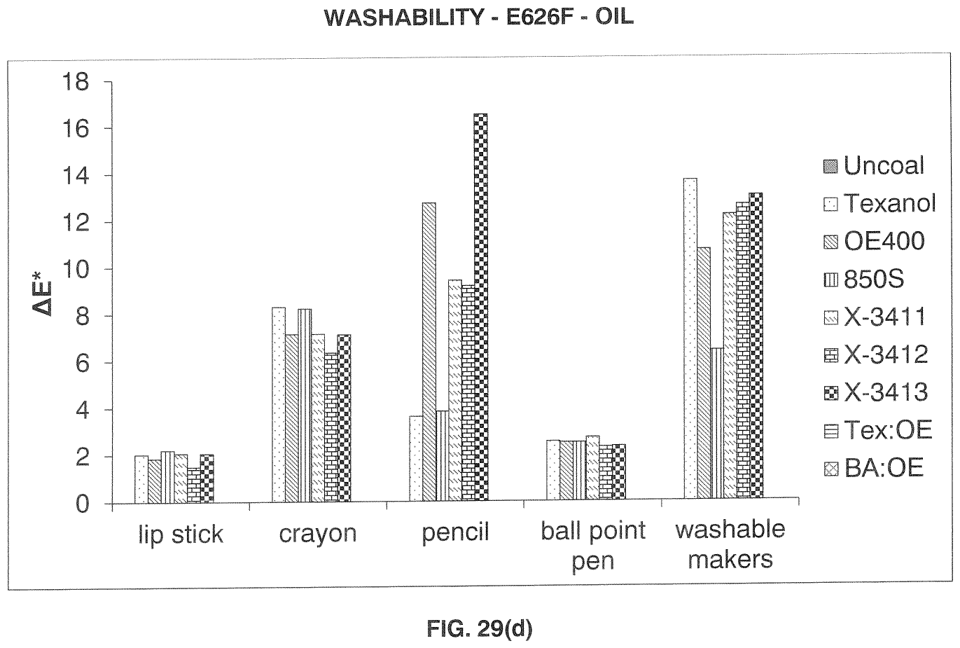

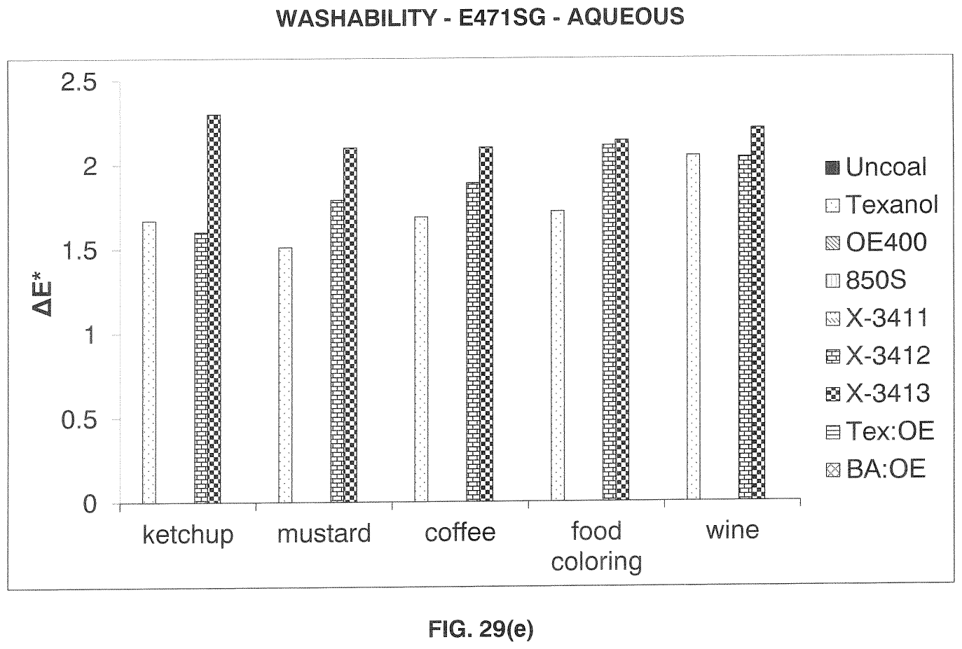

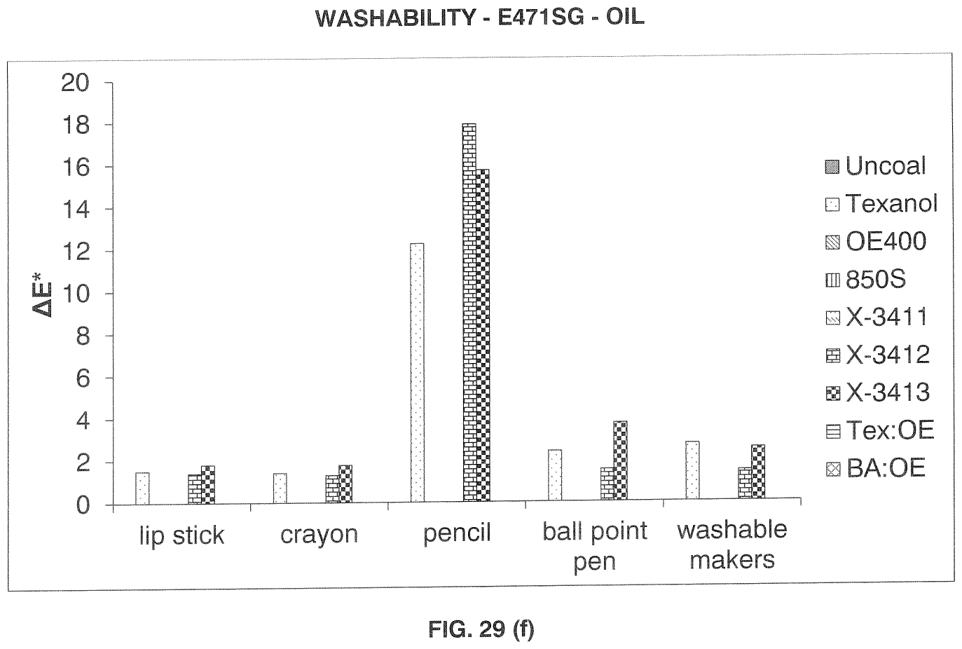

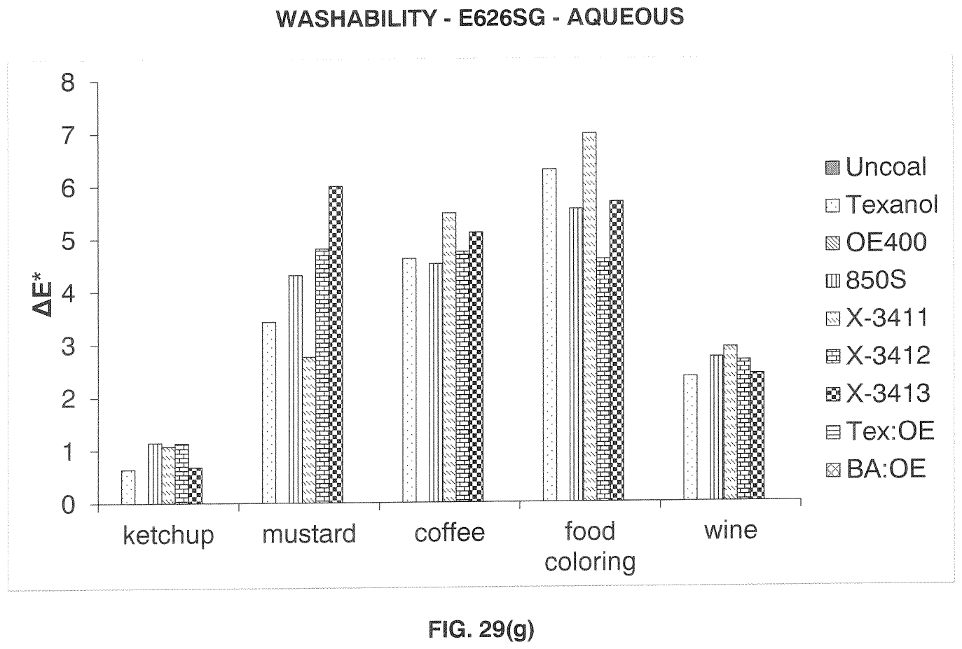

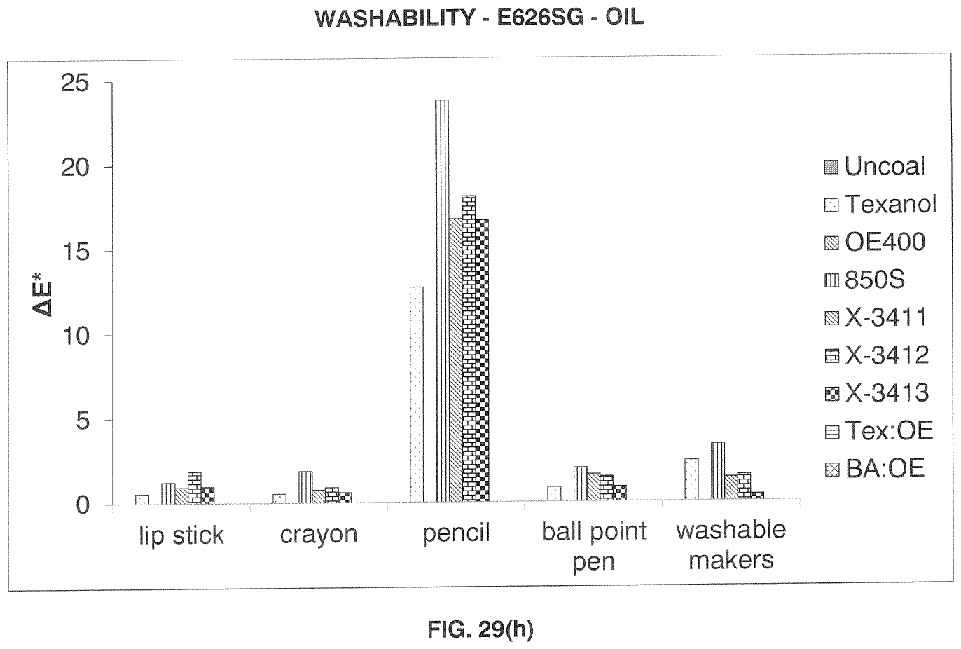

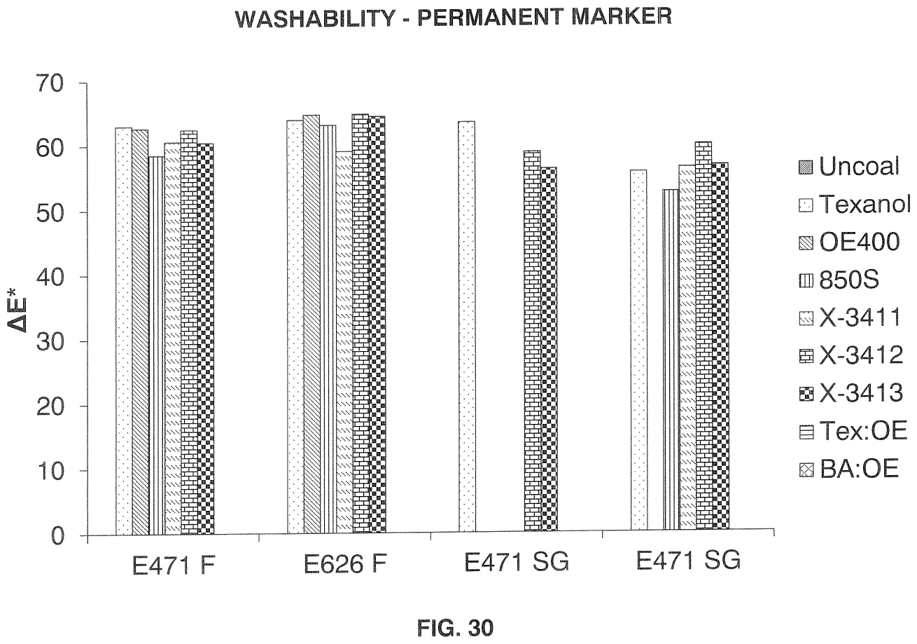

Washability was determined using the above-discussed methodology for Encor 471 and Encor 626 flat and semigloss samples and comparing an uncoalesced sample, TXMB, OE-400, K-FLEX 850S, X-3411, X-3412, X-3413, TXMB:OE-400 (1:1 ratio) blend, and benzyl alcohol:OE-400 (1:1 ratio) blend. Various stains, both aqueous and oil based, were evaluated. Results are shown in FIGS. 29 (a)-(h). Results for washability of a permanent marker are shown in FIG. 30. Results are comparable for all coalescents and blends tested.

### Example 21—TXMB:Dibenzoate Paint Evaluation/Testing

Additional testing using various ratios of TXMB:K-FLEX® 850S and TXMB:K-FLEX® 975P in various binders, i.e., Encor 471, EPS 2533, Acronal 296D (all styrene acrylics), VSR 1050 and Encor 626 (both 100% acrylics) and Encor 379G (a vinyl acrylic), was conducted in the paint formulation set forth below. The K-FLEX® coalescent selected for each paint sample was chosen based on binder type (850S for 100% acrylic and vinyl acrylic and 975 P for styrene-acrylic binders).

PAINT FORMULATION

| Grind | Weight (g) |
|---|---|
| Water | 28 |
| Ti-Pure R-746 (76.5%) | 244 |
| Let Down | |
| Binder | QS to 25% PVC |
| Biosoft N1-3 | 0.69-3.15 |
| Coalescent/ | 3.03-25.02 |
| Multifunctional | |
| Additive | |
| Water | 50 |
| Byk 28 | 1.97 |
| Ammonia (28%) | Titrate to pH 8.5 |
| Acrysol RM-8W | Titrate to 95-105 KU |
| Kathon LX | 1 |

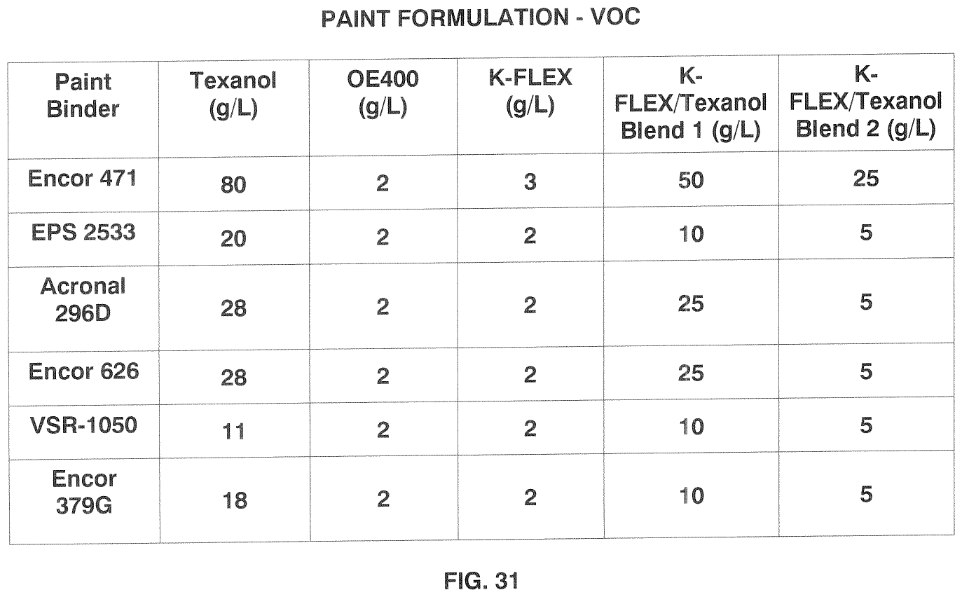

VOC Contribution. VOC calculations were performed showing the VOC contribution to the various paint formulations for TXMB, OE-400, K-FLEX® 850S or 975P (alone), depending on binder as discussed above, a K-FLEX:TXMB blend 1, and a K-FLEX:TXMB blend 2 are shown in FIG. 31. The particular K-FLEX® coalescent selected for each paint sample, whether used alone or in a blend, was chosen based on binder type (850S for 100% acrylic and vinyl acrylic binders and 975 P for styrene-acrylic binders).

The results demonstrate that formulations can be formulated down to 5 g/L VOC and still achieve good performance with the inventive multifunctional additive blends. This is surprising and contrary to the traditional view that a coalescent must have high VOC's to maintain performance properties.

Scrub Resistance. Scrub resistance was evaluated for three styrene-acrylic binders (Encor 471, EPS 2533, and Acronal 296D), two 100% acrylic binders (Encor 626 and VSR 1050) and one vinyl acrylic binder (Encor 379G) comprising TXMB, OE-400, K-FLEX® 850S or 975P alone, and inventive low VOC multifunctional additive blends of TXMB and 975P or 850S as shown below.

Encor 471: 30:70 TXMB:975P, 70:30 TXMB:975P

EPS 2533: 30:70 TXMB:975P, 55:45 TXMB:975P

Acronal 296D: 10:90 TXMB:975P, 90:10 TXMB:975P

Encor 626:10:90 TXMB:850S, 90:10 TXMB:850S

VSR 1050: 40:60 TXMB:850S, 90:10 TXMB:850S

Encor 379G: 50:50 TXMB:850S, 80:20 TXMB:850S

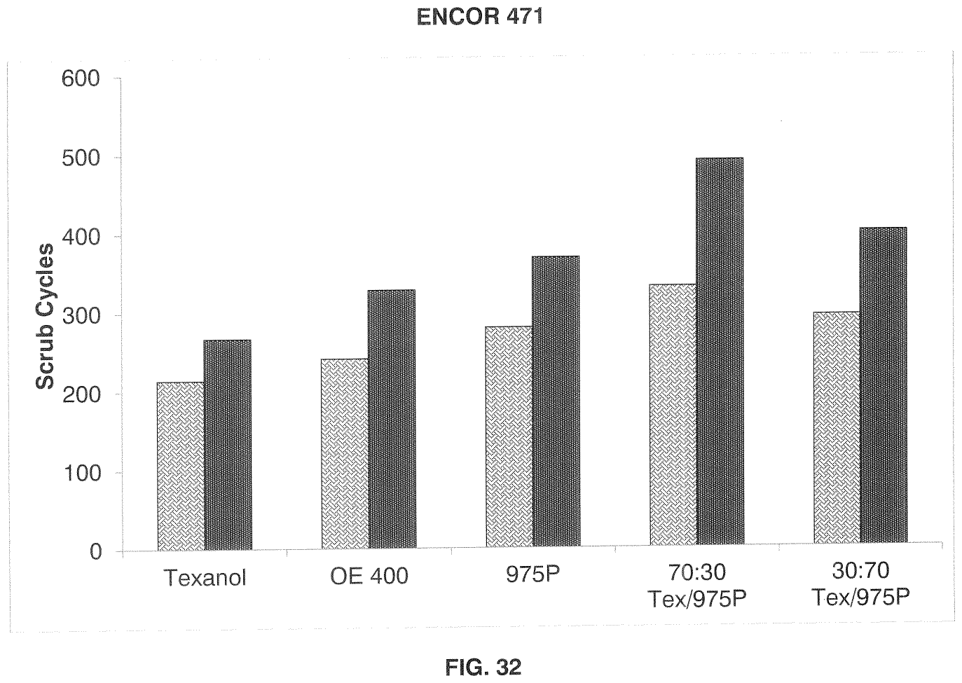

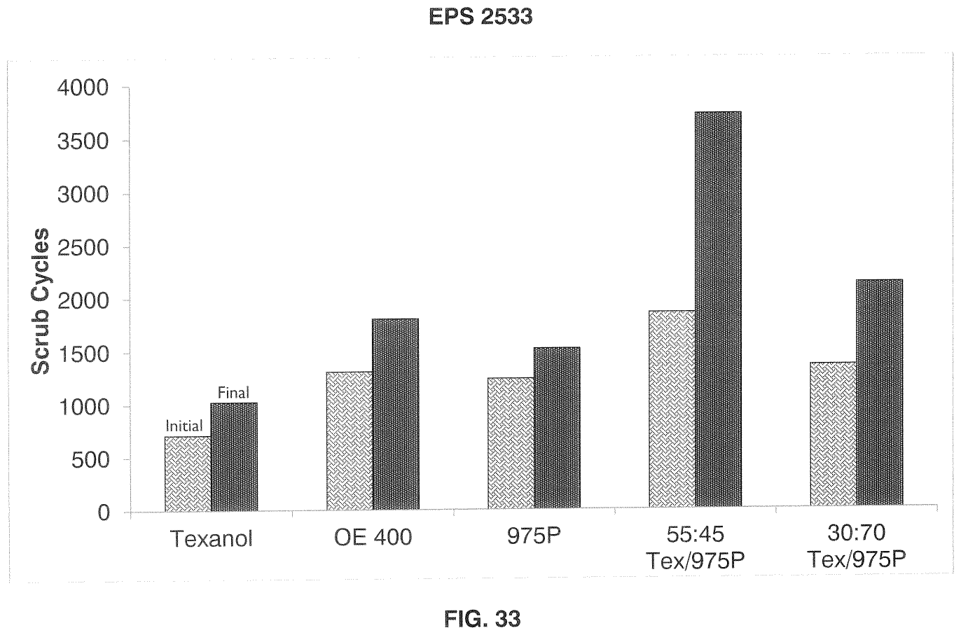

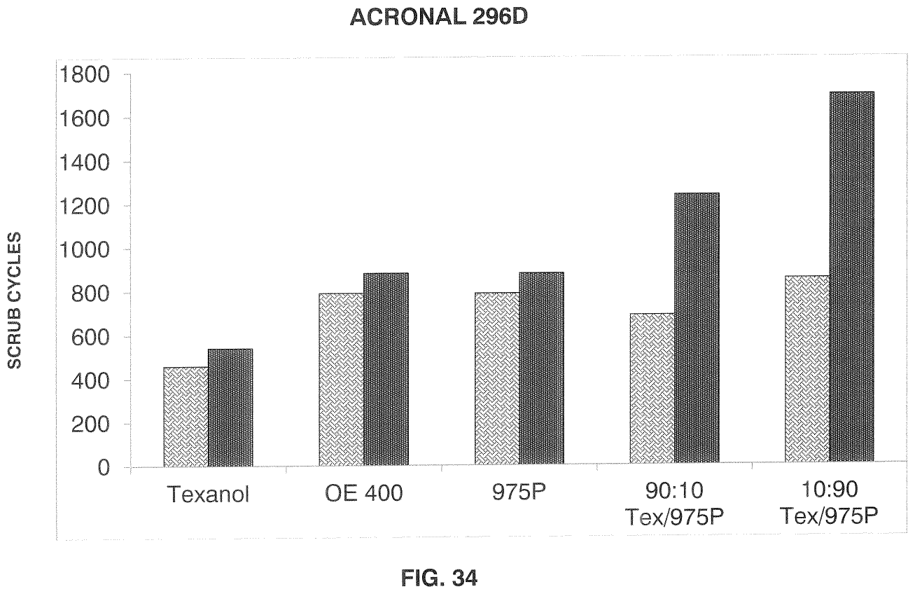

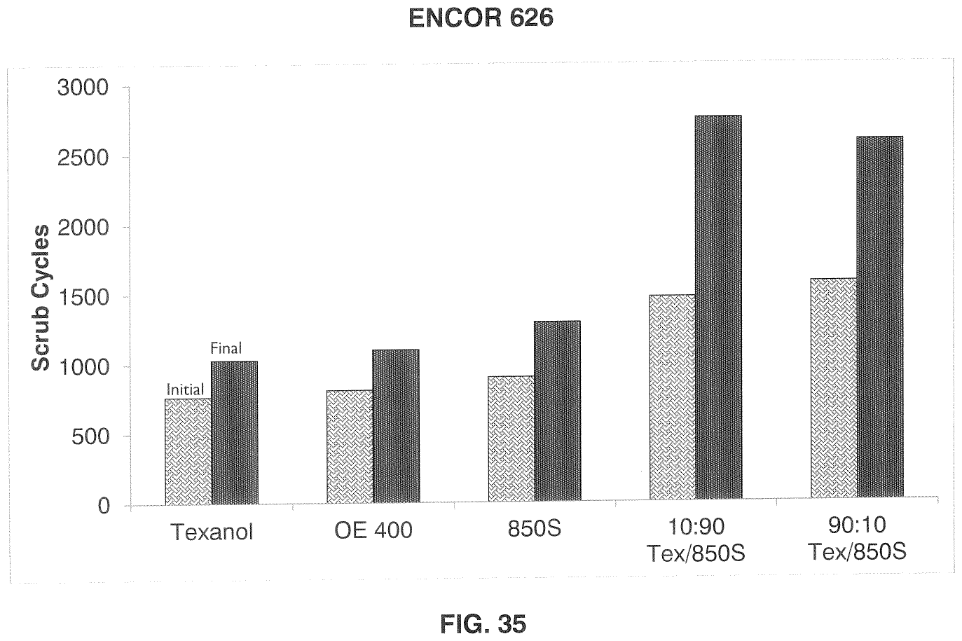

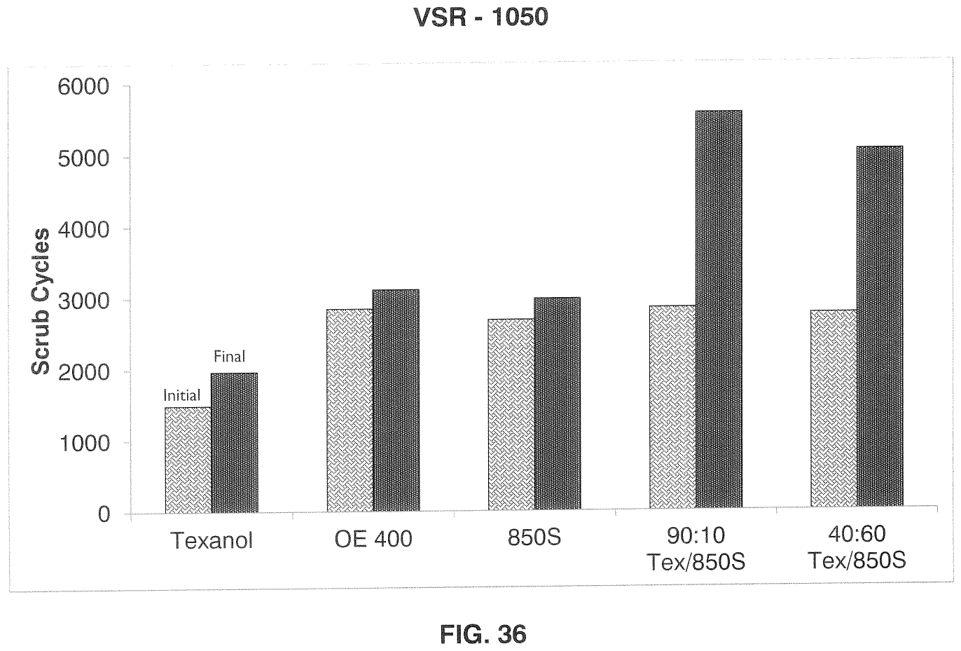

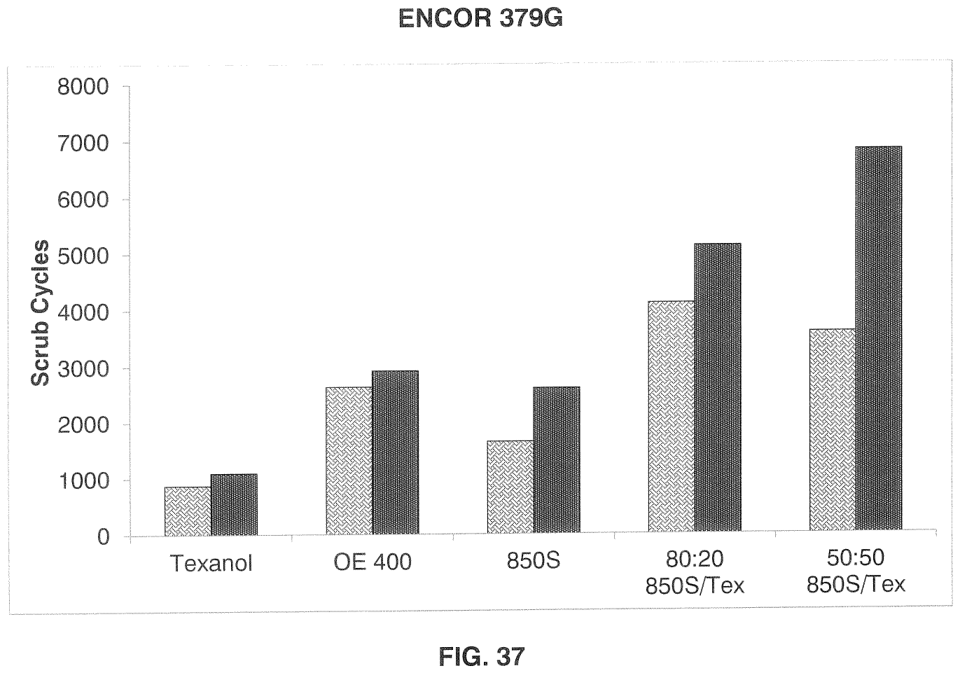

Scrub resistance results are shown in FIGS. 32-37. Incorporating the higher VOC component with the lower VOC dibenzoate (TXMB and dibenzoates, respectively, as listed above) resulted in increased scrub resistance of the coatings than use of TXMB or the dibenzoate alone.

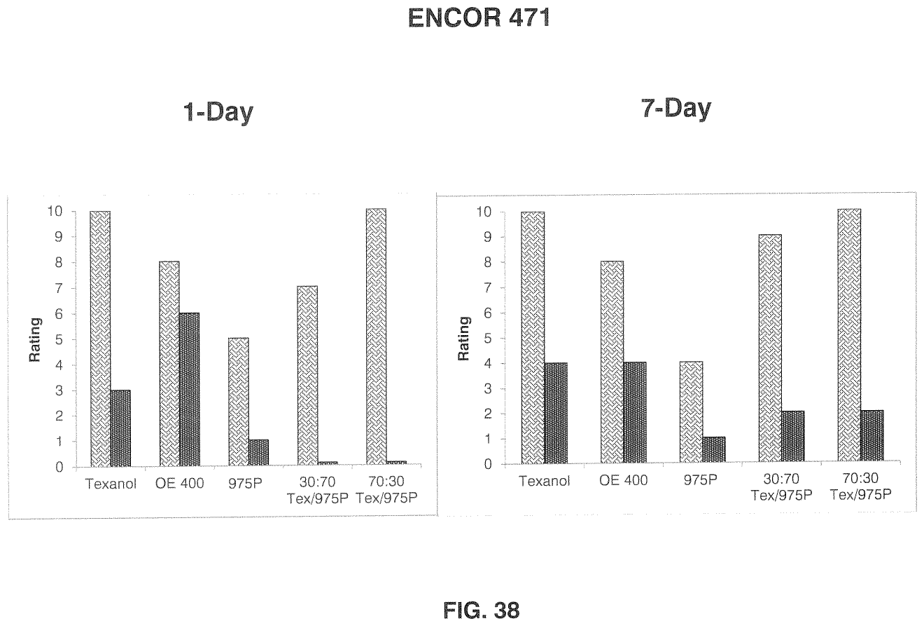

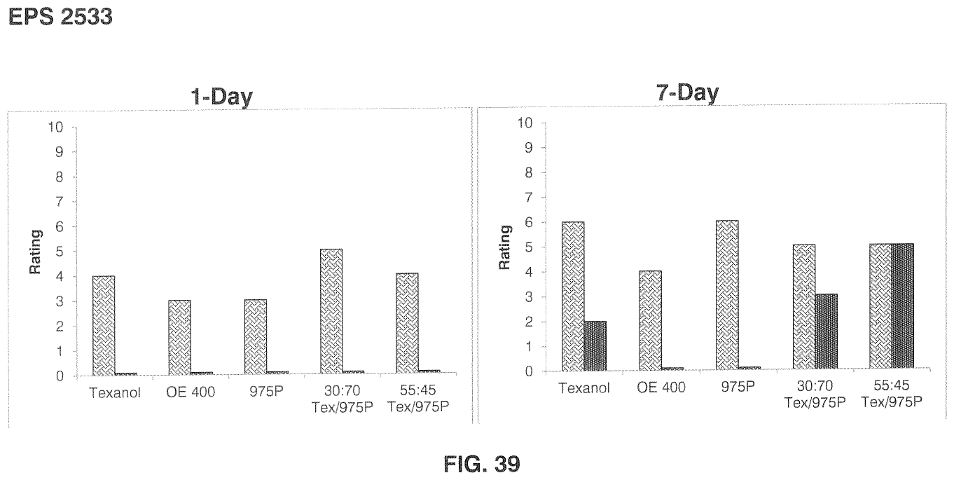

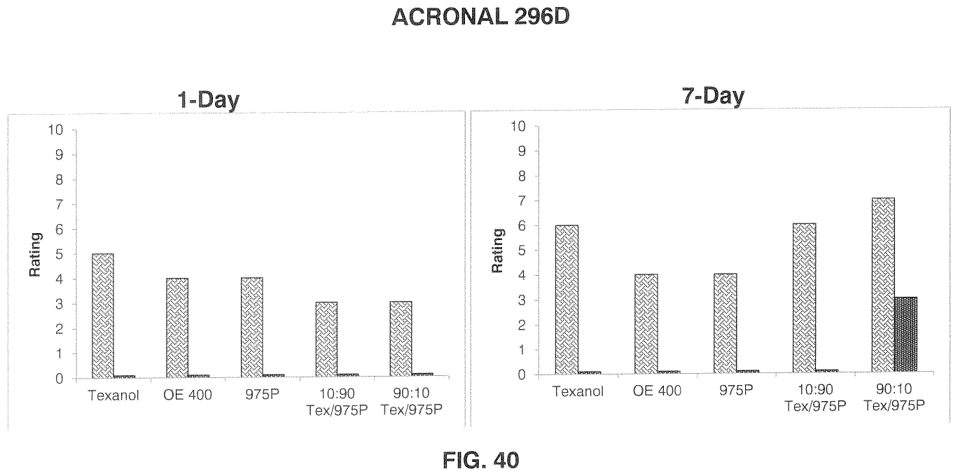

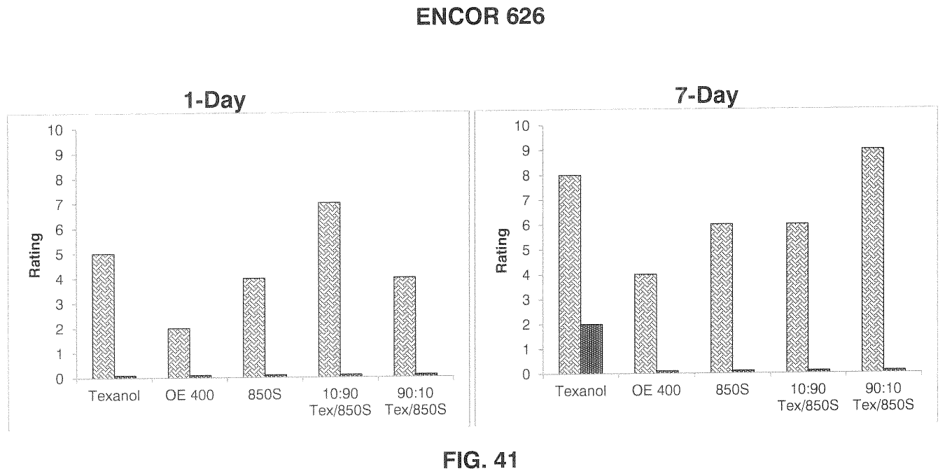

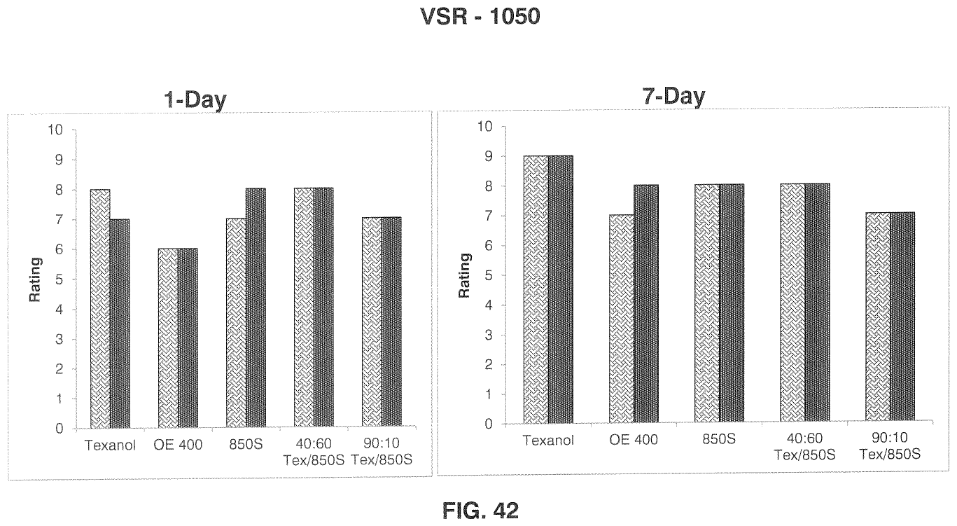

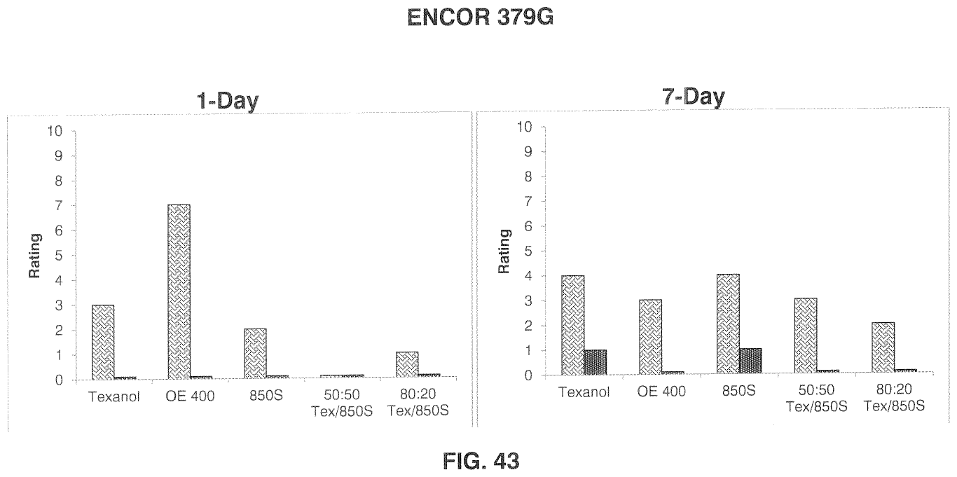

Block Resistance. Block resistance was measured at 1-day and 7-day for the same binders and coalescents and inventive low VOC multifunctional additive blends as used in the scrub resistance evaluation above. Results are shown in FIGS. 38-43. In most of the coatings tested, the blends of high VOC and low VOC (TXMB and Dibenzoates, respectively, as listed above) were able to equal the block resistance of the high VOC control and exceed block performance of just Dibenzoate alone.

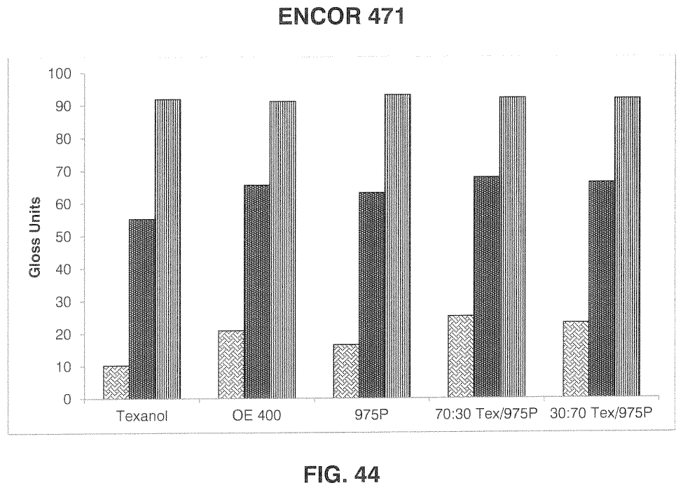

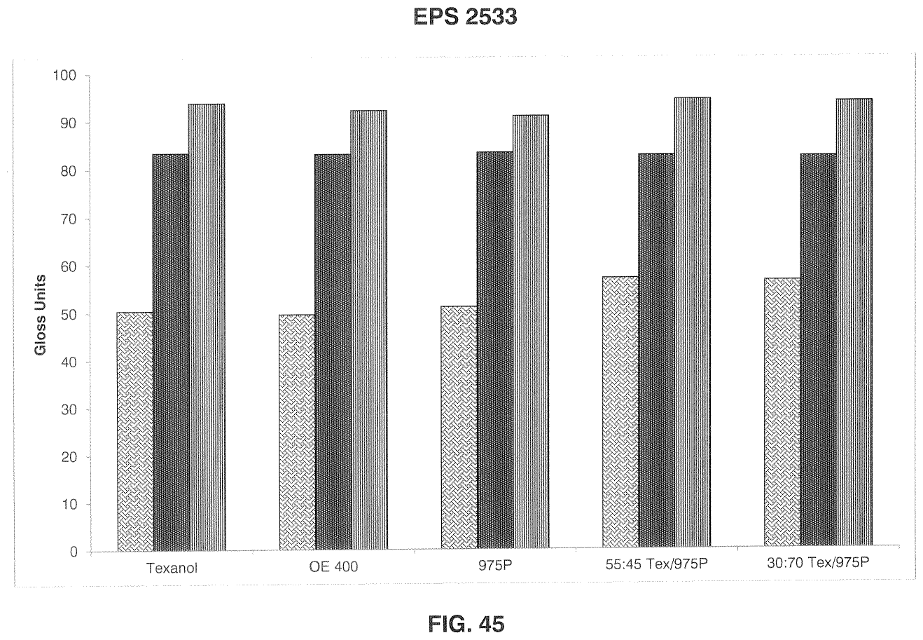

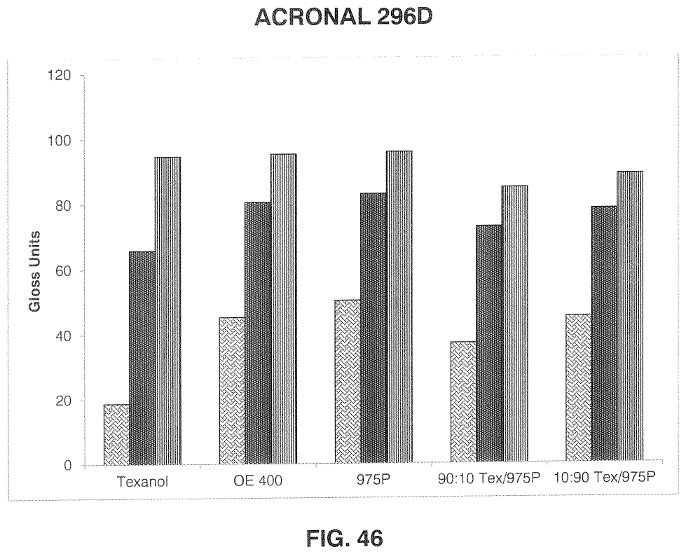

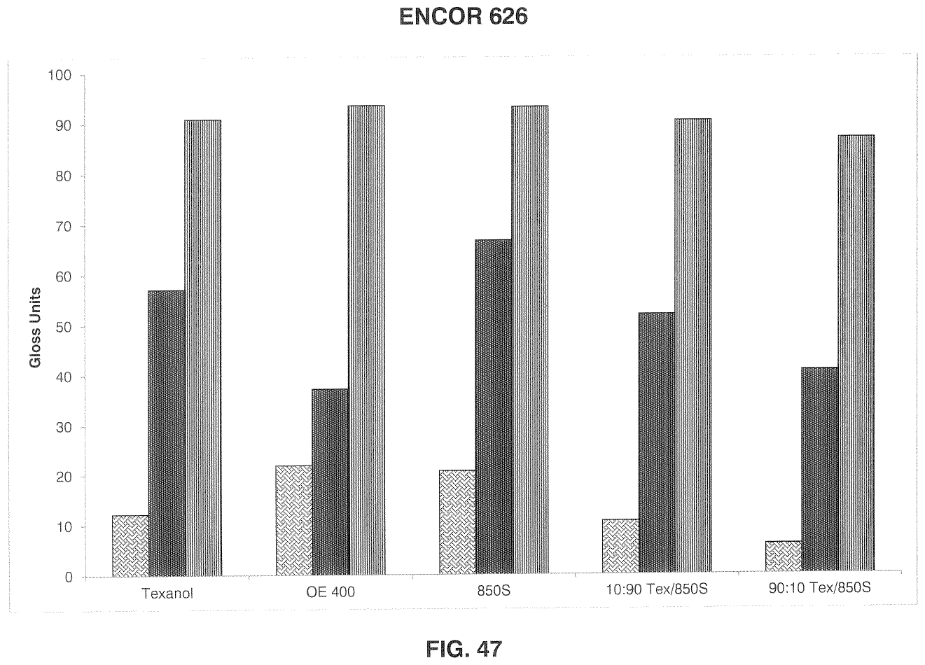

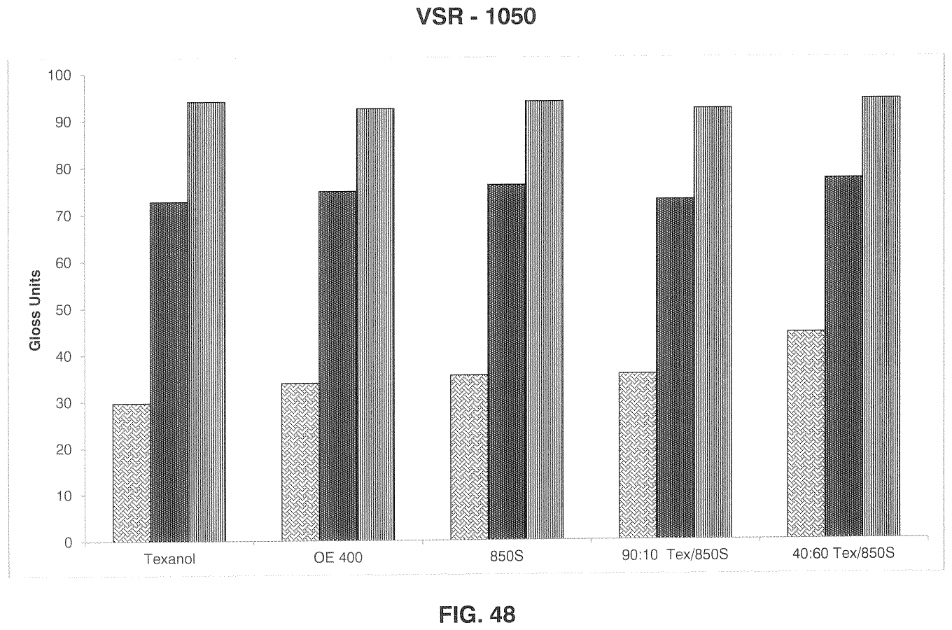

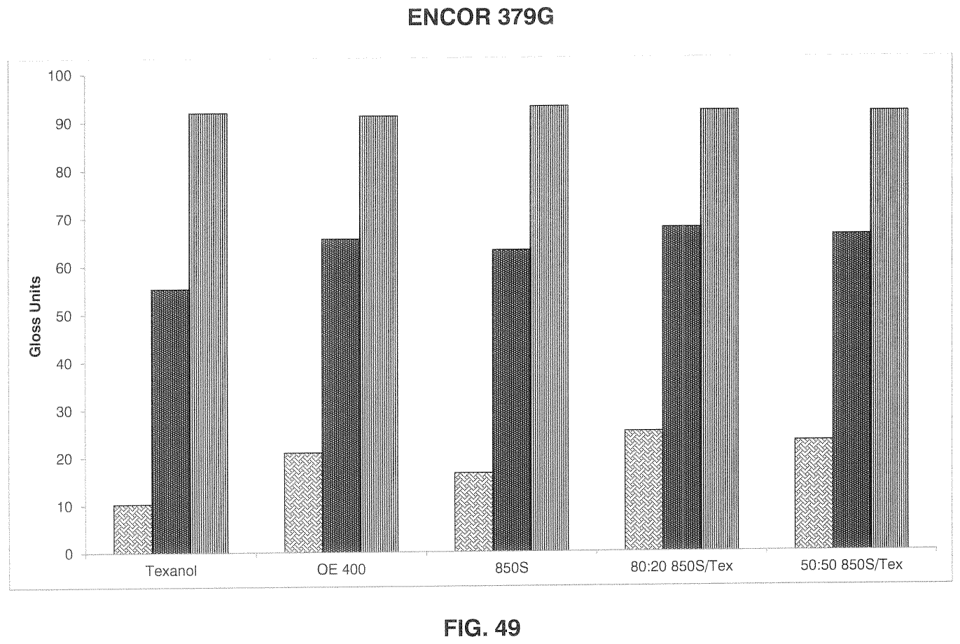

Gloss. Gloss was measured for the same binders and coalescents and inventive low VOC multifunctional additive blends of TXMB and K-FLEX® 850S and K-FLEX® 975P shown above. Results are set forth as gloss units in FIGS. 44-49 and are comparable for all coalescents and blends tested.

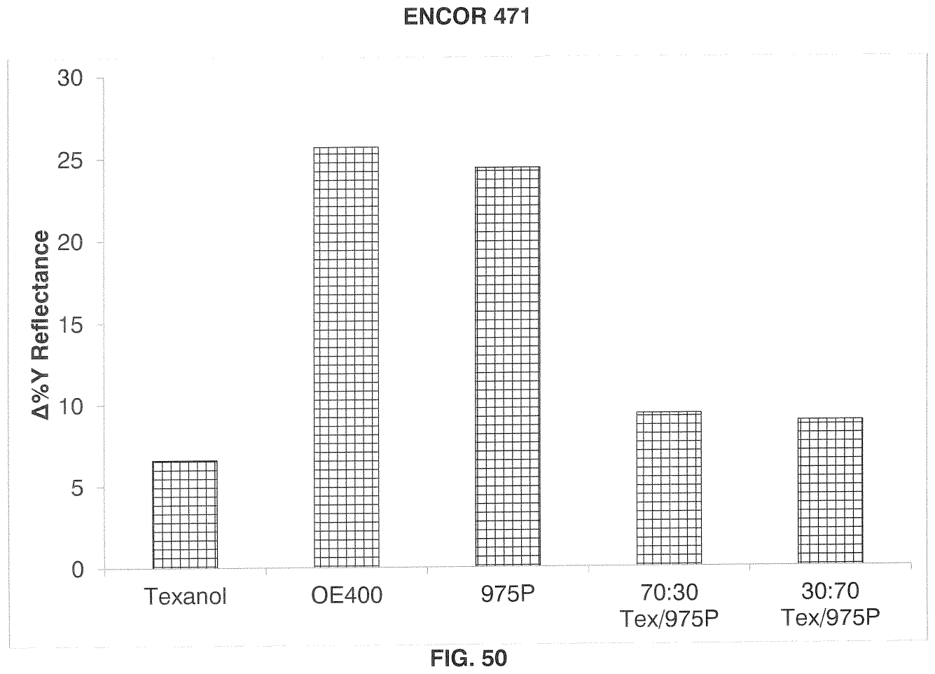

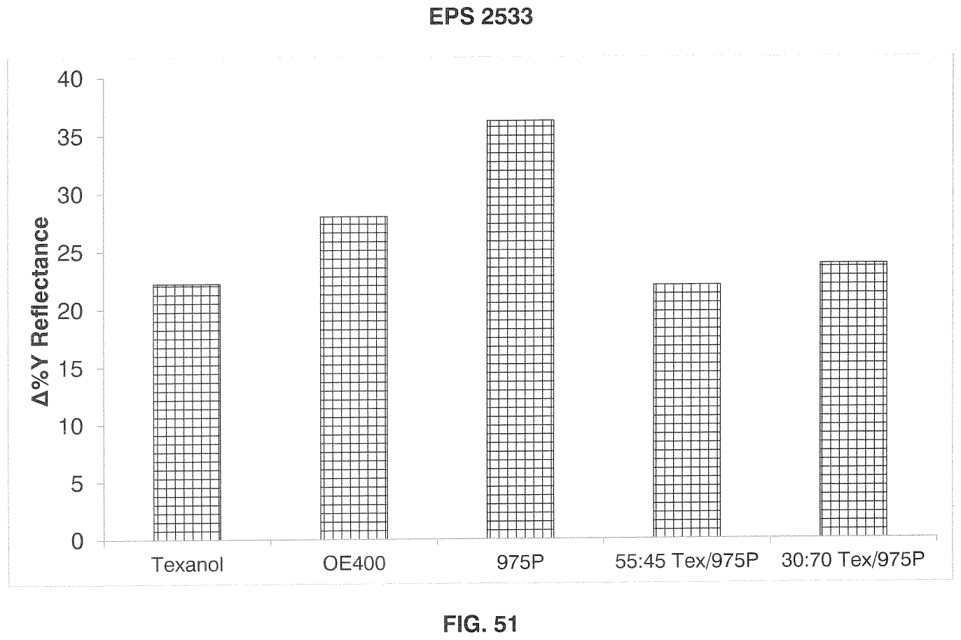

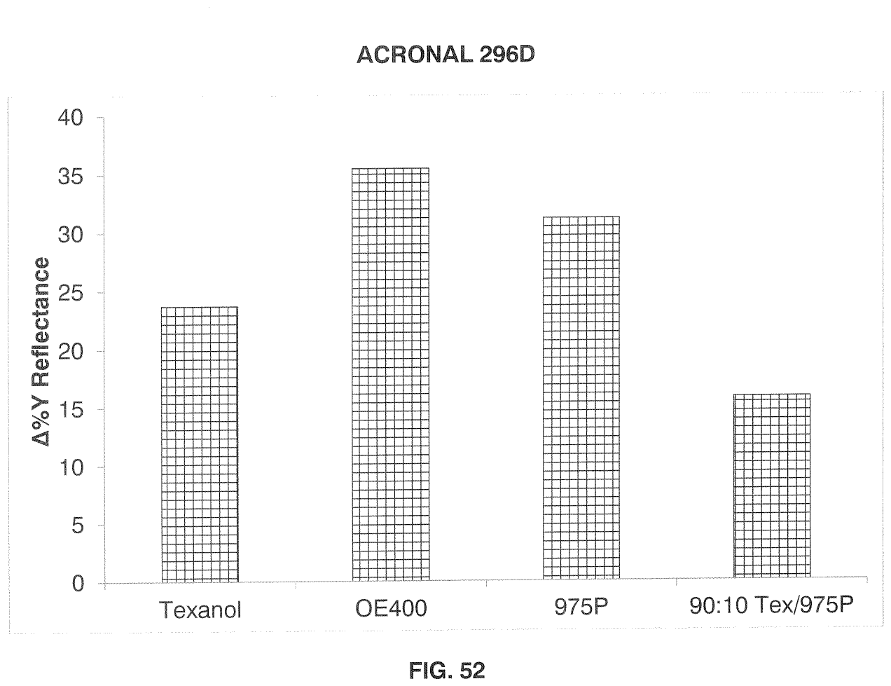

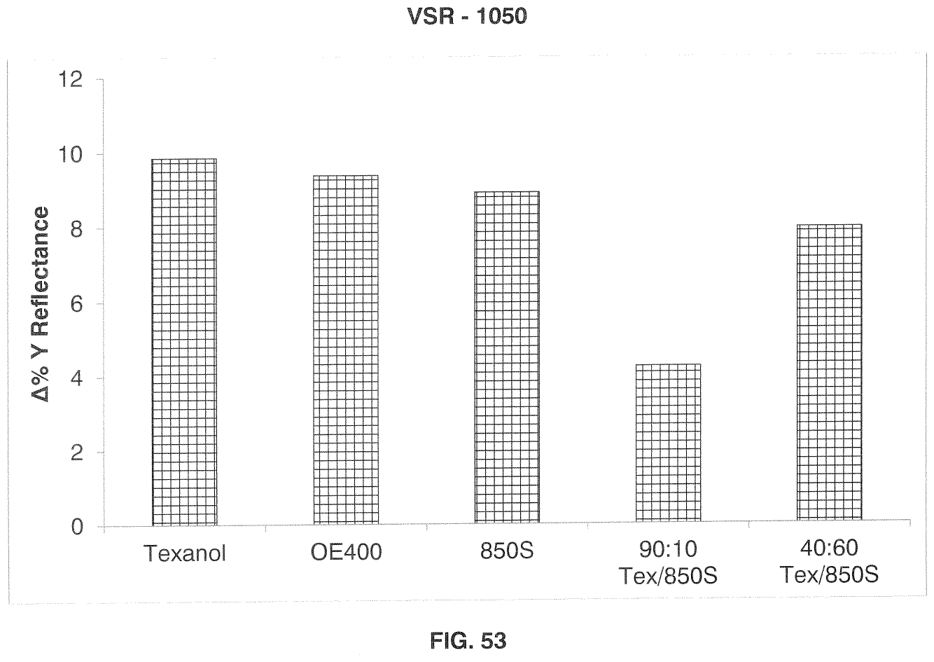

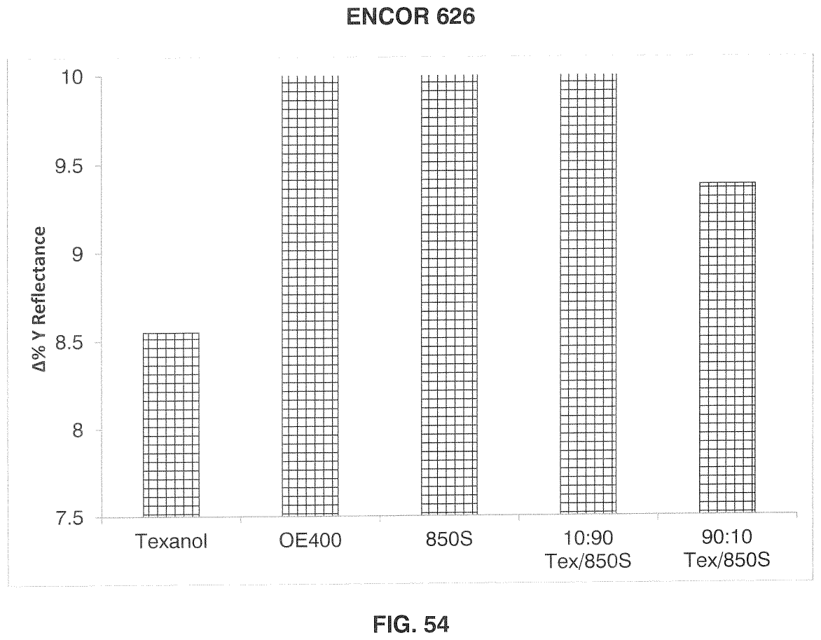

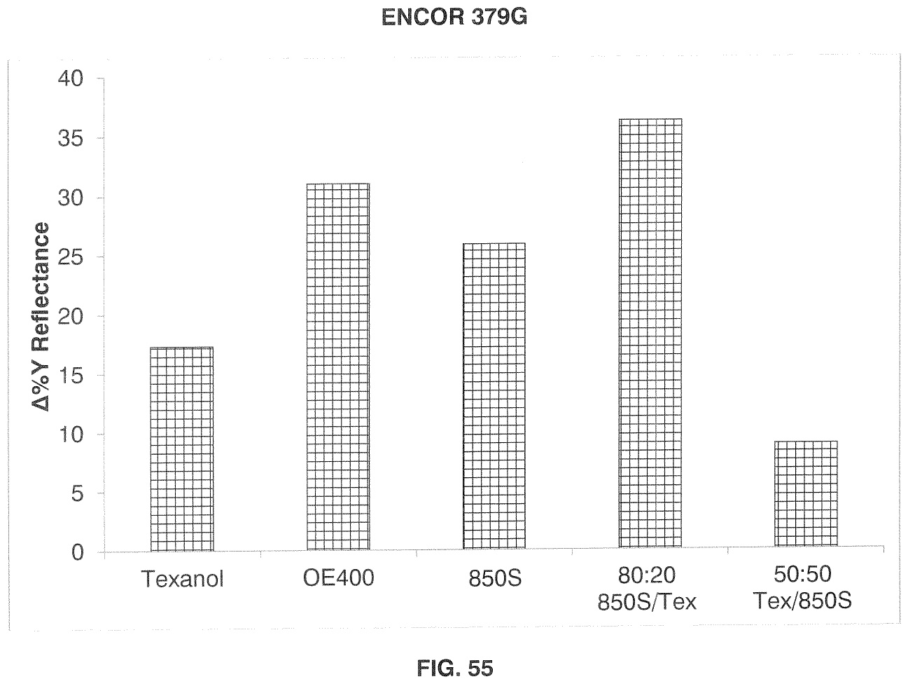

Dirt Pickup. Dirt pickup resistance was measured for the same binders, coalescents, and inventive low VOC multifunctional additive blends as shown above for the scrub resistance testing, except for Acronal 296D in which only a blend of 90:10 TXMB: 975P was evaluated. Results are shown in FIGS. 50-55, with the lower A % Y Reflectance demonstrating greater dirt pickup resistance.

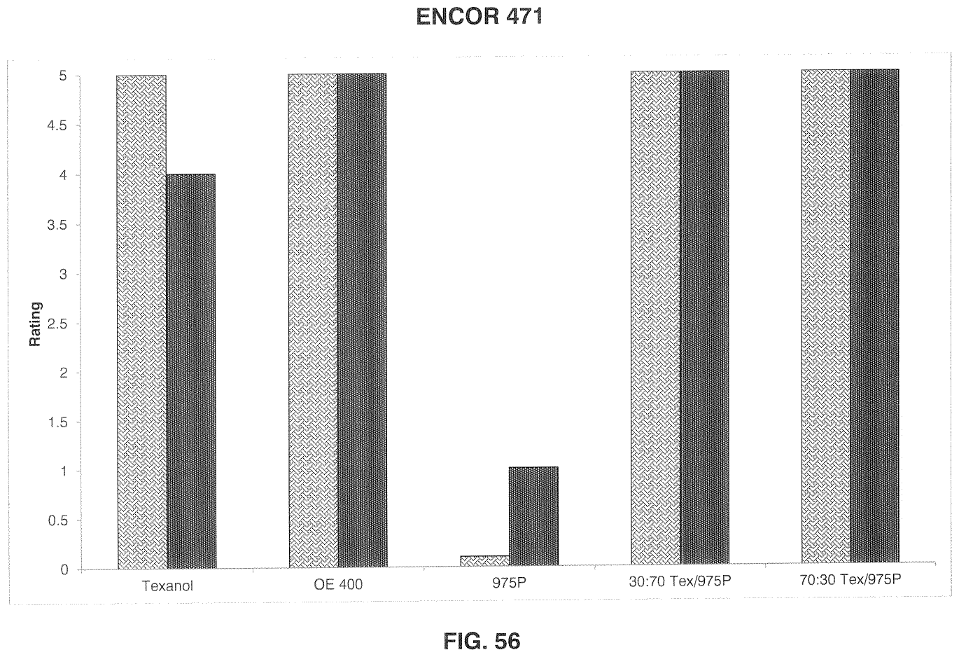

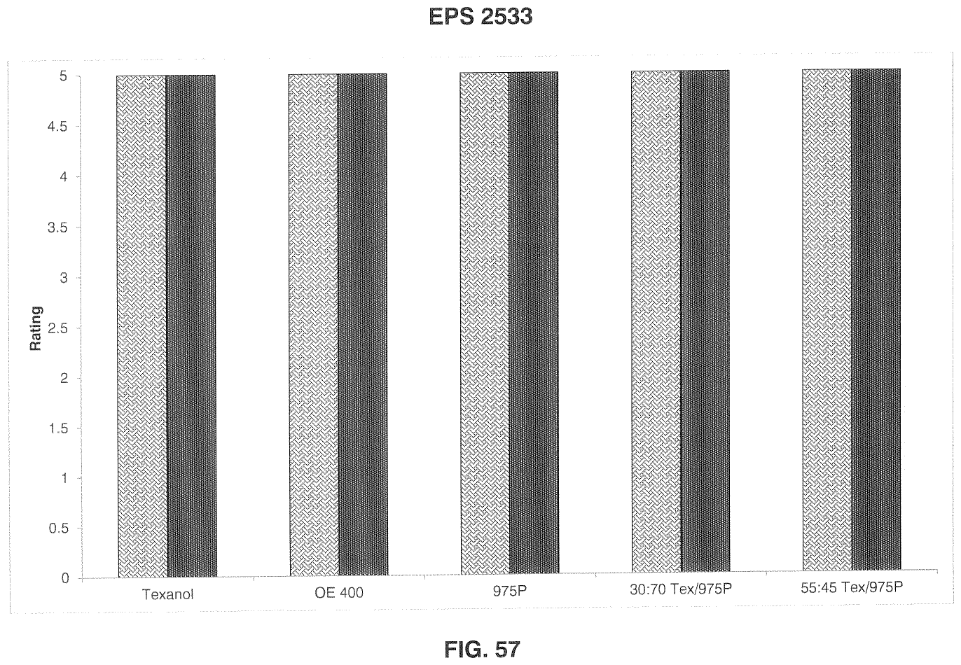

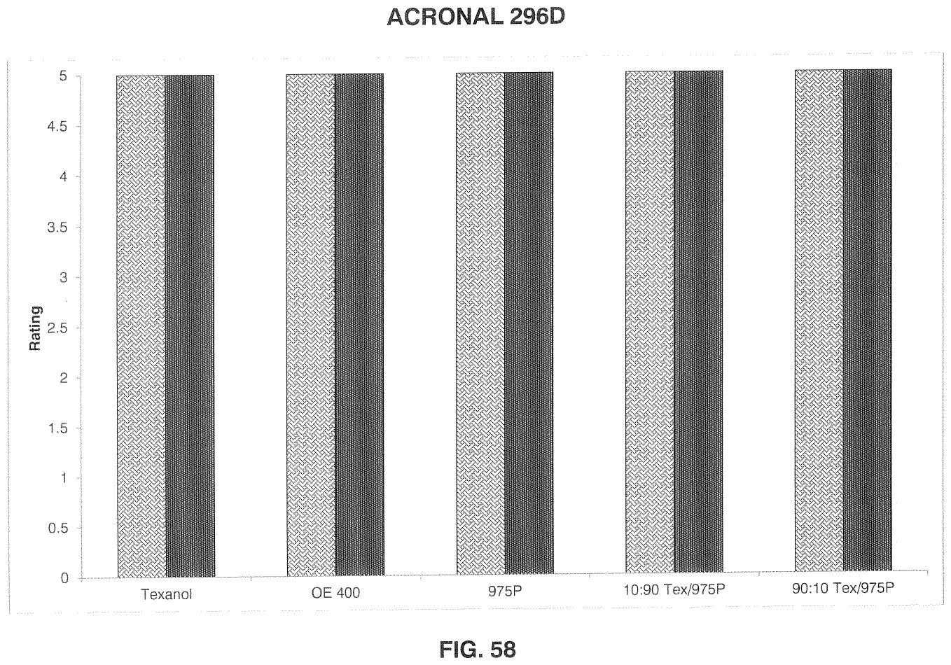

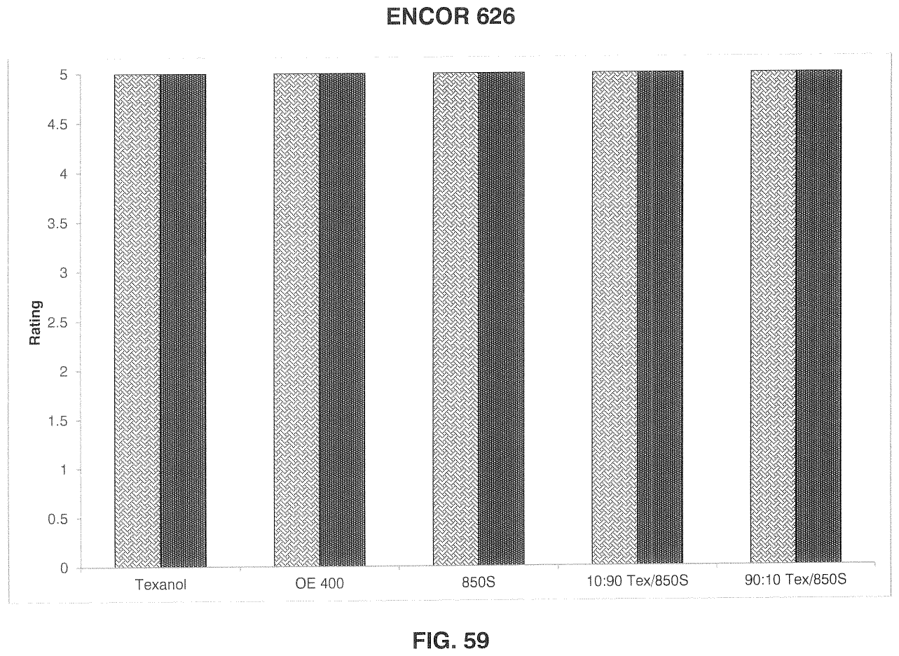

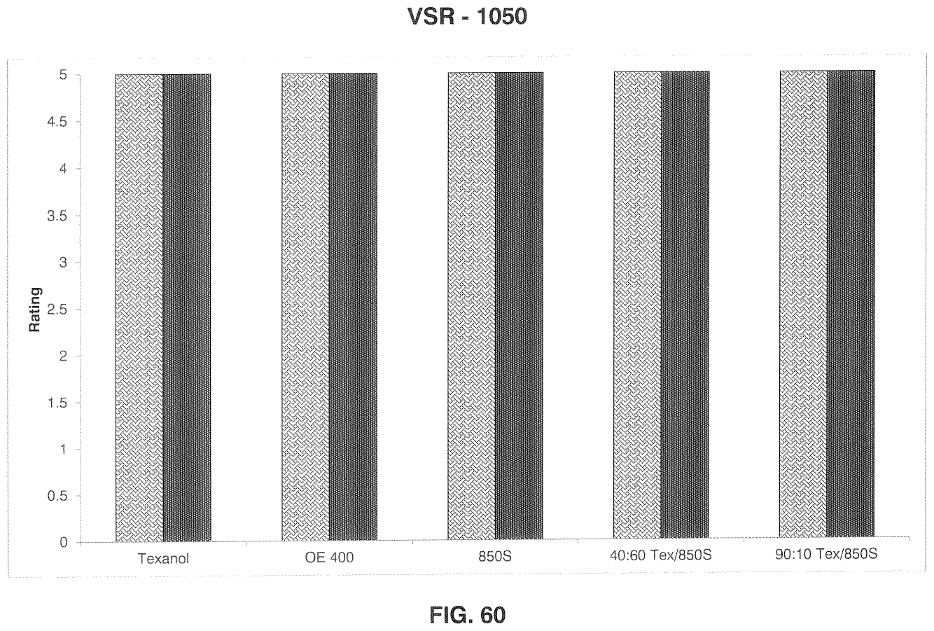

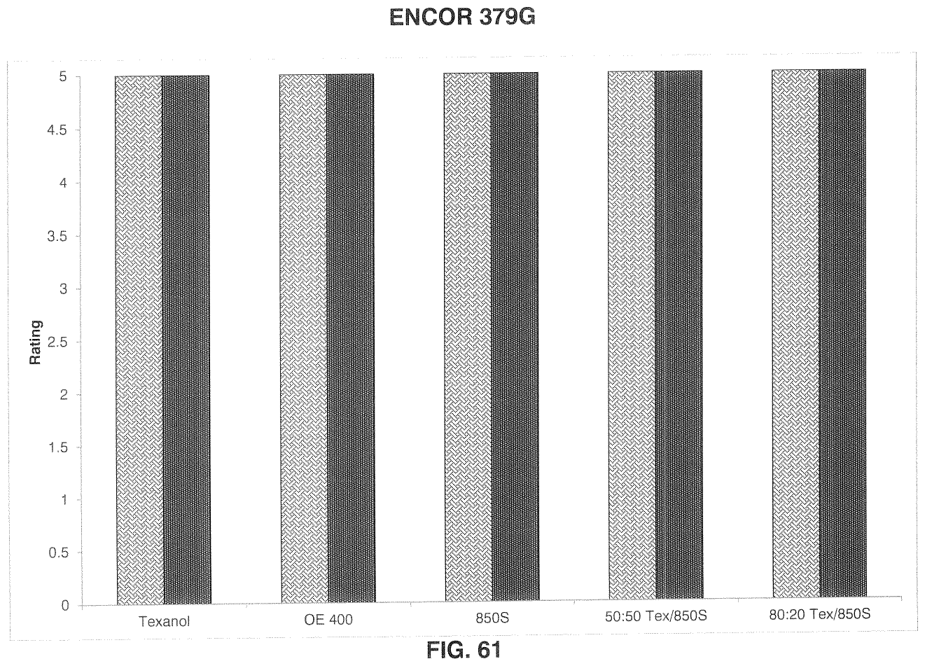

Low Temperature Coalescence. Low temperature coalescence was measured for the same binders, coalescents, and inventive low VOC multifunctional additive blends as for the scrub resistance evaluation above. Results are shown in FIGS. 56-61. Results obtained for the multifunctional additive blends evaluated were comparable to TXMB, OE-400, and K-FLEX® 850S or 975P alone.

### Example 22—Direct-to Metal Coatings—Wet Adhesion Testing

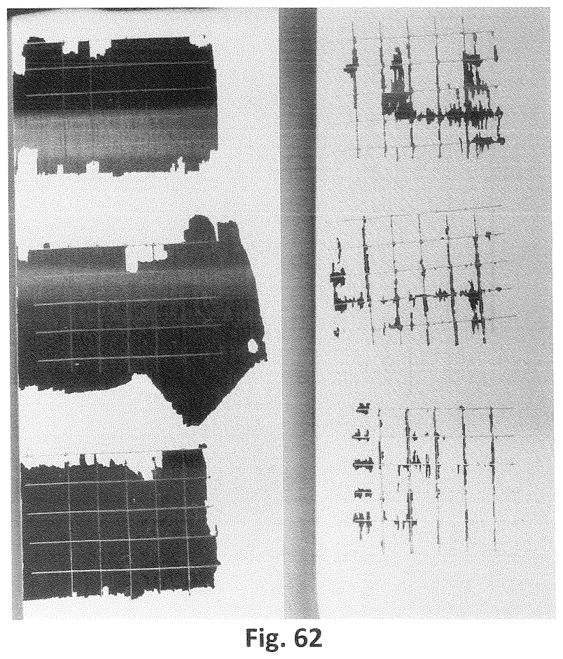

Wet adhesion testing using ASTM D3359 was conducted on a coated steel panel, using the direct-to-metal waterborne coating of Table 5 containing a blend of propylene glycol dibenzoate and dipropylene glycol n-butyl ether as a coalescent solvent or an inventive low VOC multifunctional additive blend of propylene glycol dibenzoate and benzyl alcohol as a coalescent solvent. FIG. 62, left image, shows the results of the wet adhesion testing (ASTM D3359) for the dibenzoate/ether combination. The right image of FIG. 62 shows wet adhesion testing results for an inventive dibenzoate/benzyl alcohol combination for the same formulation substituting benzyl alcohol for the ether. FIG. 62 demonstrated that benzyl alcohol combined with a dibenzoate greatly improves wet adhesion over dibenzoate/glycol ether combinations typically used in direct-to-metal coatings.

### Example 23—Direct-to-Metal Coatings—Koenig Hardness

FIG. 63 shows Koenig hardness measurements over time for a direct-to-metal waterborne coating from Table 5 comparing use of a typical blend of propylene glycol dibenzoate and dipropylene glycol n-butyl ether, an inventive low VOC multifunctional additive blend of propylene glycol dibenzoate and benzyl alcohol, and a blend of butyl benzyl phthalate and dipropylene glycol n-butyl ether (DPnB), all in 1:1 ratios. The results show that the inventive multifunctional additive benzyl alcohol combined with a dibenzoate gives superior initial hardness measurements than traditional glycol ethers used with dibenzoates or phthalates in direct-to-metal coatings.

### Example 24—Direct-to-Metal Coating—Flash Rust

Table 6 shows the visual rating for flash rust using the flash rust method described above. The results reflect that sodium benzoate (NaB) showed compatibility with propylene glycol dibenzoate (PGDB) and benzyl alcohol in the direct-to-metal coating (of Table 5) to eliminate flash rust formation. The combination of all three gave improvements in wet adhesion, initial hardness, and flash rust resistance (not all results shown).

TABLE 6
Flash Rust Visual Ratings

| Sample Name/Ingredients | Rating |
|---|---|
| 0.15% NaB + PGDB + | 0-None |
| Benzyl Alcohol w/ | |
| anticorrosion pigments | |
| PGDB + DPnB w/ | 3-Moderate |
| anticorrosion pigments | |
| PGDB + DPnB w/o | 4-Severe |
| anticorrosion pigments | |

### Example 25—Additional Testing—Direct-to-Metal Coating

Additional testing was undertaken on a 40 PVC white direct-to-metal primer formulation set forth below, which is similar to that of Table 5, with the exception that sodium benzoate, not benzoic acid, was incorporated for corrosion (flash rust) resistance. Testing compared use of inventive multifunctional additive blends comprising PGDB and K:FLEX® 850S, each in combination with benzyl alcohol (1:1 ratio) with blends containing K-FLEX® PG (PGDB) and butyl benzyl phthalate (BBP), each with DPnB (1:1 ratio).

| INGREDIENT | WEIGHT (kg) |
|---|---|
| Grind | |
| Water | 81 |
| Nuosperse W-22 | 18 |
| Biosoft N1-3 | 3 |
| AMP-95 | 1 |
| Byk-024 | 1.5 |
| TiPure R-706 | 100 |
| Atomite, 3 microns | 200 |
| Shieldex AC-5 | 15 |
| SZP-391 | 2 |
| Let Down | |
| Grind Paste | 414 |
| EPS 2535 | 425 |
| Byk-024 | 0.5 |
| Nuosept 101 | |
| Water | 131 |
| Rheolate 1 | 4 |
| Dipropylene glycol | 28.7 |
| n-butyl ether (DPnB) | |
| or Benzyl alcohol | |
| Propylene Glycol | 28.7 |
| Dibenzoate or | |
| K-FLEX ® 850S | |
| Sodium Benzoate | 1.6 |
| Acrysol RM-825 | 1.0 |
| Total (Let Down) | ~1036 |

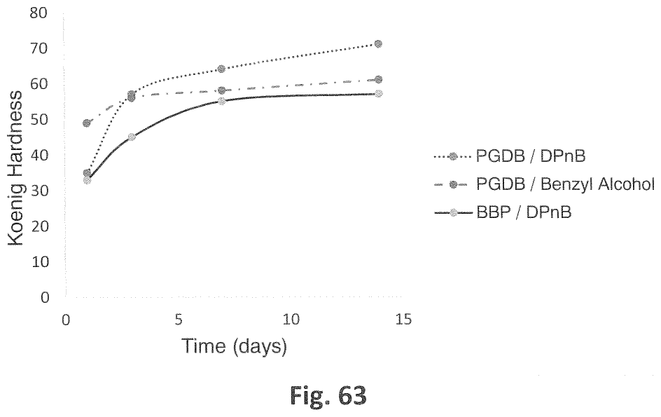

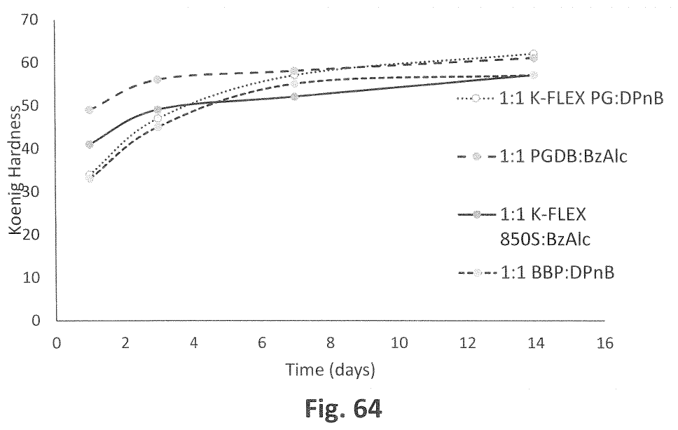

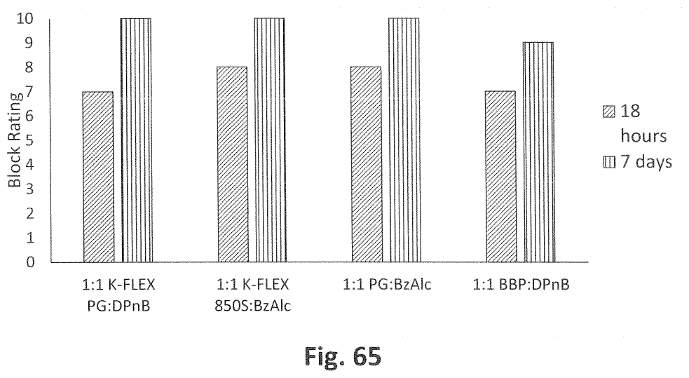

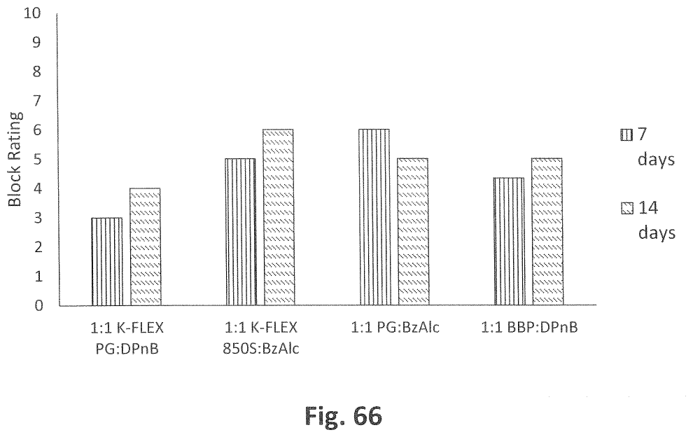

Results show that the samples comprising the inventive blends containing benzyl alcohol achieved greater early hardness development than samples with blends containing DPnB as shown in FIG. 64. In addition, samples comprising the inventive multifunctional additive blends containing benzyl alcohol had higher block ratings at room temperature (23° C.) (FIG. 65) than the other samples after 18 hours of drying. After 7 days, all the samples had excellent block ratings. For block resistance at 50° C., the samples comprising the inventive multifunctional additive blends containing benzyl alcohol had increased block ratings at both 7 and 14 days. (FIG. 66).

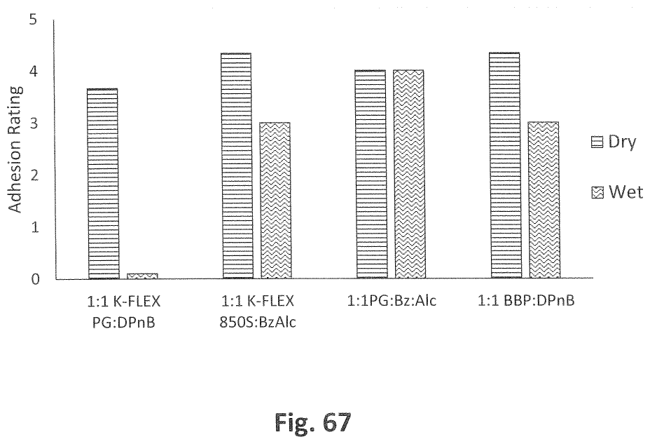

Dry and wet adhesion was also evaluated on the same samples. Paint films were dried for 21 days on steel panels, soaked in water for 1 hour and immediately tested. The samples comprising the inventive multifunctional additive blends containing benzyl alcohol had similar wet and dry adhesion compared to the BBP:DPnB. The K-FLEX® PG:DPnB sample had very poor wet adhesion. Results are shown in FIG. 67.

### Example 26—Freeze Thaw Testing

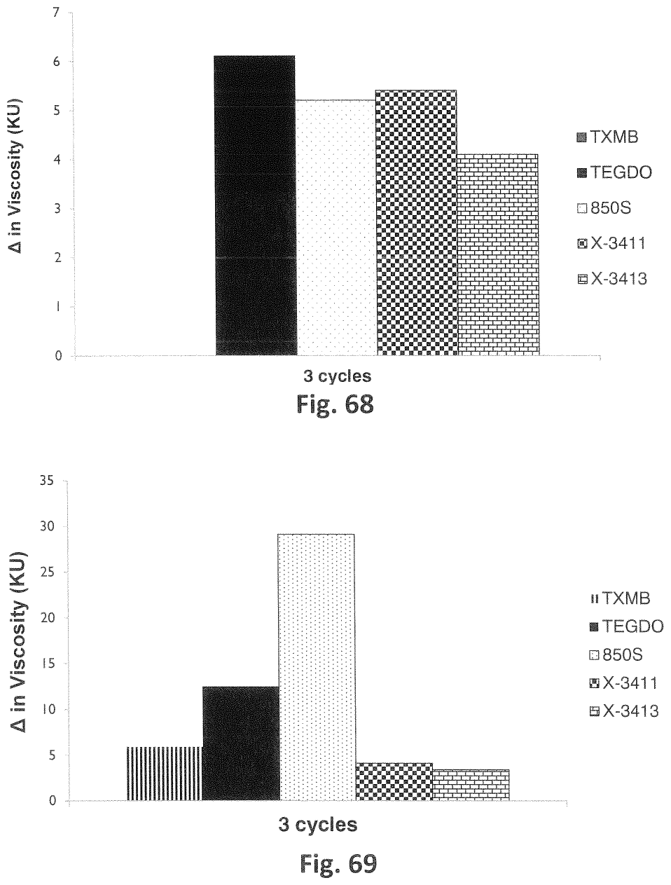

Freeze-Thaw testing was conducted on a styrene acrylic binder and an all-acrylic binder comparing TXMB, TEGDO, K-FLEX® 850S, X-3411 and X-3413. Results for the styrene-acrylic binder-based coating are shown in FIG. 68. Results are not apparent for TXMB since it gelled during the freeze-thaw cycles. The other coalescents performed similarly after the three freeze-thaw cycles, with TEGDO increasing six KU in viscosity versus four KU for the X-3413. For the all-acrylic binder formulations, coatings with 850S, TEGDO, and TXMB increased in viscosity by more than five KU after the first three freeze-thaw cycles (FIG. 69). The largest increase was observed in the 850S sample, at an almost 30 KU increase in viscosity, followed by TEGDO at a 12.5 KU increase. Significantly, in each of the different binders, coatings with X-3411 or X-3413 had the smallest change in viscosity. Also, the inclusion of benzyl alcohol or high VOC component (X-3411 & X-3413) dramatically improved stability over just 850S alone, as further discussed in Example 27.

### Example 27—Efficacy of Higher VOC Components in Multifunctional Additive Blends/Polymer Stability

A few grams of benzyl alcohol was added alone to an Encor 471 styrene-acrylic polymer. A complete destabilization of the polymer was observed. The amount added was far less than the than the benzyl alcohol portion in the benzyl alcohol:850S (X-3411) blend tested above. In the examples above, the benzyl alcohol:850S blend was added (1:1 ratio) and did not destabilize the polymer. Added alone, benzyl alcohol had a significant polymer destabilizing effect. The same effect was observed in an Encor 626 acrylic binder as well. When benzyl alcohol was added even at small amounts alone, polymer flakes crashed out of the binder indicating destabilization. Adding a benzyl alcohol:850S blend had no such effect. The binder (polymer) remained stable. The percentage of the benzyl alcohol portion of the multifunctional additive blend was 1.25 wt. % to the binder. In contrast, using benzyl alcohol alone, at a lower amount of 1.1 wt. % or even lower at 0.5 wt. %, the binder destabilized.

The inventive multifunctional additive blend of benzyl alcohol:dibenzoate (850S) improved the incorporation of benzyl alcohol into the polymer emulsion allowing for a much more stable product. The same observation was made for benzyl alcohol blended with OE-400.

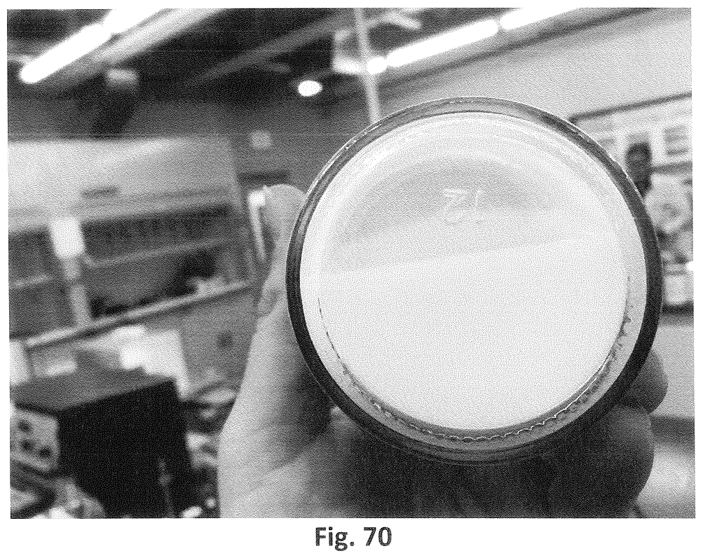

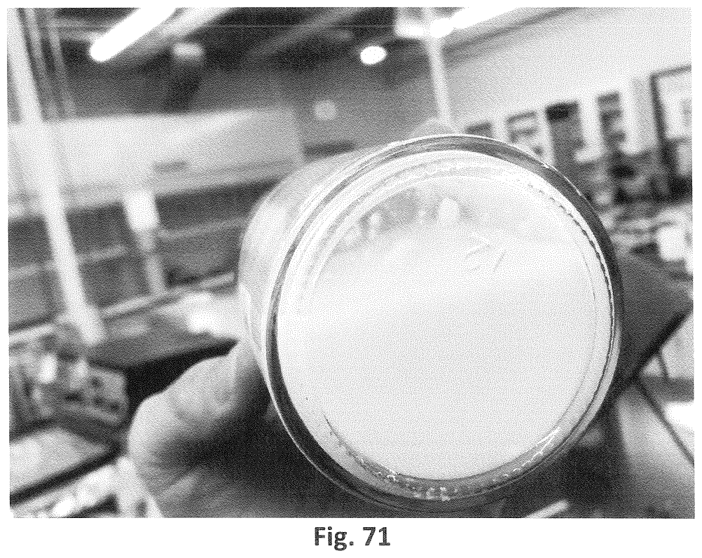

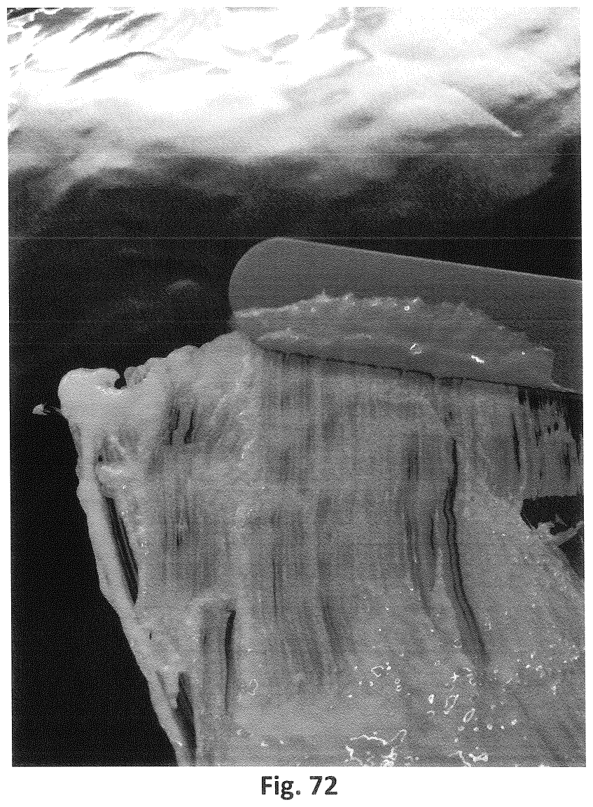

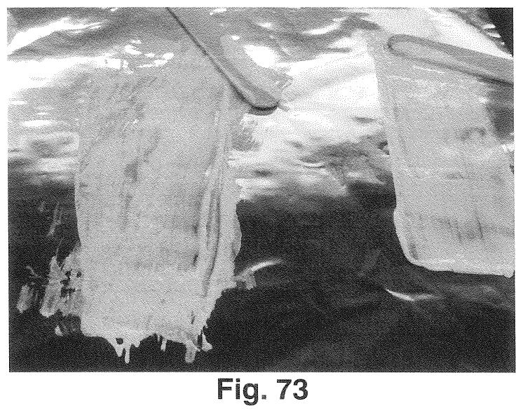

FIGS. 70-73 reflect some of the results observed. FIG. 70 shows an image of Encor 626 binder blended with 2.5 wt. % of the inventive low VOC multifunctional additive blend X-3411 to the binder. The image depicts a stable polymer emulsion that resulted from incorporating the low VOC multifunctional additive. FIG. 71 shows an image of Encor 626 binder blended with 1.1 wt. % benzyl alcohol to the binder. The image depicts an unstable polymer emulsion and aggregates/flocculant observed at the bottom of the glass jar. FIG. 72 depicts post-adding benzyl alcohol at 3.95 wt. % to the binder to a semigloss Encor 471 fully formulated coating. Aggregates and flocculants were observed, as seen in the image. The same level of benzyl alcohol (3.95 wt. % to binder) is achieved when X-3411 is used at 7.9 wt. % to the binder, but surprisingly, a stable non-flocculated coating results, as shown in the right drawdown of FIG. 73.

### Example 28—Low VOC Multifunctional Additive Blends—Ratios

The foregoing examples demonstrated efficacy of the inventive low VOC multifunctional additive blends comprising a low volatile component and a high volatile component in varying ratios. The inventive low VOC multifunctional additive blends comprise at least one low volatile component and at least one volatile component and are combined in ratios of low volatile component to high volatile component ranging from about 1:10 to about 10:1. The low volatile component is a dibenzoate, a dibenzoate blend, a monobenzoate, a phthalate, a terephthalate, a 1,2-cyclohexane dicarboxylate ester, a citrate, an adipate, triethylene glycol dioctanoate (TEGDO), Optifilm™ Enhancer 400, or a mixture of refined diisobutyl esters of adipic acid, glutaric acid, and succinic acid (Coasol). The high volatile component is diethylene glycol monomethyl ether, ethylene glycol monobutyl ether, diethylene glycol monobutyl ether, 2,2,4-trimethyl-1,3-pentanediol monoisobutyrate (TXMB), benzylamine, phenoxyethanol, phenyl ethanol, benzyl alcohol, benzyl benzoate, butyl benzoate, 3-phenyl propanol, 2-methyl-3-phenyl propanol, R-methylcinnamyl alcohol, or vanillin. Combinations of TXMB and TEGDO or TXMB and OE-400, previously reported, are not included in the inventive low VOC multifunctional additive blends.

Low volatile components and high volatile components are blended to form the low VOC multifunctional additives of the invention in ratios of 1:10 to 10:1 and provide, in addition to coalescence, improvements in hardness, hardness development, scrub resistance, block resistance, dirt pickup resistance, wet adhesion and in some instances flash rust resistance when combined with benzoic acid according to the methods set forth herein. The low VOC multifunctional additives of the invention are an alternative to traditional higher VOC coalescents previously utilized and are a method of reducing the VOC content of coatings and other waterborne polymer film-forming compositions, while achieving performance improvements.

### Example 29—Carrier for Pigment and Colorants

The inventive low VOC multifunctional additive blends are useful carriers for waterborne or solvent-borne pigments or colorants (colors, dyes). Typical formulations for waterborne colorants and solvent-borne colorants using X-3411 are shown below, although the amount of low VOC multifunctional additive blend in this application varies based upon the waterborne polymer system, the nature and type of pigments and colorants, the amount of color required, the presence of other components and the presence of water vs. other solvents.

Waterborne Colorant

| Ingredient | Wt. % |
|---|---|
| Pigment Dispersant BYK-154 | 9% |
| (ammonium polyacrylate copolymer) | |
| Pigment L3920 (red) | 10% |
| X-3411 | 2.5% |
| Water | 78.5% |

Solvent-borne Colorant

| Ingredient | Wt. % |
|---|---|
| Pigment Dispersant Anti-Terra-U | 9% |
| (unsaturated polyamine amides | |
| and low MW acidic polyesters) | |
| Pigment L3920 (red) | 110% |
| X-3411 | 81% |

The examples above demonstrate that low VOC coatings can be formulated with lower volatility coalescent components, including without limitation dibenzoate glycol esters, monobenzoates, phthalates, and other low VOC coalescents, to have, in addition to coalescence, increased hardness, block resistance, gloss, dirt pickup resistance, scrub resistance, wet adhesion and corrosion resistance, among other properties, by blending a low volatile component with a high volatile component in accordance with the present invention. Significant improvement in properties is achieved with minimal increases in VOC content. Use of known low volatile coalescents or film-formers in combination with the high volatile components of the invention allows formulators freedom of design to include higher VOC components in their coatings to achieve various properties which are critical to specific applications without unduly increasing VOC content of formulations. The present invention demonstrates the use of known low VOC coalescents or film formers in combination with higher VOC components, some of which were not known, recognized or heretofore utilized as coalescing agents, to improve properties that may have been compromised by the use of lower VOC coalescent components in the past. Surprisingly, the inventive multifunctional additive blends of the invention provided not only coalescence but also improvements in performance properties over that achieved with high VOC coalescents used alone.

While the examples focused on only some of the lower VOC coalescent components that are available and some of the basic binders (coating compositions) to illustrate coalescent polymer properties, the improvements achieved are expected to apply with different low VOC coalescent components, polymers (binders) and pigment volume concentrations. Unexpectedly, formulating with the high volatile components identified herein, even those not previously known or utilized as coalescents, and lower VOC components achieved improved hardness, hardness development, block resistance, scrub resistance, dirt pickup resistance, wet adhesion, corrosion resistance, and polymer stabilization, among other properties, in the coatings evaluated.

The inventive low VOC multifunctional additive blends are viable alternatives for use in coatings or other waterborne polymer systems where low VOC content is desired. The inventive low VOC multifunctional additive blends provide for low VOC content while actually enhancing key coatings and other waterborne system properties. The low VOC multifunctional additive blends are also useful to disperse colorants prior to adding to a waterborne polymer system.

While in accordance with the patent statutes, the best mode and preferred embodiment have been set forth, the scope of the invention is not limited thereto, but rather by the scope of the attached claims.

What is claimed is:

1. A low VOC multifunctional additive blend for use in waterborne polymer film-forming compositions, comprising:
a. at least one low volatile component comprising a dibenzoate, a dibenzoate blend, a monobenzoate, a phthalate, a terephthalate, a 1,2-cyclohexane dicarboxylate ester, a citrate, an adipate, triethylene glycol dioctanoate, Optifilm™ Enhancer 400, or a mixture of refined diisobutyl esters of adipic acid, glutaric acid, and succinic acid, blended with;
b. at least one high volatile component comprising diethylene glycol monomethyl ether, ethylene glycol monobutyl ether, diethylene glycol monobutyl ether, 2,2,4-trimethyl-1,3-pentanediol monoisobutyrate, benzylamine, phenoxyethanol, phenyl ethanol, benzyl alcohol, benzyl benzoate, butyl benzoate, 3-phenyl propanol, 2-methyl-3-phenyl propanol, β-methylcinnamyl alcohol, or vanillin,
wherein the multifunctional additive blend does not include a blend of 2,2,4-trimethyl-1,3-pentanediol monoisobutyrate with Optifilm™ Enhancer 400 or a blend of 2,2,4-trimethyl-1,3-pentanediol monoisobutyrate with triethylene glycol dioctanoate.

2. The multifunctional additive blend according to claim 1, wherein the dibenzoate comprises diethylene glycol dibenzoate, dipropylene glycol dibenzoate, 1,2-propylene glycol dibenzoate, triethylene glycol dibenzoate, tripropylene glycol dibenzoate or mixtures thereof, wherein the monobenzoate comprises 2-ethylhexyl benzoate, isodecyl benzoate, isononyl benzoate, 3-phenyl propyl benzoate, 2-methyl-3-phenyl propyl benzoate, or mixtures thereof, wherein the terephthalate comprises di-2-ethylhexyl terephthalate, dibutyl terephthalate or diisopentyl terephthalate, or mixtures thereof, wherein the 1,2-cyclohexane dicarboxylate ester is diisononyl-1, 2 cyclohexane dicarboxylate, wherein the phthalate comprises di-n-butyl phthalate, diisobutyl phthalate, or butyl benzyl phthalate, or mixtures thereof, and wherein the citrate comprises acetyl tributyl citrate or tri-n-butyl citrate, or mixtures thereof.

3. The multifunctional additive blend according to claim 1, wherein the low volatile component is a dibenzoate and the high volatile component is 2,2,4-trimethyl-1,3-pentanediol monoisobutyrate.

4. The multifunctional additive blend according to claim 1, wherein the low volatile component is a dibenzoate and the high volatile component is benzyl alcohol.

5. The multifunctional additive blend according to claim 1, wherein the low volatile component is triethylene glycol dioctanoate or Optifilm™ Enhancer-400 and the high volatile component is benzyl alcohol.

6. The multifunctional additive blend according to claim 1, wherein the low volatile component is a dibenzoate and the high volatile component is 3-phenylpropanol.

7. The multifunctional additive blend according to claim 1, wherein the low volatile component is a dibenzoate and the high volatile component is benzyl benzoate.

8. The multifunctional additive blend according to claim 1, wherein the low volatile component is a dibenzoate and the high volatile component is 2-methyl-3-phenyl propanol.

9. A waterborne coating comprising the multifunctional additive blend according to claim 1.

10. A waterborne coating comprising a styrene-acrylic binder and the multifunctional additive blend according to claim 1.

11. A waterborne coating comprising a vinyl acrylic binder and the multifunctional additive blend according to claim 1.

12. A waterborne coating comprising a 100% acrylic binder and the multifunctional additive blend according to claim 1.

13. A waterborne coating comprising a vinyl acetate-ethylene binder and the multifunctional additive blend according to claim 1.

14. A waterborne coating comprising an alkyd based binder and the multifunctional additive blend according to claim 1.

15. A waterborne coating having improved hardness and scrub resistance, comprising:
a. a binder,
b. the multifunctional additive blend according to claim 1,
c. a pigment,
d. a surfactant, and
e. a rheology modifier,
wherein the multifunctional additive blend is present in about 0.1 to 15 wt. % to binder, based on 100 grams of binder.

16. A waterborne coating comprising: a) styrene acrylic binder, a 100% acrylic binder a vinyl acrylic binder, or an alkyd and b) the multifunctional additive blend according to claim 1.

17. A method of increasing the hardness and scrub resistance of a waterborne coating, comprising the step of adding the multifunctional additive blend according to claim 1 to the waterborne coating.

18. A method of improving the antimicrobial properties of a waterborne coating, comprising the step of adding a blend of:
a. at least one low volatile component comprising a dibenzoate, a dibenzoate blend, a monobenzoate, a phthalate, a terephthalate, a 1,2-cyclohexane dicarboxylate ester, a citrate, an adipate, triethylene glycol dioctanoate, Optifilm™ Enhancer 400, or a mixture of refined diisobutyl esters of adipic acid, glutaric acid, and succinic acid, and
b. a high volatile component comprising diethylene glycol monomethyl ether, ethylene glycol monobutyl ether, diethylene glycol monobutyl ether, 2,2,4-trimethyl-1,3-pentanediol monoisobutyrate, benzylamine, phenoxyethanol, phenyl ethanol, benzyl alcohol, benzyl benzoate, butyl benzoate, 3-phenyl propanol, 2-methyl-3-phenyl propanol, or vanillin.

19. A waterborne coating having improved hardness, scrub resistance, block resistance, freeze-thaw, and dirt pickup resistance, comprising:
a. a binder comprising vinyl polymers, polyurethanes, polyamides, polysulfides, nitrocellulose and other cellulosic polymers, polyvinyl acetate and copolymers thereof, polyacrylates and copolymers thereof, acrylics and copolymers thereof, epoxies, phenol-formaldehyde polymers, melamines, alkyds and vinyl esters of versatic acid; and
b. the multifunctional additive blend according to claim 1, wherein the multifunctional additive blend is present in about 0.1 to 15% to binder, based on 100 grams of binder.

20. The waterborne coating according to claim 19 wherein the vinyl polymers comprise vinyl acetate, vinylidene chloride, diethyl fumarate, diethyl maleate, or polyvinyl butyral; wherein the polyvinyl acetate and copolymers thereof comprise ethylene vinyl acetate or vinyl acetate-ethylene; wherein the polyacrylates and copolymers thereof comprise methyl methacrylate, ethyl methacrylate, butyl methacrylate, cyclohexyl methacrylate, allyl methacrylate, benzyl methacrylate, methyl acrylate, ethyl acrylate, butyl acrylate, or 2-ethylhexyl acrylate, wherein the acrylics and copolymers thereof comprise 100% acrylic acid, methacrylic acid, vinyl acrylics, styrenated acrylics, and acrylic-epoxy hybrids.

21. A waterborne direct-to-metal coating comprising a low VOC multifunctional additive blend of benzyl alcohol and propylene glycol dibenzoate to improve wet adhesion and initial rate of hardness development.

22. A waterborne direct-to-metal coating comprising a multifunctional additive blend of benzyl alcohol and a dibenzoate to improve wet adhesion and initial rate of hardness development.

23. A waterborne direct-to-metal coating comprising a multifunctional additive blend according to claim 1 to improve wet adhesion and initial rate of hardness development.

24. A waterborne direct-to-metal coating comprising benzyl alcohol, propylene glycol dibenzoate, and sodium benzoate to improve wet adhesion, initial rate of hardness development, and flash rust resistance.

25. A waterborne direct-to-metal coating comprising a multifunctional additive blend of benzyl alcohol, a dibenzoate, and benzoic acid to improve wet adhesion, initial rate of hardness development, and flash rust resistance.

26. A waterborne direct-to-metal coating comprising a multifunctional additive blend according to claim 1 and benzoic acid to improve wet adhesion, initial rate of hardness development, and flash rust resistance.

27. A method to incorporate benzoic acid into waterborne coatings, comprising the step of synthesizing a dibenzoate with a percent molar excess of benzoic acid to form an excess-acid dibenzoate, wherein excess benzoic acid is present in a concentration sufficient for improved flash rust resistance when added to a waterborne direct-to-metal coating formulation.

28. A method to incorporate benzoic acid into waterborne coatings by dissolving benzoic acid in a dibenzoate at a concentration sufficient for improved flash rust resistance when added to a waterborne direct-to-metal coating formulation.

29. The method according to claim 27, wherein benzyl alcohol is added to the excess-acid dibenzoate to form a low VOC multifunctional additive blend to improve wet adhesion, initial rate of hardness development, and flash rust resistance of a waterborne direct-to-metal coating.

30. A method of forming a low VOC multifunctional additive blend comprising the step of: blending the excess benzoic dibenzoate according to claim 27 with benzyl alcohol, wherein the multifunctional additive blend improves wet adhesion, initial rate of hardness development, and flash rust resistance of a waterborne direct-to-metal coating.

31. A method of compatibilizing high VOC components with a binder in a waterborne coating formulation, comprising the steps of:
a. combining a low VOC component comprising triethylene glycol dioctanoate, Optifilm™ Enhancer-400 or a dibenzoate with a high VOC component comprising 2,2,4-trimethyl-1,3-pentanediol monoisobutyrate, benzylamine, phenoxyethanol, phenyl ethanol, benzyl alcohol, benzyl benzoate, 3-phenyl propanol, 2-methyl-3-phenyl propanol, vanillin or β-methylcinnamyl alcohol to form a multifunctional additive blend; and
b. adding the multifunctional additive blend to a waterborne coating formulation,
wherein the multifunctional additive blend does not include a combination of 2,2,4-trimethyl-1,3-pentanediol monoisobutyrate with Optifilm™ Enhancer 400 or a blend of 2,2,4-trimethyl-1,3-pentanediol monoisobutyrate with triethylene glycol dioctanoate.

32. A method of improving the properties of waterborne coatings or other waterborne polymer film-forming formulations, comprising the step of:
adding a low VOC multifunctional additive blend comprising triethylene glycol dioctanoate, Optifilm™ Enhancer-400, or a dibenzoate to a high VOC component comprising 2,2,4-trimethyl-1,3-pentanediol monoisobutyrate, benzylamine, phenoxyethanol, phenyl ethanol, benzyl alcohol, benzyl benzoate, 3-phenyl propanol, 2-methyl-3-phenyl propanol, vanillin, or P-methylcinnamyl alcohol, wherein the low VOC multifunctional additive blend does not include a blend of 2,2,4-trimethyl-1,3-pentanediol monoisobutyrate with Optifilm™ Enhancer 400 or a blend of 2,2,4-trimethyl-1,3-pentanediol monoisobutyrate with triethylene glycol dioctanoate, and
wherein the method provides a low VOC content to the formulation.

33. A colorant dispersion for use in waterborne coatings, wherein the colorant is dispersed in the low VOC multifunctional additive according to claim 1 prior to adding to the waterborne coating.

34. A multifunctional additive for use in waterborne polymer film-forming systems, consisting essentially of:
a. benzyl alcohol and a dibenzoate blend, wherein the ratio of benzyl alcohol to dibenzoate blend is 1:1; or
b. benzyl alcohol and a dibenzoate blend, wherein the ratio of benzyl alcohol to dibenzoate blend is 1:2; or
c. benzyl alcohol and a dibenzoate blend, wherein the ratio of benzyl alcohol to dibenzoate is 1:3; or
d. benzyl alcohol and Optifilm Enhancer 400, wherein the ratio of benzyl alcohol to Optifilm Enhancer 400 is 1:1,
wherein the dibenzoate blend comprises a mixture of diethylene glycol dibenzoate and dipropylene glycol dibenzoate or a mixture of diethylene glycol dibenzoate, dipropylene glycol dibenzoate and 1,2-propylene glycol dibenzoate.

35. A multifunctional additive for use in waterborne polymer film-forming systems, consisting essentially of: benzyl alcohol and triethylene glycol dioctanoate, wherein the ratio of benzyl alcohol to triethylene glycol dioctanoate is 1:1.

36. A multifunctional additive for use in waterborne polymer film-forming systems, consisting essentially of: 2,2,4-trimethyl-1,3-pentanediol monoisobutyrate and a dibenzoate, wherein the ratio of 2,2,4-trimethyl-1,3-pentanediol monoisobutyrate to dibenzoate is 10:90 or 20:80.

37. A low VOC multifunctional additive blend for use in waterborne polymer film-forming compositions, comprising:
a. at least one low volatile component comprising a dibenzoate, a dibenzoate blend, a monobenzoate, a phthalate, a terephthalate, a 1,2-cyclohexane dicarboxylate ester, a citrate, an adipate, triethylene glycol dioctanoate, Optifilm™ Enhancer 400, or a mixture of refined diisobutyl esters of adipic acid, glutaric acid, and succinic acid (Coasol), blended with;
b. at least one high volatile component comprising diethylene glycol monomethyl ether, ethylene glycol monobutyl ether, diethylene glycol monobutyl ether, 2,2,4-trimethyl-1,3-pentanediol monoisobutyrate, benzylamine, phenoxyethanol, phenyl ethanol, benzyl alcohol, benzyl benzoate, butyl benzoate, 3-phenyl propanol, 2-methyl-3-phenyl propanol, R-methylcinnamyl alcohol, or vanillin,
wherein the multifunctional additive blend does not include a blend of 2,2,4-trimethyl-1,3-pentanediol monoisobutyrate with Optifilm™ Enhancer 400 or a blend of 2,2,4-trimethyl-1,3-pentanediol monoisobutyrate with triethylene glycol dioctanoate,
wherein the ratio of the at least one high volatile component to the at least one low volatile component ranges from 10:1 to 1:10, and
wherein the multifunctional additive blend does not include a blend of 2,2,4-trimethyl-1,3-pentanediol monoisobutyrate with Optifilm™ Enhancer 400 or a blend of 2,2,4-trimethyl-1,3-pentanediol monoisobutyrate with triethylene glycol dioctanoate.

38. A low VOC multifunctional additive blend for use in waterborne polymer film-forming compositions, comprising:
a. at least one low volatile component comprising a dibenzoate, a dibenzoate blend, a monobenzoate, a phthalate, a terephthalate, a 1,2-cyclohexane dicarboxylate ester, a citrate, an adipate, triethylene glycol dioctanoate, Optifilm™ Enhancer 400, or a mixture of refined diisobutyl esters of adipic acid, glutaric acid, and succinic acid, blended with;
b. at least one high volatile component comprising diethylene glycol monomethyl ether, ethylene glycol monobutyl ether, diethylene glycol monobutyl ether, 2,2,4-trimethyl-1,3-pentanediol monoisobutyrate, benzylamine, phenoxyethanol, phenyl ethanol, benzyl alcohol, benzyl benzoate, butyl benzoate, 3-phenyl propanol, 2-methyl-3-phenyl propanol, β-methylcinnamyl alcohol, or vanillin,
wherein the multifunctional additive blend does not include a blend of 2,2,4-trimethyl-1,3-pentanediol monoisobutyrate with Optifilm™ Enhancer 400 or a blend of 2,2,4-trimethyl-1,3-pentanediol monoisobutyrate with triethylene glycol dioctanoate, and
wherein the ratio of the at least one high volatile component to the at least one low volatile component is 1:1.

39. A waterborne colorant, comprising:
a. a pigment or colorant,
b. a dispersant,
c. a low VOC multifunctional additive blend according to claim 1, and
d. water.

40. A solvent-borne colorant, comprising:
a. a pigment or colorant,
b. a dispersant,
c. a low VOC multifunctional additive blend according to claim 1, and
d. a solvent.

41. Use of the low VOC multifunctional additive blend according to claim 1 in waterborne polymer film-forming compositions comprising: architectural coatings, industrial coatings, OEM coatings, interior and exterior paints, metal coatings, direct-to-metal coatings, marine coatings, film coatings, vinyl film compositions, wood coatings, wood treatments, paper coatings, fabric coatings, textile coatings, wallpaper coatings, decorative coatings, textile coatings, construction coatings, cement coatings, concrete coatings, floor coatings, varnishes, inks, graphic inks, waterborne colorants, solvent-borne colorants, adhesive compositions, glues, sealants or caulks. Still other useful applications will be known to one skilled in the art.

42. An adhesive composition comprising the low VOC multifunctional additive blend according to claim 1.

43. A sealant composition comprising the low VOC multifunctional additive blend according to claim 1.

44. An ink composition comprising the low VOC multifunctional additive blend according to claim 1.
